(19) United States
(12) Patent Application Publication
(10) Pub. No.: US 2024/0211528 A1
(43) Pub. Date: Jun. 27, 2024

(54) SYSTEM, METHOD, AND COMPUTER PROGRAM PRODUCT FOR SECURELY ENABLING RENDERING OF A HYBRID WEBSITE INTERFACE BASED ON TRUSTED AND UNTRUSTED CODE COMPONENTS

(71) Applicant: WIX.COM LTD., Tel Aviv-Yafo (IL)

(72) Inventor: Yoav Abrahami, Tel Aviv (IL)

(21) Appl. No.: 18/390,345

(22) Filed: Dec. 20, 2023

Related U.S. Application Data
(60) Provisional application No. 63/597,902, filed on Nov. 10, 2023.
(60) Provisional application No. 63/590,914, filed on Oct. 17, 2023.
(60) Provisional application No. 63/582,286, filed on Sep. 13, 2023.
(60) Provisional application No. 63/477,320, filed on Dec. 27, 2022.

(51) Int. Cl. G06F 16/958; G06F 21/53; H04L 67/56

(52) U.S. Cl. CPC G06F 16/986; G06F 21/53; H04L 67/56

(57) ABSTRACT

Systems, methods, and computer program products configured to securely enable rendering of a hybrid website interface are provided. An example website building system provides a primary execution environment configured to execute one or more trusted website code definition elements, provides one or more sandbox execution environments configured to execute one or more untrusted website code components, provides one or more proxy transformation components that are configured to communicatively link the one or more untrusted website code components to at least one of the one or more trusted website code definition elements, and causes rendering of the hybrid website interface following execution of the at least one trusted website code definition element and the one or more untrusted website code components via the one or more proxy transformation components.

### CROSS-REFERENCE TO RELATED APPLICATIONS

This application claims priority to and benefit of each of U.S. Provisional Patent Application No. 63/597,902, filed Nov. 10, 2023, U.S. Provisional Patent Application No. 63/590,914, filed Oct. 17, 2023, U.S. Provisional Patent Application No. 63/582,286, filed Sep. 13, 2023, and U.S. Provisional Patent Application No. 63/477,320, filed Dec. 27, 2022, each of the foregoing of which is incorporated by reference herein in its entirety.

### TECHNOLOGICAL FIELD

Example embodiments of the present disclosure relate generally to secure website systems and, more particularly, to systems and methods configured to securely integrate externally-hosted or third-party code, or other potentially untrusted or unsecure code, into a website and enable rendering of a hybrid website interface.

### BACKGROUND

Various website-building systems provide tools, such as application programming interfaces (APIs), plug-ins, widgets, and the like, for allowing website developers to communicate with externally-hosted applications or services when creating or editing a website. However, such communications provide limited functionality and are fraught with security vulnerabilities and performance issues. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved systems and methods configured to securely integrate externally-hosted or third-party code, or other potentially untrusted or unsecure code, into a website and enable rendering of a hybrid website interface. In accordance with one exemplary embodiment of the present disclosure, a website building system configured to enable rendering of a hybrid website interface based on at least one trusted website code definition element and at least one untrusted website code component is provided, the website building system comprising at least one processor and at least one non-transitory memory comprising program code, the at least one non-transitory memory and the program code configured to, with the at least one processor, cause the website building system to at least: provide a primary execution environment configured to execute one or more trusted website code definition elements, provide one or more sandbox execution environments configured to execute one or more untrusted website code components, provide one or more proxy transformation components that are configured to communicatively link the one or more untrusted website code components to at least one of the one or more trusted website code definition elements, and cause rendering of the hybrid website interface following execution of the at least one trusted website code definition element and the one or more untrusted website code components via the one or more proxy transformation components.

In accordance with another exemplary embodiment of the present disclosure, a website building system configured to enable rendering of a hybrid website interface based on at least one trusted code structure and at least one untrusted code structure is provided, the website building system comprising at least one processor and at least one non-transitory memory comprising program code, the at least one non-transitory memory and the program code configured to, with the at least one processor, cause the website building system to at least access a code repository to identify at least one untrusted website code structure and at least one trusted website code structure, transform the at least one untrusted website code structure into a primary execution environment proxy transformation component, the at least one untrusted website code structure continuing to operate within a sandbox execution environment, generate a primary execution environment configured for executing the at least one trusted website code structure and the primary execution environment proxy transformation component, and cause rendering of the hybrid website interface following execution of the at least one trusted website code structure and the at least one untrusted website code structure via the primary execution environment proxy transformation component.

In accordance with another exemplary embodiment of the present disclosure, a computer-implemented method for automatically performing trusted code splitting to an untrusted candidate code corpus is provided, the computer-implemented method comprising applying a trusted code identification model to the untrusted candidate code corpus to automatically identify one or more trusted code sections; extracting the one or more trusted code sections from the untrusted candidate code corpus; generating one or more trusted computer executable functions based on the one or more trusted code sections; and generating one or more untrusted computer executable functions based on one or more untrusted code sections remaining in the untrusted candidate code corpus.

In accordance with another exemplary embodiment of the present disclosure, a computer-implemented method for implementing secure code-based content in a supply chain is provided, the computer-implemented method comprising receiving, at a trusted entity, code-based content from a code composition entity; identifying, at the trusted entity, at least one or more trusted code sections of the code-based content; compiling, at the trusted entity, at least the one or more trusted code sections for execution in a primary execution environment; and generating, based on at least the compiled trusted code sections, an executable code package.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1A is a flowchart for operations enabling rendering of a hybrid website interface in accordance with some example embodiments described herein;

FIG. 1B is a signal diagram of an example data flow in accordance with some example embodiments described herein;

FIG. 2 is a flowchart for operations enabling rendering of a hybrid website interface in accordance with other example embodiments described herein;

FIG. 3A illustrates a schematic control/data flow diagram at run-time for rendering a hybrid website interface in accordance with some example embodiments described herein;

FIG. 3B is another schematic control/data flow diagram at run-time for rendering a hybrid website interface in accordance with some example embodiments described herein;

FIG. 3C is another schematic control/data flow diagram at run-time for rendering a hybrid website interface with a multi-layer or nested layers sandbox execution environment in accordance with some example embodiments described herein;

FIG. 4A is a signal diagram of an example data flow for a Jcompiler in accordance with some example embodiments described herein;

FIG. 4B is a signal diagram of another example data flow for a Jcompiler in accordance with some example embodiments described herein;

FIG. 5 illustrates a schematic block diagram of example components of an example hybrid website interface rendering system in accordance with some example embodiments described herein;

FIG. 6 illustrates a schematic block diagram of example components of an example website building system in accordance with some example embodiments described herein;

FIG. 7 illustrates a schematic block diagram of example repositories of an example content management system of a website building system in accordance with some example embodiments described herein;

FIG. 8 is a schematic block diagram of example modules or circuitry for use in an example server apparatus in accordance with some example embodiments described herein;

FIG. 9 is a schematic block diagram of example modules or circuitry for use in an example client apparatus in accordance with some example embodiments described herein;

FIG. 10 is a flowchart for operations enabling rendering of a hybrid website interface in accordance with some example embodiments described herein;

FIG. 11 is a flowchart for operations automatically performing trusted code splitting to an untrusted candidate code corpus in accordance with some example embodiments described herein; and

FIG. 12 is a flowchart for operations implementing secure code-based content in a supply chain in accordance with some example embodiments described herein.

### DETAILED DESCRIPTION

One or more example embodiments now will be more fully hereinafter described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying them to any particular networked environment or standard). It should be understood that some, but not all embodiments are shown and described herein. Indeed, the embodiments may be embodied in many different forms, and accordingly, this disclosure should not be construed as being limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

### Overview

Developers and/or users may desire to add third-party applications or embed third-party code into a website for a number of reasons, however, allowing third-party code to run as part of a web page, website, or system is fraught with issues as such untrusted third-party code may be non-secure, malicious, compromised, and/or contain bugs. For example, such executable third-party code may intentionally or unintentionally contain malicious functionality, vulnerabilities, and/or allow for attackers to gain access to the website, or worse yet, the underlying system. Moreover, methods for integrating third-party or potentially untrusted code during the building or editing of websites may require the developer to explicitly identify and/or manually handle the isolation of secure code from untrusted code/elements.

Similarly, a site owner or designer may determine that certain written code, components, or sub-components, although created within an organization and not necessarily third-party code, may be less secure or non-secure compared to other secure organization code, components, or sub-components of a web page, web site, or system. Non-tested or insufficiently tested code may contain bugs such that the site owner or designer desires compartmentalization or isolation of such less tested code from well-tested code so as to prevent such potentially faulty code from harming the tested code or other parts of the web page, web site, or system. It may be desirable and advantageous to maintain the security of a web page, website, or system while efficiently providing inter-component isolation. Said differently, it is desirable to obtain the functionality of such potentially non-secure code or components but without supply chain risks associated with such potentially non-secure code being delivered intentionally or unintentionally to the website or underlying system. It is further desirable and advantageous to maintain the security of such web page, website, or system without requiring the site owner or designer to explicitly handle the necessary separation and isolation of such code or otherwise handle the flow of data and control between the differing types of code.

Methods that enable developers to use iFrame tags or elements or other isolation technologies to embed a third-party application or widget into a website have drawbacks. Indeed, the use of iFrames in websites, in which the iFrame loads the entirety of the third-party application, including both the logic code and the visible design elements of the third-party application, may lead to issues with SEO (search engine optimization), performance, and/or accessibility of the website. Content displayed via such iFrames may not be indexed or may be indexed incorrectly (e.g., search engine crawler may not be able to cross-index multiple related iFrames to effectively identify and integrate such content) such that it affects search engine ranking of the underlying website. The use of iFrames which must load both the logic code and the visible design elements of the third-party application or widget may also or instead adversely affect the loading speed or latency of the website. For example, a browser has to essentially open a new browser window instance to execute each iFrame to load both the logic code and the visible design elements of the third-party application or widget. This can be computationally expensive and lead to performance issues due to memory requirements, processing power, or the like.

This problem is only exacerbated as the number of iFrames increase for any particular website. Indeed, a large amount of computing effort is required to generate and compare virtual Document Object Model (DOM) trees in such conventional systems and methods. Details regarding DOM tree comparison algorithms are described in commonly-owned U.S. Pat. No. 9,817,804, which was filed on Feb. 11, 2015 as U.S. patent application Ser. No. 14/619,145, and is entitled “SYSTEM FOR COMPARISON AND MERGING OF VERSIONS IN EDITED WEBSITES AND INTERACTIVE APPLICATIONS,” which patent is incorporated by reference herein in its entirety. As will be apparent in view of the foregoing disclosure, it is desirable and advantageous to maintain the security of a web page, website, or system while supporting a more streamlined execution of trusted and untrusted code that reduces computational load and memory requirements, minimizes impact on performance, and produces a lower latency user experience, as well as improves SEO indexing.

In addition, one of the challenges of running secure code is that it is challenging to check what the code does without running it. Even when running the code, defensive mechanisms tend to be very complex, including trying to mitigate huge attack surfaces that have to be maintained, applied, and monitored in real-time, while trying to avoid major impact on performance, application loading time (e.g., important for web, mobile, and serverless compute) and stability. While code can be run in a sandbox environment while exposing only a subset of APIs to the sandbox, such white-listed APIs still have to be made available, monitored, loaded, have performance and stability impact, and confirmed to be secure.

Still further, systems that rely on a compiler for security may still be susceptible to supply chain attacks. For example, code-based content may be split into secure and unsecure parts using a compiler. Although there may be some advantages for a code consumer (e.g., not needing to know or understand dependencies and requirements, receiving the benefits of easier to consume, pre-compiled content, etc.) and a code supplier (e.g., delivery model is simplified as many variables on the consumer end need not be considered) in an instance wherein the compiler is run by the code supplier of the code-based content, the code supplier has all of the control and may, after the compilation, change or adjust the compiled content (e.g., inject unwanted code into the so-called secure artifact), placing the code consumer at risk. Alternatively, if the compiler is run by the code consumer, the code consumer is burdened with taking on the responsibility of setting up the compiler, policies, environments, etc. The content may not be consumed “as is” from the internet, CDN, package managers, etc., and may alter or degrade the user experience for the user using the content from the intention of the code supplier.

To overcome these problems and others, Applicant has identified that, in some embodiments, it is advantageous to separate the logic code of a website from the design or visible design elements of the website. Said differently, various embodiments of the present disclosure enable the ability to create a safe, stable, and low-latency system where the UI component or visible design element (e.g., the DOM) runs in a main context (e.g., a primary execution environment) while other code (e.g., not a visible element, but potentially malicious logic of the component) runs in one or more sandbox contexts (e.g., sandbox execution environment(s)), such that the website realizes the beneficial functionality of trusted and untrusted code without incurring undue risks to the UI component or underlying system that may be delivered intentionally or unintentionally by the execution of such code.

By separating the logic code from the visible design and isolating such logic code in one or more sandbox contexts (e.g., sandbox execution environment(s)) in accordance with various embodiments of the present disclosure, the risk of any potentially malicious code within such logic code is, by definition, extremely limited. The developer of such code running in the sandbox execution environment has full freedom to do what they want, but they do not have access to the primary execution environment or any other context of any other code developer. Indeed, any potentially malicious code (e.g., untrusted website code component) cannot affect the global scope, or otherwise pollute other portions, of the website or system as it cannot take over any part of the UI not owned by it or by its corresponding visible design element (e.g., trusted website definition element) running in the main context (e.g., the primary execution environment).

Various embodiments of the present disclosure also implement proxy transformation component(s) that communicatively link untrusted website code components to trusted website code definition elements and vice versa. Such proxy transformation component(s) advantageously preserve the rendering or execution order of website code elements/components by representing or emulating the corresponding website code element/component of one context in the execution environment of the other context.

Various embodiments of the present disclosure further maintain the security of the web page, website, or system while also minimizing computing expense and memory requirements associated with rendering the associated UI. For example, performance issues are improved as data need only be compared between individual components (e.g., recorded data of a proxy transformation component compared to previous recorded data of the proxy transformation component) such that there is no need to generate virtual DOM trees just for comparison. Indeed, the compared data tends to be much smaller as compared to such virtual DOM trees. Example embodiments of the present disclosure enable the rendering of third-party UI elements, features, or components using a single object message method (OMM) message regardless of the composability of the untrusted website code components of third-party code (e.g., single layer or multiple/deeply nested code structures). Applicant has also identified that it is faster to use immutable data structures as compared to mutable data structures in various embodiments of the present disclosure because when working with a mutable object in a sandbox execution environment, it may be complicated to take the untrusted code component, generate a ViewState, do a Diff, create a JSON patch, post it from sandbox execution environment to the primary execution environment, apply a patch on the previous view state in the main object, get a new object, and then do another algorithm to figure out the reconciliation, but the system does not know what changed because it does not have a previous version to compare with. By using immutable objects, the system can simply check if the object is different from the previous version which provide a huge improvement in performance.

Applicant has identified it is advantageous to build and/or improve upon certain algorithms that are necessarily rebuilt or new for performing certain operations in accordance with various embodiments of the present disclosure. For example, array reconciliation and JSON Diff benefit from item movement support. Traditionally, in a case with array reconciliation, algorithms perform a Diff one-by-one on array elements when updating a DOM. However, the DOM generally uses only an index (rather than a key) such that one-by-one replacement when updating is inefficient. Alternatively, example embodiments of the present disclosure may use a key property to track object identity to facilitate array reconciliation with movement support. This algorithm determines the minimum number of operations needed by checking various possibilities and moving (thereby preserving) child DOMs whenever possible, rather than using replacement. By using movement as opposed to replacement, inefficiencies related to steps including re-calculating nodes, updating nodes and recreating components are mitigated. Supporting movement preserves a child component state and improves efficiency for DOM operations. Similarly, a JSON Diff algorithm may be configured to support object movement using a same or similar algorithm.

Efficiently and effectively identifying website code segments or snippets as potentially malicious or otherwise non-secure from an integrated website code repository is a computationally difficult task, given the large amount of code and varying programming languages. Accordingly, various embodiments of the present disclosure apply machine learning models and/or rules-based models to previously identified untrusted website code component(s), trusted website definition element(s), and proxy transformation component(s), as well as additional sources (e.g., application store information, code configuration, version tracking systems, developer directives, etc.) to learn relationships among the underlying code, which in turn informs embodiments herein as to which code is potentially untrusted or non-secure and which code can be trusted or verified as secure. Knowledge of which code is potentially untrusted or non-secure and which code can be trusted or verified as secure enables embodiments herein to efficiently identify untrusted website code component(s), trusted website definition element(s), the need to create proxy transformation component(s), trusted code section(s), and/or untrusted code section(s).

Applicant has also identified that it is advantageous to selectively identify and extract trusted code sections from a potentially untrusted candidate code corpus in order to compile such selectively identified trusted code sections into trusted computer executable functions that can be executed in an unsecured, main context (e.g., a primary execution environment). For example, various embodiments of the present disclosure may automatically perform trusted code splitting by applying a trusted code identification model to an untrusted candidate code corpus in order to automatically and selectively identify one or more trusted code sections therein. The trusted code identification model may be configured to apply, for example, a static code analysis to the non-running code, in order to inspect the untrusted candidate code corpus and identify, mark, and/or deduce candidate trusted code sections in the untrusted candidate code corpus based on, for example, one or more code analysis factors. For example, by using detectable or recognized code patterns previously deemed to be safe, the trusted code identification model will skip obfuscated code, tricky code patterns, or other forms of attacks that may try to access private and/or unauthorized APIs, as those “smart attack vectors” will not be covered by the detectable or recognized code patterns.

Various embodiments of the present disclosure may further split the untrusted candidate code corpus into a structure of functions comprising two or more functions that can be run or executed in a primary execution environment or a sandbox execution environment. That is, the selectively identified trusted code sections may be extracted or hoisted from the untrusted candidate code corpus. In some embodiments, the selectively identified trusted code sections are generated (e.g., compiled) as trusted computer executable functions to be run in a primary execution environment and the untrusted code sections remaining in the untrusted candidate code corpus may generated (e.g., compiled) as untrusted code computer executable functions to be run in a sandbox execution environment, thereby creating a secure system. It is contemplated by this disclosure that, in some instances, such secure code splitting may be performed in a preparation or compilation phase prior to execution (e.g., in preparation of an executable code package). In other instances, the compilation and execution phases may be integrated such that the secure code splitting may be performed during execution (e.g., a run-time) or just-in-time (JIT).

Although it is a focus of the present disclosure to provide a secure system for running code, Applicant has also determined that certain executable code failing to run is, at times, acceptable or even desirable in order to protect the system from potentially malicious code. In addition, such secure code splitting may advantageously reduce the need for runtime layers of security since the secure code splitting is performed at compilation. For example, a particular section of code may not have a detectable or recognized code pattern that can be verified by the trusted code identification model and as such, fails to satisfy the requirements to be identified as a trusted code section. Even though such code section may require an API that is not available in the sandbox execution environment, it is not extracted or hoisted from the untrusted candidate code corpus and is instead generated (e.g., compiled) as an untrusted computer executable function to be run in a sandbox execution environment. At runtime, such untrusted computer executable function will fail to run in the sandbox execution environment due to the necessary API not being available. Said differently, this code may be considered to be an attempt to break the sandbox and/or circumvent the security system, and therefore, it is acceptable that this code fails to run in a sandbox execution environment.

Applicant has also identified that it is advantageous to incorporate a third party trusted entity into the middle of a code supply chain in order to compile and create a safe supply chain for secure artifacts to make such secure artifacts to code consumers. Similar to digital certification, adding such a trusted player into the code supply chain prevents the code supplier from tampering with trusted code, enabling the code consumer to know that the trusted code has not been tampered with, and allowing the code supplier to still provide the product without having to disclose all of its code to the code consumer.

Having set forth an overview of the present disclosure, example methods, system architectures, and apparatuses are described below for implementing example embodiments and features of the present disclosure, followed by a series of definitions called-upon throughout this application. While various embodiments of the present disclosure are described herein with reference to a hybrid website interface rendering system and/or a website building system, the present disclosure contemplates that embodiments herein may be equally applicable to a variety of website building systems and/or non-website building systems, such as a visual design system, an experiment system, an end-user oriented website or application, a native application building system, a dynamic view assignment system, an application generation system, and a page analyzing visual editor. Details regarding example website building systems and non-website building systems are described in commonly-owned U.S. Pat. No. 9,996,566, which was filed Jul. 31, 2016, as U.S. patent application Ser. No. 15/224,579, and is entitled “VISUAL DESIGN SYSTEM FOR GENERATING A VISUAL DATA STRUCTURE ASSOCIATED WITH A SEMANTIC COMPOSITION BASED ON A HIERARCHY OF COMPONENTS,” which patent is incorporated by reference herein in its entirety.

### Example Hybrid Website Interface Rendering Operation Overview and Embodiments

Example embodiments of the present disclosure may proceed to enable rendering of a hybrid website interface in a number of ways. Accordingly, various processes in accordance with the present disclosure are described herein.

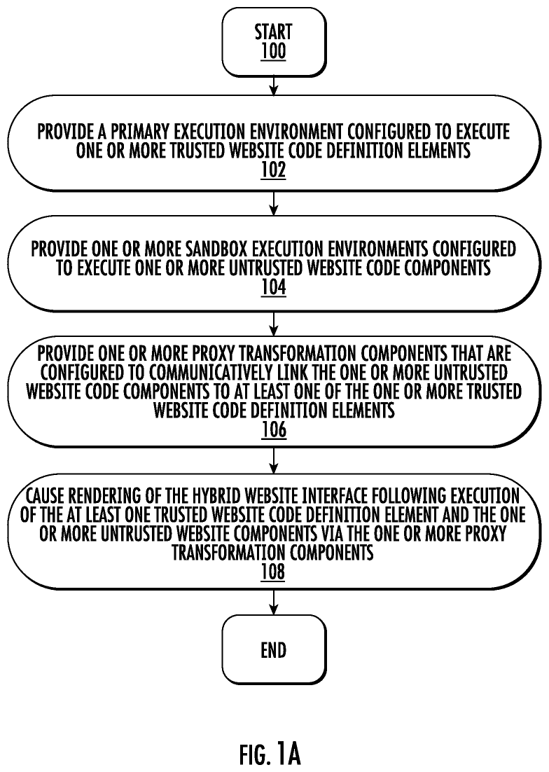

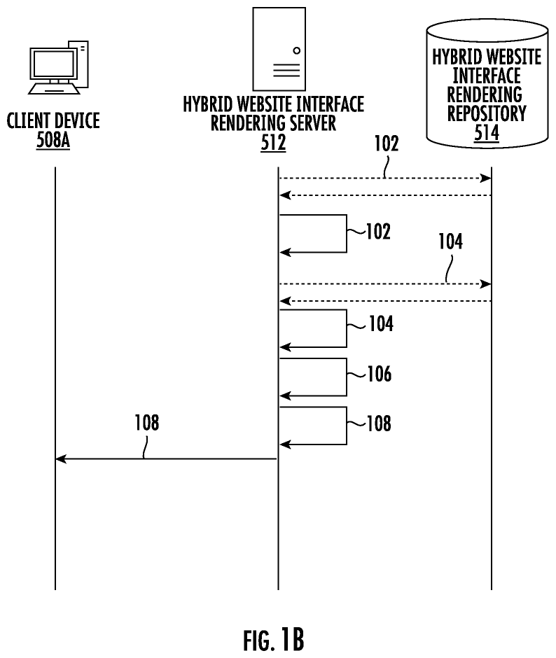

Turning now to FIG. 1A, example operations are shown for enabling rendering of a hybrid website interface. In particular, FIG. 1A is a flowchart broadly illustrating the series of operations or process blocks in method 100 that are executed or performed by a system or apparatus to enable rendering of the hybrid website interface in accordance with some example embodiments of the present disclosure. To avoid unnecessarily overcomplicating the discussion, the operations of method 100 illustrated in FIG. 1A are described as being performed by a hybrid website interface rendering server, however, some or all of the steps can also be performed by, with the assistance of, and/or under the control of a system, such as a hybrid website interface rendering system or a website building system, and/or a client apparatus (e.g., one or more of client devices 508A-B).

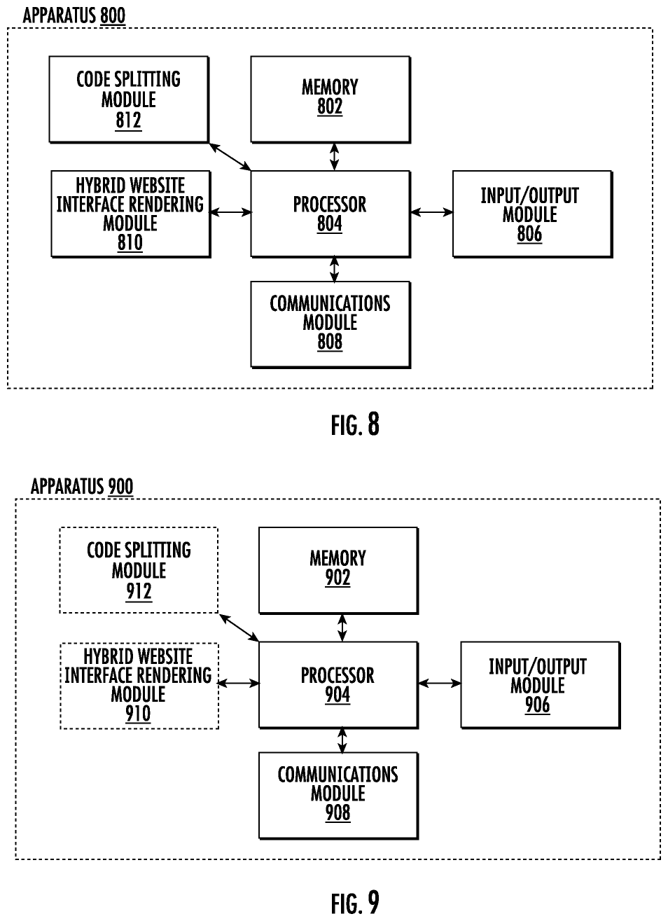

For example, hybrid website interface rendering system 510 or website building system 610 may be configured to perform method 100 for a plurality of different web pages, websites, and/or the like. The operations illustrated in FIG. 1A may be performed by, with the assistance of, and/or under the control of a server apparatus 800 (e.g., as depicted in FIG. 8) and/or a client apparatus 900 (e.g., as depicted in FIG. 9). Performance of the operations may invoke one or more of memory 802, 902, processor 804, 904, input/output module 806, 906, communications module 808, 908, hybrid website interface rendering module 810, 910, and/or code splitting module 812, 912, as described in more detail below with respect to FIGS. 8 and 9.

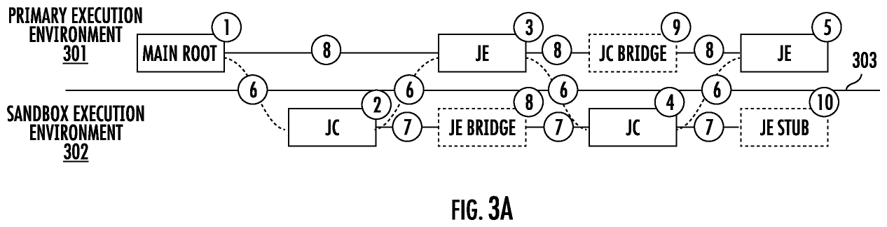

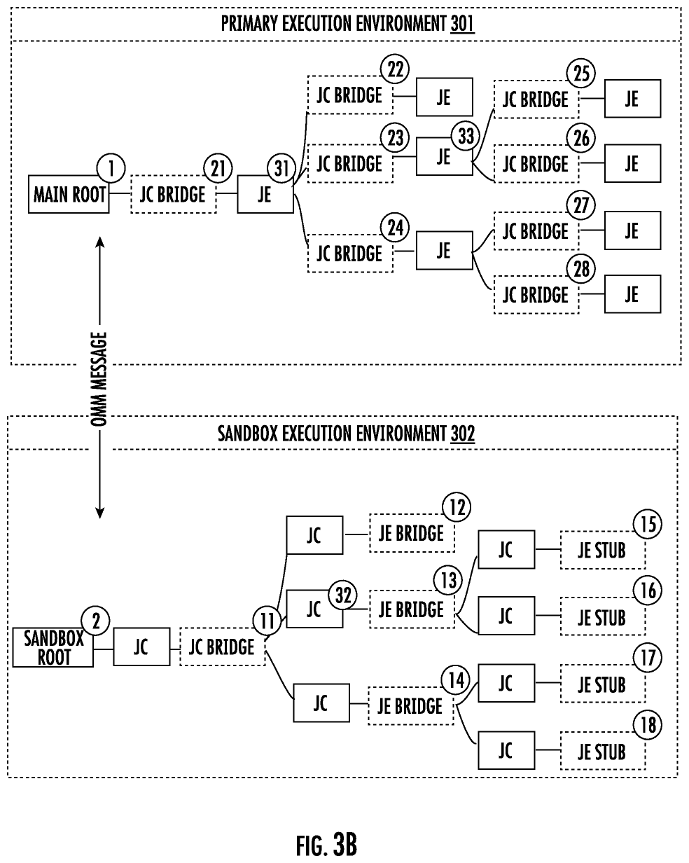

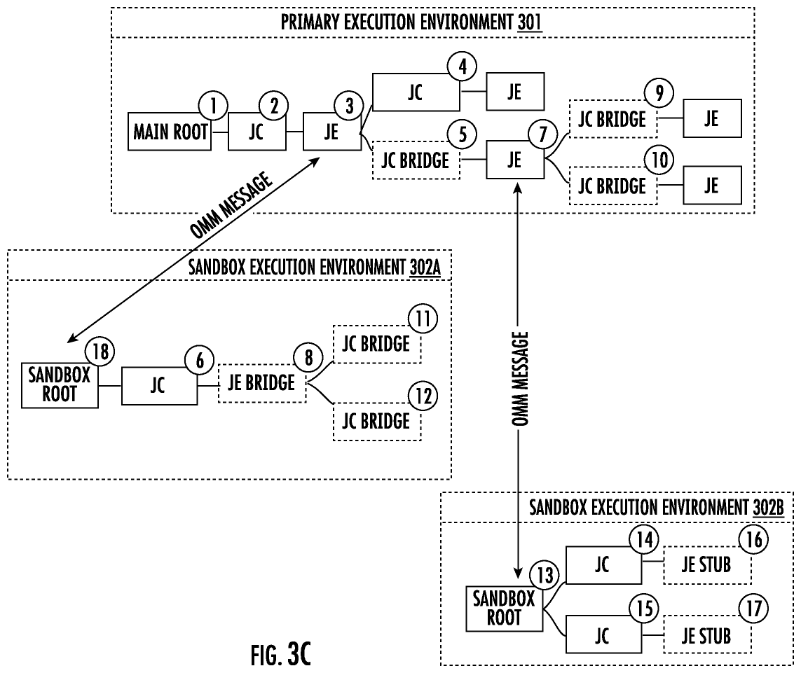

In the embodiment illustrated in FIG. 1A, the flowchart illustrates method 100 which includes providing a primary execution environment configured to execute one or more trusted website code definition elements at Block 102. In some embodiments, a hybrid website interface rendering server (e.g., hybrid website interface rendering server 512), embodied by server apparatus 800, may include means, such as memory 802, processor 804, input/output module 806, communications module 808, hybrid website interface rendering module 810, code splitting module 812, and/or the like, which are collectively configured to provide the primary execution environment. An example of a primary execution environment 301 is depicted above the center, horizontal line 303 in FIG. 3A.

A primary execution environment is an unsecured (i.e., not isolated from other environments or systems) or trusted environment, such as a web window or windows, which can run code, such as JavaScript (JS). In various embodiments, a primary execution environment may be front-end (e.g., in client-side rendering), back-end (e.g., in server-side rendering), or a combination thereof. The depicted hybrid website interface rendering module 810 forms part of server-side software executed by a server, such as hybrid website interface rendering server 512. While various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

In various embodiments, the primary execution environment may be a browser window, thread, or any server-side technology used to render the main part of a web page. In a further example, it is contemplated by this disclosure that some or all of the functionality of hybrid website interface rendering module 810 may optionally be performed by a client-side software application running on one or more client devices 508A-B and the disclosure is not limited to the specifically identified arrangement of software executed by the hybrid website interface rendering server 512. For example, when rendering on the server-side, the primary execution environment is operating on the device, platform, or software used for rendering the page content (HTML, CSS or otherwise) to be sent to the browser (or another user agent). Moreover, in some embodiments, the hybrid website interface rendering server 512 providing one or more sandbox execution environments (e.g., as described in Block 104 below) may be performed on a separate server(s) than the hybrid website interface rendering server 512 providing the primary execution environment (e.g., as described in Block 102).

Although Block 102 is described with respect a single primary execution environment, it is contemplated by the present disclosure that multiple primary execution environments might be used. Said differently, any window or session that performs UI rendering, for example, may create, require, or provide essentially a separate primary execution environment as a separate instance.

In various embodiments, the primary execution environment is configured to execute one or more trusted website code definition elements. A trusted website code definition element corresponds to an element or code structure that is deemed essentially safe or trusted by the system (e.g., via machine learning) and/or the user (e.g., website designer or code writer). For example, in some embodiments, a trusted website code definition element utilizes declarative programming language that can be verified as secure via static analysis. Static code analysis or static analysis comprises analyzing or otherwise examining the code without executing the program (e.g., non-running code) in order to identify and/or understand the underlying code structure. Declarative programming language (e.g., HTML, CSS, JSX, and/or the like) is inherently secure and/or can be transformed/compiled into a verifiably secure code such that it may execute in the primary context environment. The exact details of the declarative programming language used depend on the actual embodiment.

In some embodiments, a trusted website code definition element utilizes such declarative programming language or otherwise secure code to define the task or desired outcome of the element. Function(s) of a trusted website code definition element are typically UI-related. Said differently, in some embodiments, a trusted website code definition element defines (e.g., through a Jcompiler) a function that accepts data and, when called, creates and/or updates (e.g., returns an update function) one or more structures in the DOM of the hybrid website interface. In some embodiments, the DOM of the hybrid website interface is associated with at least one document data structure, the at least one document data structure comprises one or more of a tree-structured data structure, a forest-structured data structure, a federated architecture data structure, a graph data structure, a referential table, an object database, a flat data structure, a hash table, or any combination(s) thereof.

In certain embodiments, a trusted website code definition element defines (e.g., through a Jcompiler) the structure of the state. When compiled, the trusted website code definition element renders the UI code (e.g., HTML) and creates and/or updates the UI. That is, when the declarative programming language is compiled to produce generated code, the generated code can respond to event handlers of an untrusted website code component or otherwise be triggered by an untrusted website code component virtually performing other DOM-related manipulations in order to render the UI code (e.g., HTML) and create and/or update the UI.

In some embodiments, a trusted website code definition element does not include any logic code or logic code subcomponent. In another embodiment, a trusted website code definition element comprises a section including instructions, which will subsequently be compiled (e.g., through a Jcompiler) into logic instructions.

In a non-limiting contextual example, a hybrid website interface (“Website A”) includes a counter functionality. The following inset represents an example trusted website definition element (“JE Counter”) for such a counter functionality in Website A:

```
<html>
<head>
    <script type=“application/yaml-jay”>
data:
  count: number
    </script>
</head>
<body>
<div>
    <button ref=“subtracter”>−</button>
    <span style=“margin: 0 16px”>{count}</span>
    <button ref=“adder”>+</button>
</div>
</body>
</html>
```

As depicted, the example trusted website definition element, JE Counter, running in the primary execution environment (e.g., the primary execution environment 301 in FIG. 3A), comprises instructions for rendering two buttons, one for minus (“−”) and one for plus (“+”), as well as a span, to render the “count”. The exemplary JE Counter also includes a definition that “count” is a number. The JE Counter further has two references (“button ref”) that identify those elements for events. Most notably, the JE Counter is logic free such that it does not cause any security risk. It is contemplated by the present disclosure that, in some instances, HTML can introduce script (e.g., such as an inline JS event handler), however, certain embodiments of the present disclosure are configured to perform a static analysis of such code and remove such script to a sandbox execution environment. Accordingly, in this non-limiting contextual example, the JE Counter is deemed as a trusted website code definition element that can be compiled into safe code.

With continued reference to the JE Counter example, the definition actually defines a function of the indented form below (and is later compiled into such a function):

$$JE ( ViewState ) \text{=>} [ DOM Representation , ( ViewState ) \text{=>} \{ update logic \} ]$$

The JE Counter function accepts data denoted as ViewState, which is defined in the data section of the JE Counter file in the example above. When called, the function creates the defined structure in the DOM using the ViewState function. The function also returns an update function, that when called with a new ViewState, updates the DOM accordingly. The data section of the JE Counter file defines the structure of the ViewState. The root DIV JE defines the DOM structure that the function creates. Instructions embedded into the HTML, like ‘forEach’ (render a list), ‘if (conditional rendering) or’{variable}′ (render a value) complete the declarative JE Counter file structure.

With continued reference to the JE Counter example, the JE Counter definition file is side effect-free, which compiles into a side effect-free function and a side effect-free update function. A side effect-free function means it is secure by definition, up to what it creates on the DOM structure. As the DOM structure is well-defined and declarative, it is simple to validate that it does not introduce any vulnerabilities (e.g., such as JS event handlers). For example, in some embodiments, a simple white list/black list of DOM elements and attributes (e.g., imposed by the Jcompiler with no run-time penalty) can validate that the DOM structure does not impose vulnerabilities. The combination of a side effect-free trusted website code definition element, such as JE Counter, with a well-defined DOM, allows the Jcompiler to generate safe code.

In some embodiments, a trusted website code definition element and/or an untrusted website code component is/are manually identified by a user of various embodiments of the present disclosure. For example, in some instances, method 100 optionally comprises receiving one or more pre-separated or pre-identified trusted website code definition element(s) from a client device 508. In other embodiments, the method optionally comprises receiving an integrated set of modules (e.g., website code structures), wherein the website code structures may comprise one or more directives (e.g., embedded or separate) indicating how the integrated set of modules should be divided into trusted website code definition element(s) and untrusted website code component(s). In still another embodiment, the method optionally comprises analyzing the received website code structures and determining how the integrated set of modules should be divided into trusted website code definition element(s) and untrusted website code component(s). Such analysis may comprise analysis of the website code, data from additional source(s) (e.g., application store information, code configuration, version tracking systems, historical user data, etc.), or some combination thereof. Such programmatic analysis may be based on various criteria defined by the system user in some embodiments.

In still further embodiments, the hybrid website interface rendering server 512 (e.g., hybrid website interface rendering system 510) optionally provides for use of a machine learning model designed to leverage artificial intelligence in connection with the determination of trusted website code definition element(s) and/or untrusted website code component(s). That is, such programmatic analysis and/or determination may be performed by one or more trained machine learning models to programmatically determine and categorize the website code structure(s) as trusted website code definition element(s) or as untrusted website code component(s). For example, in various embodiments of the present disclosure, the hybrid website interface rendering module 810 and/or code splitting module 812 is configured to analyze a plurality of website code structures, the plurality of website code structures configured to render the hybrid website interface, parse the plurality of website code structures, and programmatically determine and categorize at least one website code structure as a trusted website code definition element and at least one other website code structure as an untrusted website code component.

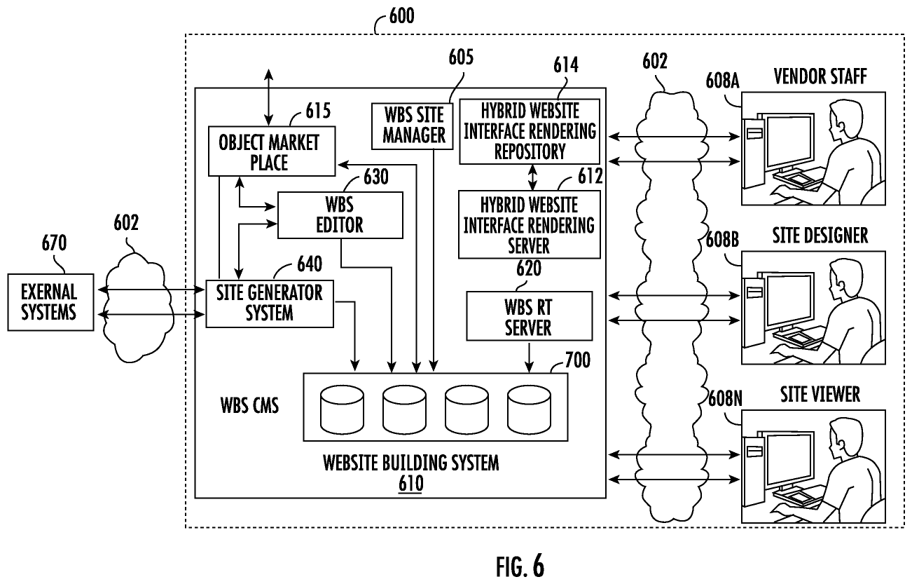

In identifying, determining, and/or categorizing the website code structure(s) as trusted website code definition element(s) or as untrusted website code component(s), the hybrid website interface rendering server 512 (e.g., hybrid website interface rendering system 510) may draw from a range of information sources that can be supplied to the machine learning model in order to make suggestions or predictions as to trusted website code definition element(s) and untrusted website code component(s). For example, any one or more of the data described herein (e.g., tracked data, historical data, and/or the like) and correlations thereof can be used in connection with the machine learning model. Some embodiments of the present disclosure, such as a website building system 610 described below with respect to FIG. 6, which creates and/or updates a plurality of websites, has access to a plethora of unique data that may be further used as a training corpus in connection with machine learning models. In addition to the tracked data (e.g., data communicated view OMM) and historical data (e.g., previous identifications of trusted website code definition elements and untrusted website code components) of most embodiments of the present disclosure, certain embodiments of website building systems 610 may use or have access to designer selection pattern(s), latency timing data associated with executing various website code structures, tested website code structures previously unrelated to hybrid website interfaces, data associated with usage of website building blocks, website editing historical interactions, editing historical interactions, historical editing interactions, electronic interaction data, transactional editing data, user preference(s) and change thereof over time, business related data (e.g., user revenue or predicted revenue of other financial properties or transactions, whether the user has users of users (UoUs), etc.), previous outcomes of hybrid website interface rendering configurations, level(s) of trust in third-party code(s), level(s) of risk associated with the website and/or user, and/or the like, which may further be used in connection with machine learning model(s).

In some embodiments, dissimilar website code structures can be analyzed by the machine learning model to programmatically determine trusted website code definition element(s) and untrusted website code component(s). Moreover, in some embodiments, the machine learning based model employed by the hybrid website interface rendering server 512 (e.g., hybrid website interface rendering system 510) can be trained using such tracked data, historical data, and/or the like. For example, in some embodiments, an unsupervised learning structure, a supervised learning structure, a reinforcement learning structure, a deep learning structure, a clustering algorithm, and/or the like is implemented for programmatically determining correlations of the varied data and data formats to make suggestions or predictions as to trusted website code definition element(s) and untrusted website code component(s).

Returning to Block 104 of FIG. 1A, method 100 further includes providing one or more sandbox execution environments configured to execute one or more untrusted website code components. For example, in some embodiments, hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to provide one or more sandbox execution environments. An example sandbox execution environment 302 is depicted below the center, horizontal line 303 in FIG. 3A.

A sandbox execution environment is an isolation mechanism or environment for securely executing potentially untrusted code (e.g., one or more untrusted website code components). A sandbox execution environment is a secured environment (i.e., structurally isolated from other environments or systems) that can run code, such as JS. Example server-side sandbox execution environments include any server sandbox, such as VM, micro VM, container, web assembly sandbox, or node.js worker. Example client-side sandbox execution environments include Web Workers (e.g., as defined by the W3C and WHATWG standard-setting bodies), iFrames, or any other technology(ies) or client-side code isolation mechanisms for the execution of background, independent, or otherwise asynchronous scripts or code (e.g., in separate threads or processes). Details regarding iFrames and other mechanisms for integrating third-party applications into a website are described in commonly-owned U.S. Pat. No. 10,509,850, which was filed Feb. 10, 2014, as U.S. patent application Ser. No. 14/176,166, and is entitled “THIRD PARTY APPLICATION COMMUNICATION API,” which patent is incorporated by reference herein in its entirety. Example embodiments of the present disclosure using an iFrame as a sandbox execution environment for running such potentially untrusted code/elements reduce performance issues as the sandbox execution environment is not running the entirety of the, for example, third-party application, but instead only executes the logic code and not the visible design elements, of the third-party application.

While example embodiments of the present disclosure may use an iFrame as a sandbox execution environment for running such potentially untrusted code/elements, the iFrame itself is run as invisible, using a small area (e.g., width and height 4px or smaller) or placed off-screen using negative X and Y positioning. For example, one may use a Technical iFrame, which can run scripts, but is hidden from the users, from help tools, and from keyboard navigations. In some embodiments, it can be hidden from search engine optimization (SEO) robots (e.g., by using content=“noindex,nofollow”). Such hidden iFrames can be loaded quickly, reducing the performance hit compared to typical iFrames which load with lazy-loading behavior. There is no iFrame in the DOM and in turns of loading time, embodiments of the present application are much faster. For example, in rendering a table of 100×100 items, wherein each frame updates 100 numbers in the table, embodiments of the present disclosure were three times more efficient than compared to applications applying solely iFrames.

A myriad of other isolation mechanisms or environment technologies (e.g., including, but not limited to, <object> element, <embed> tag, Google Chrome® portals using the <portal> HTML element, Asynchronous Javascript And XML (AJAX), Web Components, etc.) are contemplated by this disclosure to create or provide such sandbox execution environment(s) in association with the primary execution environment and the present claims are not limited to the provided examples.

In various embodiments, a sandbox execution environment is configured to execute one or more untrusted website code components. An untrusted website code component corresponds to a component or code structure that is deemed, by the system (e.g., via machine learning) and/or the user (e.g., website designer), to be potentially or inherently unsafe, such that it may not be trusted to execute in the primary execution environment. For example, in some embodiments, an untrusted website code component utilizes scripting programming language, such as JS and/or the like.

In one embodiment, an untrusted website code component may be a third-party application or third-party code (e.g., code structure generated externally of the system). However, an untrusted website code component need not be third-party code or otherwise generated externally of the system. In some embodiments, an untrusted website code component is code generated by the same website designer that generated a trusted website code definition element running in the primary execution environment. That is, in a non-limiting contextual example, a website designer may desire that a sandbox execution environment be provided and configured to execute non-tested, less deeply tested, or otherwise insufficiently tested code in order to isolate or compartmentalize such potentially buggy or unsafe code from well-tested code executing in the primary execution environment. In still other embodiments, certain third-party code may be designated as a trusted website code definition element when such third-party code is sufficiently tested and trusted to be regarded as safe.

In some embodiments, an untrusted website code component utilizes such script programming language or otherwise non-secure code to create data (e.g., tracked data) that its associated trusted website definition element renders. That is, function(s) of an untrusted website code component are typically related to directing the UI and/or other components (e.g., logic, DB, etc.) that are not related to the corresponding trusted website definition element. For example, in one embodiment, the untrusted website code component may be a structure that, given some trigger, communicates or sends new data to the associated trusted website definition element using some API. An untrusted website code component defines event handler(s) for the associated trusted website definition element. For example, the untrusted website code component listens to events from DOM element(s) created by its associated trusted website code definition element and/or child components of the untrusted website code component (e.g., nested untrusted website code component(s), nested trusted website code definition element, and the like).

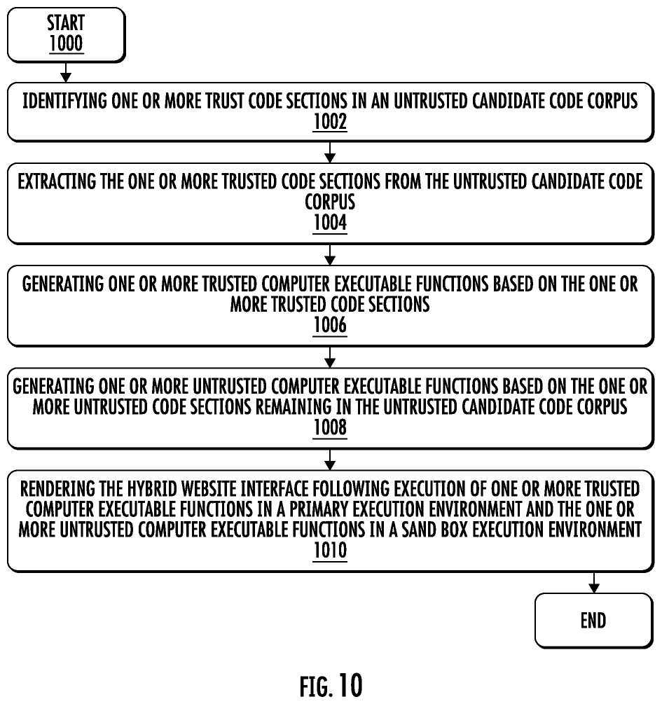

In various embodiments, an untrusted website code component may define the event handler(s) using a declarative programming language, which is then compiled into code running in the primary execution environment. Additionally, or alternatively, in various embodiments, an untrusted website code component may define direct DOM manipulations using a declarative programming language, which is then compiled to code running in the primary execution environment, thereby allowing the untrusted website code component to interact with the DOM created by the trusted website code definition element. In some embodiments, an untrusted website code component comprises a logic code subcomponent. Additionally, or alternatively, in some embodiments, an untrusted website code component comprises a presentation subcomponent. For example, an untrusted website code component may comprise both untrusted website code sub-components and trusted website code definition element sub-components, which are recursively split into trusted computer executable functions and untrusted executable functions for execution in the primary and sandbox execution environments, respectively, such as described with respect to FIGS. 10-12.

Continuing with reference to the non-limiting contextual example illustrated herein with respect to Website A including a counter functionality, the following inset represents an example untrusted website code component (“JC Counter”) for such a counter functionality in Website A:

```
import {render, CounterRefs} from ‘./counter.jay.html’;
import ...
interface CounterProps {
  initialValue: number
}
function CounterConstructor({initialValue}: Props<CounterProps>, refs:
CounterRefs) {
  let [count, setCount] = createState(initialValue);
  refs.subtracter.onclick(( ) => setCount(count( ) − 1));
  refs.adder.onclick(( ) => setCount(count( ) + 1));
  const reset = ( ) => {setCount(0)}
  return {
    render: ( ) => ({count}),
    reset
  }
}
export const Counter = makeJayJC(render, CounterConstructor);
```

As depicted, the CounterConstructor function constructs the example untrusted website code component, JC Counter, in a sandbox execution environment (e.g., sandbox execution environment 302 in FIG. 3A). The “createState” creates a reactive state pair of read value function count and update value setCount function. A reactive state means that any other function reading the value of the count function is rerun whenever the count value is updated.

As further depicted, JC Counter comprises two event handlers for “onclick” (e.g., subtracter and added) with respect to either of the two buttons described above with respect to the JE Counter, which in turn updates the count state, and a render function which returns the count state to be used in rendering and updating the trusted website code definition element, JE Counter. That is, using the same refs as the JE Counter, when a website user clicks on or otherwise engages with either the “−” button or the “+” button (as rendered by the JE Counter), the corresponding event handler is called, the “count” is updated, and such “count” data (e.g., a state) is automatically exported or outputted to the JE Counter to update the UI in accordance therewith. In other words, in the depicted JC Counter example, whenever a button is clicked in the UI, a click handler is called, which in turn calls setCount, thereby updating the state. The render function is calling the count reader function, which will be rerun anytime the count state changes, causing the trusted website code definition element, JE Counter, to be updated. In addition, an API function reset is used to reset the counter.

With continued reference to the JC Counter example, the JC Counter is also a function (e.g., denoted as the JC constructor function) that returns a render function, that in turn, returns the ViewState which is the input of the trusted website code definition element (e.g., JE Counter). To complete full component capabilities (e.g., API functions and properties, access to selected DOM elements, or the like), the JC constructor function may return, in addition to the render function, additional API functions of the untrusted website code component, JC Counter (e.g., such as “reset” in JC Counter). The function can support component properties using the first function parameter Props< > (like Props<CounterProps> in JC Counter). The function also accepts a second parameter refs which is a proxy transformation component enabling access to selected DOM elements defined in the trusted website code definition element, JE Counter, with a ref attribute for event registration.

In one embodiment, the hybrid website interface rendering module 810 may be configured to provide a single sandbox execution environment. If one or more untrusted website code components are generated by a single third-party developer or supplier, such untrusted website code components may be executed or run in a single sandbox execution environment. In other embodiments, the hybrid website interface rendering module 810 may be configured to provide a plurality of sandbox execution environments. For example, if a first untrusted website code component is generated by a first third-party developer or supplier and a second untrusted website code component is generated by a second third-party developer or supplier, such untrusted website code components may be executed or run in two different sandbox execution environments. Similarly, if a third-party application embeds or nests code from other supplier(s) or additional parties (e.g., fourth-party code, fifth-party code, and so on), such untrusted website code components may be executed or run in two or more different/nested sandbox execution environments. A non-limiting contextual example of such a multi-layer sandbox is described in further detail with respect to FIG. 3C.

In some embodiments, a single untrusted website code component or multiple untrusted website code components may correspond to a single trusted website code definition element, but there must be a corresponding trusted website code definition element for each untrusted website code component. Said differently, at least one trusted website code definition element is minimally required in various embodiments of the present disclosure.

Moreover, although providing a primary execution environment in Block 102 is depicted as occurring prior to providing one or more sandbox execution environments in Block 104, it is contemplated in the present disclosure that Blocks 102 and 104 may occur in any order (e.g., Block 102 may be consecutively performed after Block 104, Block 104 may be consecutively performed after Block 102, Block 104 may be performed before Block 102 is complete, and the like), occur simultaneously, and/or the like. For example, providing a primary execution environment configured to execute one or more trusted website code definition elements and providing one or more sandbox execution environments optionally comprises mapping a rendering order of the one or more trusted website code definition elements across the execution environments.

Returning to Block 106 of FIG. 1A, method 100 further comprises providing one or more proxy transformation components that are configured to communicatively link the one or more untrusted website code component to at least one of the one or more trusted website code definition elements. For example, in some embodiments, hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to provide the one or more proxy transformation components.

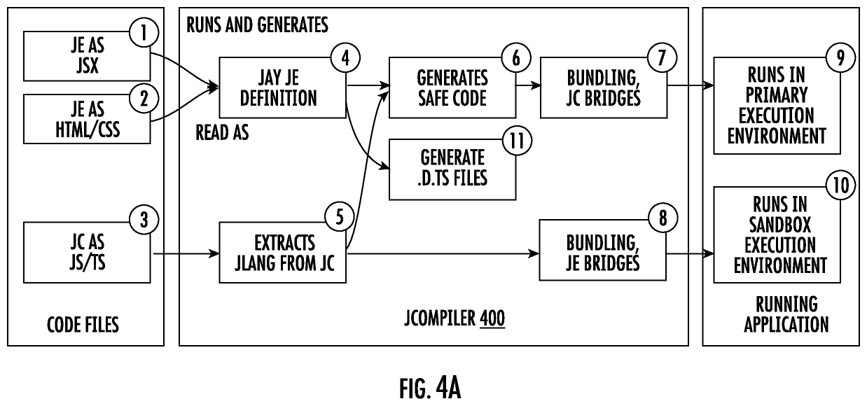

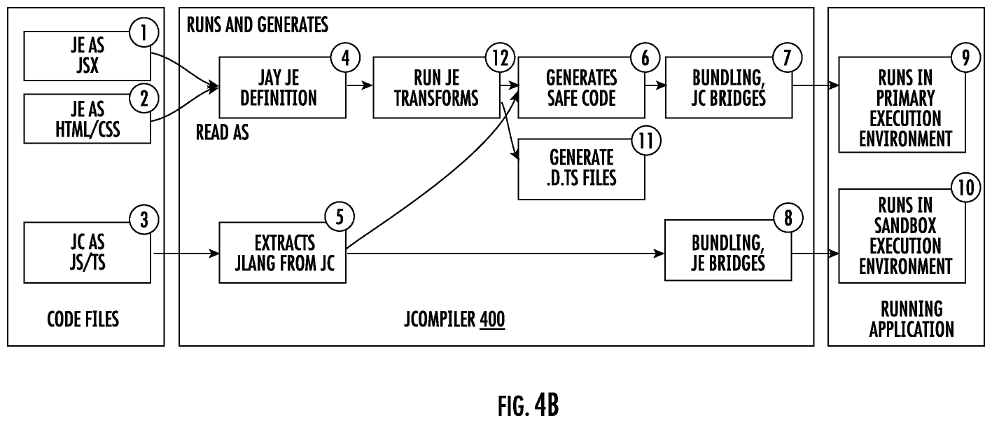

As set forth in Block 106, in some embodiments, a proxy transformation component is configured to communicatively link the one or more untrusted website code components (i.e., executing in the sandbox execution environment) to at least one of the one or more trusted website code definition elements (i.e., executing in the primary execution environment). For example, in some embodiments, one or more proxy transformation component(s) (e.g., as generated by a Jcompiler 400 as described with respect to FIGS. 4A and 4B) are used to represent or emulate the trusted website code definition element JE or untrusted website code component JC in matching contexts. In some embodiments, a trusted website code definition element JE executing in the primary execution environment is configured to receive a triggering event and transmit the triggering event downstream to a subsequent proxy transformation component (e.g., a primary execution environment proxy transformation component such as a JC Bridge or JC Stub as described below) executing in the primary execution environment, the subsequent proxy transformation component communicating a message to its corresponding untrusted website code component JC executing in a sandbox execution environment. In still further embodiments, the triggering event is a client event originating from a user interaction with a browser operating on a client device (e.g., client device 508).

In some embodiments, proxy transformation components can be of two types: a bridge-type or a stub-type. A bridge-type proxy transformation component serves as a proxy to a trusted website code definition element JE or untrusted website code component JC which has both parent and child nodes. A stub-type proxy transformation component serves as a proxy to a trusted website code definition element JE or untrusted website code component JC which has parent nodes but no child nodes. It is contemplated by this disclosure that proxy transformation components may be of other types and the disclosure is not limited to the specifically identified bridge-type and stub-type of proxy transformation components.

In some embodiments, a proxy transformation component may optionally be a primary execution environment proxy transformation component (e.g., a JC Bridge or a JC Stub) such that it operates in the primary execution environment and holds the rendering order place of the corresponding untrusted website code component JC. For example, a primary execution environment proxy transformation component (e.g., a JC Bridge or a JC Stub) acts as if it is the untrusted website code component JC in the primary execution environment and is responsible to provide the recorded “ViewState” to the trusted website code definition element JE as well as register event handlers on the trusted website code definition element JE and pass them back to the untrusted website code component JC. For example, in some embodiments, an untrusted website code component JC executes in a sandbox execution environment, an output of the execution of the untrusted website code component JC comprises tracked data, and the tracked data is communicated to a corresponding primary execution environment proxy transformation component (e.g., JC Bridge or JC Stub) executing in the primary execution environment. In some embodiments, the primary execution environment proxy transformation component creates child untrusted website code components as if they are created by the trusted website code definition elements (e.g., for nested components).

Such secure code components may be executed in either the primary execution environment or the sandbox execution environment. Additionally, or alternatively, in some embodiments, secure code components are used by event handlers of trusted website code definition elements and/or as actions triggered by untrusted website code components.

Additionally, or alternatively, in some embodiments, a proxy transformation component may optionally be a sandbox execution environment proxy transformation component (e.g., a JE Bridge or a JE Stub) such that it operates in the sandbox execution environment (e.g., including nested contexts or nested execution environments) and holds the rendering order place of the corresponding trusted website code definition element.

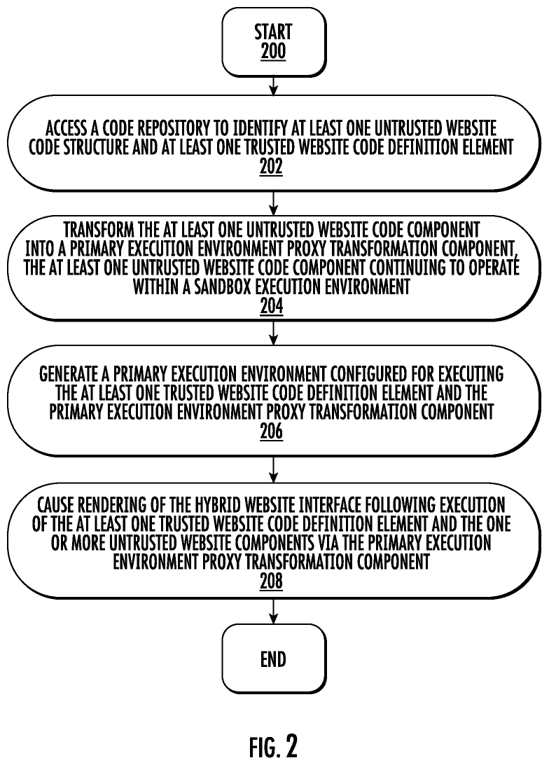

Proxy transformation components enable various embodiments of the present disclosure to work with a single object messaging method (OMM) message for each update cycle that can call the update method of all untrusted website code components JC in a sandbox execution environment, then call the update of all trusted website code definition elements in the primary execution environment. A sandbox execution environment proxy transformation component (e.g., a JE Bridge or JE Stub as depicted in FIGS. 2-4) enables building a single tree of all untrusted website code components JC in a secure context (e.g., a sandbox execution environment), allowing to render all data in the sandbox execution environment and record all inputs to trusted website code definition elements. Additionally, or alternatively, a primary execution environment proxy transformation component (e.g., JC Bridge as depicted in FIGS. 2-4) enables building a single tree for all trusted website code definition elements in the primary execution environment, allowing rendering of all trusted website code definition elements to DOM using the recorded data of the sandbox execution environment proxy transformation components (e.g., JE Bridges as depicted in FIGS. 2-4) as inputs provided by the primary execution environment proxy transformation component (e.g., JC Bridges as depicted in FIGS. 2-4) to the trusted website code definition elements. Together, such two trees, the first tree of trusted website code definition elements and primary execution environment proxy transformation components (e.g., JEs and JC Bridges as depicted in FIGS. 2-4) and the second tree of untrusted website code components and sandbox execution environment proxy transformation components (e.g., JCs, JE Bridges, and JE Stubs as depicted in FIGS. 2-4), enable a single message exchange using the OMM for a full rendering of the DOM. Example embodiments of the present disclosure may aggregate multiple messages sent from one execution environment to another (and propagate the messages inside the recipient tree) to affect such full rendering, or to otherwise save on bandwidth and communication between the multiple execution environments.

In addition, in some embodiments, declarative programming language (JLang) expressions may also be extracted from the untrusted website code components JC, to be run in the primary execution environment as secure code components or secure functions. Said differently, various embodiments of the present disclosure extract declarative programming language (JLang) expressions from the presentation code subcomponent of an untrusted website code component and compile the extracted declarative programming language (JLang) expressions to form a secure code component or secure function executing in the primary execution environment (e.g., thereby enabling support for gated APIs (GAPIs) gated by user activation in a safe way). In various embodiments of the present disclosure, two or more programs are running—a program running trusted code in the primary execution environment which calls one or more other programs running untrusted code in a sandbox execution environment. APIs denoted as GAPIs (e.g., APIs gated by user interaction such as “window.open” or the “HTMLMediaElement.play” APIs (or other modal windows)) are typically prevented from operating when using two or more programs. GAPIs are browser APIs which may be activated only when the user is actively interacting with the website (e.g., for security or user experience reasons) to ensure applications are unable to abuse APIs (e.g., popup prevention mechanisms). Thus, GAPIs may prevent background script usage as part of the browser security model. Asynchronous invocation of a GAPI (e.g., such as postMessage to a Worker or iFrame) or an HTTP request, may not function due to the GAPIs usage restrictions. Because various embodiments of the present disclosure enable the ability to write untrusted code compiled to trusted code to handle events directly in the first program (i.e., the primary execution environment running the trusted code), the GAPIs can be called synchronously. Said differently, portions of untrusted website code components written in declarative programming language (e.g., JLang) may be, for example, event handlers that are compiled into safe code that run in the primary execution environment, directly following the event, thus enabling the usage of GAPIs. Because the untrusted code for event handlers is written in declarative programming language, the compiler (e.g., Jcompiler 400 as depicted in FIGS. 4A and 4B) is able to verify it is “safe” and not causing any intentional side effects that can compromise the safe environment. A non-limiting contextual example of an event handler with declarative programming language for GAPIs is:

```
import {render, CounterRefs} from ‘./counter.jay.html’;
import ...
interface CounterProps {
    initialValue: number
}
function CounterConstructor(
  {initialValue}: Props<CounterProps>, refs: CounterRefs) {
    let [count, setCount] = createState(initialValue);
    refs.subtracter.$onclick(( ) => count % 2 == 0 && refs.audio.play( ))
      .then(( ) => setCount(count( ) − 1));
    refs.adder.$onclick(( ) => count % 2 == 0 && refs.audio.play( ))
      .then(( ) => setCount(count( ) + 1));
    const reset = ( ) => {setCount(0)}
    return {
        render: ( ) => ({count}),
        reset
    }
}
export const Counter =
  makeJayJC(render, CounterConstructor);
```

In the example above, the counter will play an audio file (e.g., defined as an audio element in the trusted website code definition element JE) when the counter value is even. The $onXXX denotes a function in declarative programming language, which is then extracted from the untrusted website code component, replaced with an identifier, and compiled to a safe function and included in the corresponding primary execution environment proxy transformation component (e.g., JC Bridge) for the untrusted website code component.

With continued reference to this example, when the event handler of the trusted website code definition element is triggered (e.g., the click event handler for the subtracter element), the primary execution environment proxy transformation component (e.g., JC Bridge) handles the event, runs the extracted and compiled declarative programming language expression, tracks the result of the declarative programming language expression and sends it back to the sandbox execution environment with the identifier. Then, the event handler of the untrusted website code component is triggered (e.g., .then( )), receiving as an input the value returned from the declarative programming language expression. Thereafter, the Jcompiler verifies the declarative programming language expression can be compiled to a safe code expression.

Returning to Block 108 of FIG. 1A, method 100 further includes causing rendering of the hybrid website interface following the execution of the at least one trusted website code definition element and the one or more untrusted website code components via the one or more proxy transformation components. For example, in some embodiments, hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to cause rendering of the hybrid website interface to a visual display of a client device 508A-B via a browser window.

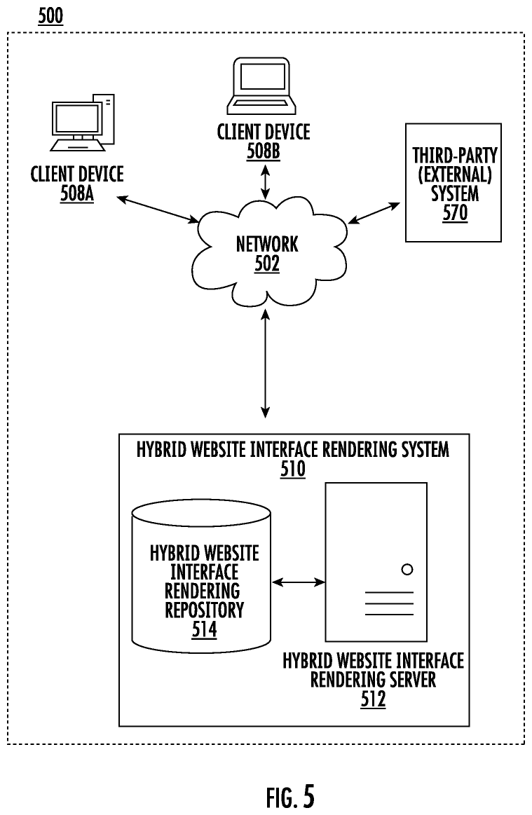

FIG. 1B is a signal diagram of an example data flow represented by method 100. FIG. 1B illustrates an example signal diagram illustrating data flow interactions between example components of the system 500 of FIG. 5, including a hybrid website interface rendering server, a repository, and a client device when implementing hybrid website interface rendering in accordance with one embodiment. Method 100 is described as being performed by a client device 508, a hybrid website interface rendering server 512, and a hybrid website interface rendering repository 514. These system components may be similar to those discussed with regard to the hybrid website interface rendering system 510 depicted in FIG. 5.

FIG. 2 is a flowchart broadly illustrating the series of operations or process blocks in method 200 that are executed or performed by a system or apparatus to enable rendering of the hybrid website interface in accordance with other example embodiments of the present disclosure. Like FIG. 1A, the operations of method 200 illustrated in FIG. 2 are described as being performed by a hybrid website interface rendering server 512 to avoid unnecessarily overcomplicating the discussion. The operations illustrated in FIG. 2 may be performed by, with the assistance of, and/or under the control of a server apparatus 800 (e.g., as depicted in FIG. 8) and/or a client apparatus 900 (e.g., as depicted in FIG. 9). In this regard, the performance of the operations may invoke one or more of memory 802, 902, processor 804, 904, input/output module 806, 906, communications module 808, 908, hybrid website interface rendering module 810, 910, and/or code splitting module 812, 912, as described in more detail below with respect to FIGS. 8 and 9.

In the embodiment illustrated in FIG. 2 the flowchart illustrates method 200 which includes accessing a code repository to identify at least one untrusted website code component and at least one trusted website code definition element at Block 202. For example, in some embodiments, a hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to access code repository to identify at least one untrusted website code component and at least one trusted website code definition element.

In some embodiments, a plurality of website code structures configured for rendering a hybrid website interface are stored in a code repository (e.g., hybrid website interface rendering repository 514, a third-party system 570, a combination thereof, or the like). For example, in some embodiments, one or more integrated sets of website code structures may comprise one or more directives (e.g., embedded or separate) indicating how the website code structures should be divided into trusted website code definition element(s) and/or untrusted website code component(s).

In still another embodiment, method 200 optionally comprises analyzing the website code structures in the code repository and determining how the website code structures should be divided into trusted website code definition element(s) and untrusted website code component(s). Such analysis may comprise analysis of the website code structures, data from additional source(s) (e.g., application store information, code configuration, version tracking systems, etc.), or some combination thereof. Such programmatic analysis may be based on various criteria defined by the system user in some embodiments. In still further embodiments, such programmatic analysis, determination, and/or identification may be performed by one or more trained machine learning models to programmatically determine and categorize the website code structure(s) as trusted website code definition element(s) or as untrusted website code component(s). In various embodiments of the present disclosure, the hybrid website interface rendering module 810 and/or code splitting module 812 analyzes a plurality of website code structures in the code repository, parses the plurality of website code structures, and programmatically determines and categorizes at least one website code structure as a trusted website code definition element and at least one other website code structure as an untrusted website code component.

Turning to Block 204 of FIG. 2, the flowchart illustrates method 200 which includes transforming the at least one untrusted website code component into a primary execution environment proxy transformation component, the at least one untrusted website code component continuing to operate within a sandbox execution environment. For example, in some embodiments, a hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to transform the at least one untrusted website code component into a primary execution environment proxy transformation component. In some embodiments, the primary execution environment proxy transformation component (e.g., a JC Bridge or a JC Stub) acts as if it is the untrusted website code component (JC) in the primary execution environment and it is responsible to provide the recorded “ViewState” to the trusted website code definition element (JE) as well as register event handlers on the trusted website code definition element (JE) and pass them back to the untrusted website code component (JC). In some embodiments, the primary execution environment proxy transformation component creates child untrusted website code components as if they are created by the trusted website code definition elements (e.g., for nested components).

Turning to Block 206, the flowchart illustrates method 200 which includes generating a primary execution environment configured for executing the at least one trusted website code definition element and the primary execution environment proxy transformation component. For example, in some embodiments, hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to generate a primary execution environment. A primary execution environment is an unsecured (i.e., not isolated from other environments or systems) or trusted environment, such as a web window or windows, which can run code, such as JS.

Turning to Block 208, the flowchart illustrates method 200 which includes causing rendering of the hybrid website interface following the execution of the at least one trusted website code definition element and the at least one untrusted website code component via the primary execution environment proxy transformation component. For example, in some embodiments, hybrid website interface rendering server 512, embodied by server apparatus 800, may include means, such as memory 802, processor 804, input/output module 806, communications module 808, hybrid website interface rendering module 810, code splitting module 812, and/or the like, which are collectively configured to cause rendering of the hybrid website interface to a visual display of a client device 508A-B via a browser window.

In a non-limiting contextual example depicted in FIG. 3A, a control/data flow diagram at run-time for rendering a hybrid website interface in accordance with various embodiments disclosed herein is illustrated in a simplified manner. FIG. 3A depicts the major components of an exemplary embodiment as well as a suggested flow between them. In the depicted embodiment, the application logical structure (e.g., as the developer writes the application) is to have an application Main Root (Main Root [1]), which is using a first untrusted website code component (JC [2]) and a first trusted website code definition element (JE [3]), which in turn is using another, second untrusted website code component (JC [4]), which is using another, second trusted website code definition element (JE [5]) to render a hybrid website interface. The logical data flow of the rendering is represented by the dashed lines (6).

Continuing with the non-limiting contextual example depicted in FIG. 3A, various embodiments of the present disclosure actually execute the website code at run-time by running the first untrusted website code component (JC [2]), the second untrusted website code component (JC [4]), a first proxy transformation component (JE Bridge [8]), and a second proxy transformation component (JE Stub [10]) in sandbox execution environment 302 (e.g., below the center horizontal line 303) using the communication lines (7), while the first trusted website code definition element (JE [3]), the second trusted website code definition element (JE [5]), and another proxy transformation component (JC Bridge [9]) are run in the primary execution environment 301 (e.g., above the center horizontal line 303) to render a hybrid website interface.

FIG. 3B illustrates a similar, but more complex use case, of a control/data flow diagram at run-time for rendering a hybrid website interface in accordance with various embodiments disclosed herein. In the depicted embodiment, untrusted website code components JC and trusted website code definition elements JE communicate bidirectionally using the object messaging method (OMM) (e.g., JC to JE and JE to JC). For example, the untrusted website code components JC send to the trusted website code definition element JE the data to render given some trigger or which declarative programming expression to run (as well as its inputs). The trusted website code definition element JE returns data about events happening in the DOM to the untrusted website code component JC. A Jcompiler creates the necessary code and interfaces that implement such communication. The information exchanged between the untrusted website code components JC and trusted website code definition elements JE may include regular data (e.g., content information), pointers to pre-compiled declarative programming language expressions, actual pre-defined (e.g., and pre-compiled) declarative programming language expressions, declarative programming language expressions compiled during run-time using an analyzing just-in-time (JIT) version of the Jcompiler, and/or the like.

With continued reference to the depicted embodiment in FIG. 3B, during site loading/initialization, the Main Root [1] gets called by a website browser or any computer program and the Main Root [1] calls (e.g., using any available OMM) the Sandbox Root [2] executing in the sandbox execution environment 302. Said differently, various embodiments of the present disclosure receive a code execution request, the code execution request triggers an execution instruction to the trusted root website code definition element (e.g., Main Root [1]) of the primary execution environment 301 and the trusted root website code definition element transmitting another execution instruction to the untrusted root website code component (e.g., Sandbox Root [2]) of the sandbox execution environment 302.

At this point, the sandbox execution environment 302 runs the code in a sandbox tree simulating the same call/rendering order in which the trusted website code definition elements JE would be called/rendered (e.g., Depth First Search or other related methods, etc.). However, as this run is performed in a sandbox execution environment 302, it does not result in, or perform, the actual rendering. Instead, this run only keeps track and/or records the data that is being changed in the untrusted website code components JC while the sandbox execution environment 302 “plays” or simulates rendering of the code. During this process, the proxy transformation components, JE Bridges [11], [12], [13], and JE Stubs [15], [16], [17], [18], track the input data received from the untrusted website code components JC. The untrusted website code components JC starts running by running the Sandbox Root [2], with the sandbox execution environment 302 responsible at run-time for setting up the required isolation structures and supporting elements (e.g., Workers, iFrames, or other isolation mechanisms).

With continued reference to the depicted embodiment in FIG. 3B, during site loading/initialization, the tracked data is sent back to the Main Root [1] and the Main Root [1] runs the actual rendering order of the trusted website code definition elements JE and the proxy transformation components in the primary execution environment 301. During this process, the JC Bridges [21], [22], [23], [24], [25], [26], [27], provide the tracked data from the proxy transformation components (JE bridges and JE Stubs) to the trusted website code definition elements JE for the actual and initial rendering of the hybrid website interface. In the illustrated example depicted in FIG. 3B, the data that the proxy transformation component JE Bridge tracks is used as the input data for rendering trusted website code definition element JE while the data that the proxy transformation component JE Bridge tracks is used as input for rendering trusted website code definition element JE [33]. It is contemplated by the present disclosure that such run-time execution may be done for user code, generated code, and/or third-party code.

With continued reference to the depicted embodiment in FIG. 3B, during website serving, different events (e.g., from the user, other servers, through the network, WBS events, containing website events, etc.) may be received, thereby requiring updating hybrid website interface rendering. Client events (e.g., originating from user interactions with the browser) are received or “caught” using the event listeners of the trusted website code definition elements JE and when an event arrives, the trusted website code definition element JE passes it “upwards” to the corresponding JC bridge, which sends a message (e.g., via any relevant OMM) to its corresponding “twin” untrusted website code component JC operating in the sandbox execution environment 302, which may trigger “virtual rendering” downstream. The output data of the untrusted website code component JC is tracked/recorded and sent back to the proxy transformation component JC Bridge, the data is compared, and rendering, by the trusted website code definition elements JE takes effect (e.g., updated rendering), if necessary.

It is contemplated by the present disclosure that embodiments of the system may be responsible for routing events and/or messages between untrusted website code components JC and trusted website code definition elements JE (e.g., via any relevant OMM) and other event routing tasks may be handled externally of the inventive system. Example object messaging methods (OMMs) include HTML5 PostMessage, using URL fragment identifier for messages, specialized communication web service, through HTML5 local storage, through HTML5 local file system access APIs, specialized browser plug-in, local shared object (LSO) (e.g., flash cookies), other communication method which may be developed in the future, and/or the like. Details regarding a number of these communication methods are described in commonly-owned U.S. Pat. No. 10,509,850, which was filed Feb. 10, 2014 as U.S. patent application Ser. No. 14/176,166, and is entitled “THIRD PARTY APPLICATION COMMUNICATION API,” which patent is incorporated by reference herein in its entirety. A myriad of other communication methods is contemplated by this disclosure and the present claims are not limited to the provided examples.

In some embodiments, a proxy transformation component may optionally include compiled declarative programming language code (e.g., extracted from the corresponding untrusted website code component) that runs some expressions on the event received from the trusted website code definition element, calling GAPIs or extracting data from the event and/or DOM model, to be sent back to the event handler of the untrusted website code component JC. For example, with continued reference to the depicted embodiment in FIG. 3B, in an instance wherein an event is triggered by the trusted website code component JE executing in the primary execution environment 301, the trusted website code component JE reports the event to the proxy transformation component JC Bridge [23], which in turn sends a message (e.g., using OMM message or other means) to the untrusted website code component JC executing in the sandbox execution environment 302. The untrusted website code component JC performs simulated or virtual rendering of itself and the downstream tree of untrusted website code components, thereby tracking the data on proxy transformation components JE Bridge and JE Stubs [15], [16]. This tracked data is then sent back to the primary execution environment 301 and is used to actually render the subtree of the proxy transformation component JC Bridge [23].

FIG. 3C illustrates another more complex use case of a control/data flow diagram for rendering a hybrid website interface with a multi-layer or nested layers sandbox execution environment in accordance with various embodiments disclosed herein. Various embodiments of the present disclosure enable logical nesting of sandbox execution environments 302A and 302B, such as cases wherein website code or an application is using a third-party code (e.g., comprising JCs and JEs), which in turn is using another third-party code (e.g., also comprising JCs and JEs), and so on. Such multiple third-party code structures may be provided (or executed) by a single third-party or developer or by multiple additional parties (e.g., third-party, fourth-party, fifth-party, and so on). In such a case, the layout of the run-time stage becomes one tree of trusted website code definition elements JE and proxy transformation components in the primary execution environment 301, with two or more sandbox execution environments 302A, 302B, each of which runs the potentially unsafe code of each third-party code, including an instance wherein one third-party code is nested into another third-party code.

As depicted in the embodiment of FIG. 3C, a website page built using various embodiments of the present disclosure would generally have a single trusted website code definition element tree and multiple untrusted website code component trees. It is further contemplated by the present disclosure that a page may contain multiple display contexts (e.g., separate pop-up windows) which would be handled by various embodiments of the present disclosure as separate instances (e.g., each with their own execution environments, 301, 302A, 302B, trusted website code definition element tree, and untrusted website code component trees).

With continued reference to the depicted embodiment in FIG. 3C, during the compile stage, the Jcompiler reads the trusted website code definition elements JE and untrusted website code components JC of the main or primary website or application, as well as the trusted website code definition elements and untrusted website code components of the third- and fourth-parties. The Jcompiler then generates three bundles: (i) a secure bundle including the code generated from the trusted website code definition elements JE of the main or primary website or application, from the trusted website code definition elements JE of the third-party code, and from the trusted website code definition elements JE of the fourth-party code; (ii) a sandbox 1 bundle including the untrusted website code components JC of the third-party code; and (iii) a sandbox 2 bundle including the untrusted website code components JC of the fourth-party code. As depicted by JC [2] and JC [4] running in the primary execution environment 301 in the embodiment of FIG. 3C, it is contemplated by the present disclosure that some third-party code from the main application may optionally be included in the (i) secure bundle (e.g., after being compiled from declarative programming language and thus verified for security as well as assuming they are initially trusted at a higher level) as “trusted” JCs.

With continued reference to the depicted embodiment in FIG. 3C, during the run-time stage, the Main Root [1] running in the primary execution environment 301 gets called by the website browser or any computer program and starts to render “trusted” JCs [2], [4] and trusted website code definition element JE [3] without a sandbox or isolation mechanism. As described above, the “trusted” JCs [2], [4] are third-party code component structures for which a sufficient level of trust has been achieved which allows them to be optionally executed in the primary execution environment 301.

With continued reference to the depicted embodiment in FIG. 3C, once the trusted website code definition element JE [3] tree reaches untrusted website code component JC [5] of the third-party, the trusted website code definition element JE [3] calls (e.g., via OMM message) the other computer program running in the first sandbox execution environment 302A. Said differently, in some embodiments, the rendering order comprises at least a trusted root website code definition element (e.g., Main Root [1]) of the primary execution environment 301 and an untrusted root website code component (e.g., Sandbox Root [18]) of the first sandbox execution environment 302A.

With continued reference to the depicted embodiment in FIG. 3C, the code (e.g., sandbox tree) in the first sandbox execution environment 302A executes simulating the same call/rendering order in which the trusted website code definition elements JE would be called/rendered in a sandbox/safe environment, as explained above. During this process, the proxy transformation component JE Bridge [8] tracks the input data received from the untrusted website code component JC [6]. Having untrusted website code components JC from another third-party (e.g., the fourth-party), the first sandbox execution environment 302A simulates such fourth-party code as the proxy transformation components JC Bridges [11], [12], which in turn, record the input data for the corresponding untrusted website code components JC. The recorded data from the proxy transformation components, JE Bridges and JC Bridges, is returned by the Sandbox Root [18] to the trusted website code definition element JE [3] running in the primary execution environment 301, thereby enabling the rendering of the rest of the trusted website code definition elements tree.

With continued reference to the depicted embodiment in FIG. 3C, when the rendering of the trusted website code definition elements tree arrives at a trusted website code definition element JC which has untrusted website code components JC from the fourth-party (e.g., JC [7]), it calls the second program running in the second sandbox execution environment 302B. Additionally, or alternatively, in some embodiments, the rendering of the proxy transformation component JE Bridge [8] in the first sandbox execution environment 302A triggers the fourth-party rendering. The fourth-party code runs in the sandbox 2 tree in the second sandbox execution environment 302B simulating the call/rendering order of the trusted website code definition elements of the fourth-party in a different sandbox/safe environment. During this process, proxy transformation components JE Stubs [16], record the inputs, which are then returned by the Sandbox Root of the second sandbox execution environment 302B to the trusted website code definition element JE [7], thereby continuing the rendering process.

A non-limiting contextual example of a multi-layer or nested layers sandbox execution environment in accordance with FIG. 3C is provided below. This example demonstrates a composition of components into a composite component (e.g., a table component built of Row and Cell components). The untrusted website code component (JC) for a table component provides:

```
import {render, TableRefs} from ‘./table.jay.html’;
import {createState, makeJayComponent, Props } from ‘jay-component’;
import { mutableObject } from ‘jay-reactive’;
interface TableProps {
  data: string[ ][ ]
}
function TableConstructor({data}: Props<TableProps>, refs: TableRefs) {
  let [line, _] = createState(( ) => {
    let tableLines = [ ]
    for (let x = 0; x < data( ).length; x++) {
      tableLines[x] = {id: x, row: [ ]};
      for (let y = 0; y < data( )[x].length; y++) {
        tableLines[x].row[y] = {id: y, value: data( )[x][y]};
      }
    }
    return mutableObject(tableLines)
  });
  return {
    render: ( ) => ({line})
  }
}
export const Table = makeJayComponent(render, TableConstructor);
```

The trusted website code definition element (JE) for a table component provides:

```
<html>
<head>
    <link rel=“import” href=“./row” names=“Row”/>
    <script type=“application/yaml-jay”>
data:
  line:
  - id: number
    row:
      - id: number
        value: number
    </script>
</head>
<body>
<div>
    <table>
        <tbody>
        <Row forEach=“line” trackBy=“id” row={row}/>
        </tbody>
    </table>
</div>
</body>
</html>
```

The untrusted website code component (JC) for a table row component provides:

```
import {render, TableRowRefs} from ‘./table-row.jay.html’;
import {createState, makeJayComponent, Props } from ‘jay-component’;
import { mutableObject } from ‘jay-reactive’;
interface TableRowProps {
  row: string[ ]
}
function TableRowConstructor({row}: Props<TableRowProps>, refs:
TableRowRefs) {
  return {
    render: ( ) => ({row})
  }
}
export const Row = makeJayComponent(render, TableRowConstructor);
```

The trusted website code definition element (JE) for a table row component provides:

```
<html>
<head>
      <link rel=“import” href=“./cell” names=“Cell”/>
      <script type=“application/yaml-jay”>
data:
  row:
  - id: number
      value: string
      </script>
</head>
<body>
<div>
    <Cell forEach=“row” trackBy=“id” value={value}></Cell>
</div>
</body>
</html>
```

The untrusted website code component (JC) for a table cell component provides:

```
import {render, TableCellRefs} from ‘./table-cell.jay.html’;
import {createState, makeJayComponent, Props } from ‘jay-component’;
import { mutableObject } from ‘jay-reactive’;
interface TableCellProps {
  value: string
}
function TableCellConstructor({value}: Props<TableCellProps>, refs:
TableCellRefs) {
  return {
    render: ( ) => ({value})
  }
}
export const Cell = makeJayComponent(render, TableCellConstructor);
```

The trusted website code definition element (JE) for a table cell component provides:

```
<html>
<head>
      <script type=“application/yaml-jay”>
data:
  value: string
      </script>
</head>
<body>
<div>
    <td>{value}</td>
</div>
</body>
</html>
```

Such example is intentionally trivial but demonstrates the capability of composition and yet can be rendered with a single message cycle between the primary execution environment and the sandbox execution environment.

It is contemplated by the present disclosure that various embodiments of the system may employ multiple execution units running the same structure (e.g., as the JC and JE trees are aligned/homomorphic). It is also contemplated by the present disclosure that various embodiments of the system may execute using a simulation mode (e.g., run the JC tree and send results to the trusted website code definition element). If the system needs to support interactivity (e.g., due to user click or database information change), various embodiments of the system may be configured to re-execute only the sub-tree associated with the node to which the interactivity event applies. Such simulation may need to provide a specific handling of side effects of the executed code (e.g., if any).

It is contemplated by the present disclosure that, in some instances, code may not be properly classified as a trusted website code definition element JE or as an untrusted website code component JC. It is also contemplated by the present disclosure that code may be able to be run in both the primary execution environment 301 and a sandbox execution environment 302. For example, code related to metering, profiling, security, provisioning, underlying infrastructure, or other system aspects which may in neither or both of a trusted website code definition element and an untrusted website code component.

Turning to FIG. 10, example operations for enabling rendering of a hybrid website interface in accordance with another embodiment of the present disclosure are shown. In particular, FIG. 10 is a flowchart broadly illustrating the series of operations or process blocks in the method 1000 that are executed or performed by a system or apparatus to enable rendering of a hybrid website interface in accordance with some example embodiments of the present disclosure. To avoid unnecessarily overcomplicating the discussion, the operations of method 1000 illustrated in FIG. 10 are described as being performed by a hybrid website interface rendering server, however, some or all of the steps can also be performed by, with the assistance of, and/or under the control of a system, such as a hybrid website interface rendering system or a website building system, and/or a client apparatus (e.g., one or more of client devices 508A-B).

For example, hybrid website interface rendering system 510 or website building system 610 may be configured to perform method 1000 for a plurality of different web pages, websites, code-based content, and/or the like. The operations illustrated in FIG. 10 may be performed by, with the assistance of, and/or under the control of a server apparatus 800 (e.g., as depicted in FIG. 8) and/or a client apparatus 900 (e.g., as depicted in FIG. 9). Performance of the operations may invoke one or more of memory 802, 902, processor 804, 904, input/output module 806, 906, communications module 808, 908, hybrid website interface rendering module 810, 910, and/or code splitting module 812, 912, as described in more detail below with respect to FIGS. 8 and 9.

In the embodiment illustrated in FIG. 10, the flowchart illustrates method 1000 which includes identifying one or more trusted code sections in an untrusted candidate code corpus at block 1002. For example, an untrusted candidate code corpus may comprise a plurality of website code structures configured for rendering a hybrid website interface and such untrusted candidate code corpus may be stored in one or more code repositories (e.g., hybrid website interface rendering repository 514, a third-party system 570, a combination thereof, or the like).

In some embodiments, block 1002 is performed, at least in part, by a compiler. For example, in some embodiments, the compiler applies one or more analyses to selectively identify such trusted code sections. The compiler may use static analysis to analyze the un-compiled code and identify one or more trusted code sections based on one or more algorithms, pattern matching, rules, and/or the like. That is, a compiler may use one or more code analysis factors to make suggestions or predictions to identify trusted code sections. For example, identifying one or more trusted code sections comprises identifying one or more detectable code patterns, such as matching sections of the untrusted candidate code to predetermined patterns of code that are deemed safe.

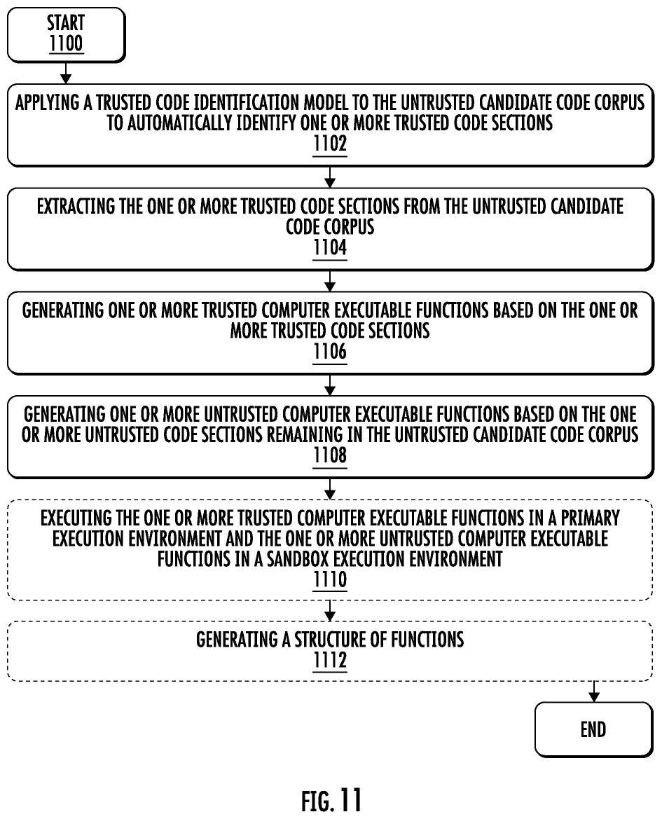

Code that may be considered as trusted code may be defined by a user (e.g., a system provider, a vendor, a third party, a website, an, application designer, a developer, etc.), set of rules or patterns, machine learning algorithm, verification process, etc., or some combination thereof. For example, a user may predefine specific code syntax to be trusted code. In another example, trusted code may be code defined as using APIs not available in the sandbox execution environment and having recognized patterns that can be verified using static analysis and/or machine learning. In still further embodiments, identifying one or more trusted code sections is based at least in part on code sections using one or more allowed APIs. In some embodiments, the compiler may apply static analysis to match sections of code in the untrusted candidate code corpus to predetermined patterns of code (e.g., detectable code patterns). In other words, in a preparation stage, specific patterns of trusted code are identified as trusted code sections. In still further embodiments, the compiler applies a trusted identification model as described more herein with respect to FIG. 11.

Turning to block 1004 of FIG. 10, method 1000 further includes extracting the one or more trusted code sections from the untrusted candidate code corpus. For example, the one or more trusted code sections may be selectively removed from the untrusted candidate code corpus such that only untrusted code remains in the untrusted candidate code corpus. The sections in the untrusted candidate code corpus where the trusted code sections were extracted from (i.e., the one or more split points) become placeholders with associated identifiers to which later information (e.g., at runtime) may be sent to and from the trusted code sections and untrusted code sections (e.g., communicably interconnected trusted computer executable functions and untrusted computer executable functions, such as via a reciprocal communication. In this manner, information remains capable of flowing through the code after the one or more trusted code sections are extracted from the candidate code corpus. In some embodiments, block 1004 is performed, at least in part, by a compiler. For example, in some embodiments, the compiler extracts the one or more trusted code sections from the untrusted candidate code corpus.

At block 1006 of FIG. 10, method 1000 further includes generating one or more trusted computer executable functions based on the one or more trusted code sections. In some embodiments, block 1006 is performed, at least in part, by a compiler. For example, the one or more trusted code sections extracted are used to generate (e.g., compile) a respective one or more trusted computer executable functions capable of running the respective one or more trusted code sections. A trusted computer executable functions may receive, as an input, the output of another computer executable function (e.g., an untrusted computer executable function). Additionally, or alternatively, another computer executable function (e.g., an untrusted computer executable function) may receive, as an input, the output of a trusted computer executable function. The one or more trusted computer executable functions are optionally executed or expected to be executed in a primary execution environment.

Turning to block 1008 of FIG. 10, method 1000 further includes generating one or more untrusted computer executable functions based on one or more untrusted code sections remaining in the untrusted candidate code corpus. For example, one or more untrusted code sections may be defined by the one or more split points resulting from the one or more trusted code sections being extracted. In some embodiments, block 1008 is performed, at least in part, by a compiler. For example, in some embodiments, the compiler extracts the one or more trusted code sections from the untrusted candidate code corpus. The one or more untrusted code sections may then be used to generate (e.g., compile) a respective one or more untrusted computer executable functions capable of running the respective one or more untrusted code sections. An untrusted computer executable functions may receive, as an input, the output of another computer executable function (e.g., a trusted computer executable function). Additionally, or alternatively, another computer executable function (e.g., a trusted computer executable function) may receive, as an input, the output of an untrusted computer executable function. The one or more untrusted computer executable functions are optionally executed or expected to be executed in a sandbox execution environment.

Additionally or alternatively, method 1000 optionally further includes statistically generating a report during compilation (e.g., during block 1008) that is based on one or more compilation performance metrics and providing the statistically-generated report to a user. For example, an untrusted computer executable function may require access to an API that is not available to the untrusted computer executable function in a sandbox execution environment and the method 1000 may optionally include reporting such issue via the statistically-generated report to the user so that it may be addressed during compilation and prior to proceeding to block 1010.

At block 1010 of FIG. 10, method 1000 further includes rendering the hybrid website interface following execution of the one or more trusted computer executable functions in a primary execution environment and the one or more untrusted computer executable functions in a sandbox execution environment. For example, a provider hosting website services may receive code-based content from a third-party configured to provide a hybrid website interface. To securely execute the third-party code-based content, the provider may perform a code splitting operation in accordance with embodiments described herein. Once the third-party code-based content has been complied as one or more trusted computer executable functions in a primary execution environment and one or more untrusted computer executable functions in a sandbox environment, the provider may safely execute the code in the respective environments, thereby rendering the hybrid website interface the code-based content is configured to provide. By executing untrusted code in the sandbox execution environment, the provider executing the third-party code-based content is protected from potentially malicious or erroneous code.

### Example Trusted Code Splitting Operation Overview and Embodiments

Example embodiments of the present disclosure may proceed to automatically perform trusted code splitting to an untrusted candidate code corpus in a number of ways. Accordingly, various processes in accordance with the present disclosure are described herein.

Turning now to FIG. 11, example operations are shown for automatically performing trusted code splitting to an untrusted candidate code corpus. In particular, FIG. 11 is a flowchart broadly illustrating the series of operations or process blocks in method 1100 that are executed or performed by a system or apparatus to automatically perform trusted code splitting in accordance with some example embodiments of the present disclosure. To avoid unnecessarily overcomplicating the discussion, the operations of method 1100 illustrated in FIG. 11 are described as being performed by a hybrid website interface rendering server, however, some or all of the steps can also be performed by, with the assistance of, and/or under the control of a hybrid website interface rendering server, a system (e.g., a hybrid website interface rendering system or a website building system), and/or a client apparatus (e.g., one or more of client devices 508A-B).

For example, website building system 610 may be configured to perform method 1100 for a plurality of different web pages, websites, code-based content, and/or the like. The operations illustrated in FIG. 11 may be performed by, with the assistance of, and/or under the control of a server apparatus 800 (e.g., as depicted in FIG. 8) and/or a client apparatus 900 (e.g., as depicted in FIG. 9). Performance of the operations may invoke one or more of memory 802, 902, processor 804, 904, input/output module 806, 906, communications module 808, 908, hybrid website interface rendering module 810, 910, and/or code splitting module 812, 912, as described in more detail below with respect to FIGS. 8 and 9.

In the embodiment illustrated in FIG. 11, the flowchart illustrates method 1100 which includes applying a trusted code identification model to an untrusted candidate code corpus to automatically and selectively identify one or more trusted code sections at block 1102. In some embodiments, a server (e.g., hybrid website interface rendering server 512), embodied by server apparatus 800, may include means, such as memory 802, processor 804, input/output module 806, communications module 808, hybrid website interface rendering module 810, code splitting module 812, and/or the like, which are collectively configured to apply a trusted code identification model to an untrusted candidate code corpus. In some embodiments, trusted code sections are code sections that are deemed essentially safe or secure, such that the trusted code sections may be trusted to execute in a primary execution environment.

An untrusted candidate code corpus may comprise a plurality of code sections (e.g., website code structures configured for rendering a hybrid website interface) and such untrusted candidate code corpus may be stored in one or more code repositories (e.g., hybrid website interface rendering repository 514, a third-party system 570, a combination thereof, and/or the like).

The one or more trusted code sections may be selectively identified via application of the trusted code identification model to the untrusted code corpus. That is, the trusted code identification model may apply one or more analyses to identify such trusted code sections. For example, in some embodiments, the trusted code identification model may apply one or more algorithms (e.g., array reconciliation), pattern matching, and/or rules to identify trusted code sections. That is, the trusted code identification model may apply one or more defined rules and/or match one or more defined patterns of code to identify sections of the code within the untrusted candidate code corpus as trusted code sections. In still further embodiments, the trusted code identification model may use one or more policies to define what identifiable code patterns and/or APIs are considered trusted, given a specific use case. For example, the trusted code identification model may be used to enforce third party permissions by limiting which code patterns and APIs third party code can run in a primary execution environment. That is, embodiments of the present disclosure may benefit from any collected business information on the usage of the same/previous code from other uses or in similar situations.

In some embodiments, a trusted code identification model may use one or more code analysis factors to make suggestions or predictions as to trusted code sections. For example, in some embodiments, the trusted code identification model applies one or more trusted code identification rules to automatically identify the one or more trusted code sections, the one or more trusted code identification rules being based on one or more code analysis factors. In a non-limiting contextual example, the trusted code identification model may identify one or more potential trusted code sections based on a code analysis factor, such as collected and/or historical code identification data, demonstrating execution of the same or similar code sections in other places throughout the WBS.

Additionally or alternatively, in some embodiments, a trusted code identification model may use one or more code analysis factors to make suggestions or predictions as to untrusted code sections. For example, in some embodiments, the trusted code identification model applies one or more trusted code identification rules to automatically identify the one or more untrusted code sections (e.g., based on the code section NOT satisfying the trusted code identification rule), the one or more trusted code identification rules being based on one or more code analysis factors. In another non-limiting contextual example, the trusted code identification model may identify one or more potential untrusted code sections based on one or more code analysis factors, such as collected and/or historical code identification data (e.g., security history), demonstrating execution of the same or similar code sections in other places throughout the WBS, such as past use of such code for nefarious purpose(s).

In still some further embodiments, the trusted code identification model may be an AI-based model or a non-AI based model. For instance, in a non-limiting example, the trusted code identification model may be a non-AI based model that applies pattern matching on an Abstract Syntax Tree (AST), which is a tree representation of the source code. The trusted code identification model may identify one or more detectable code patterns that have previously been deemed to be safe and/or optionally, not safe (e.g., past use of detectable code pattern for nefarious purpose(s)). In particular, the trusted code identification model may apply static analysis to match sections of the untrusted candidate code corpus in the AST to predetermined patterns of code (e.g., detectable code patterns). In another example, the trusted code identification model is a non-AI based model that locates trusted code sections (or untrusted code sections) based on naming conventions. In still a further example, identifying one or more trusted code sections is based at least in part on the corresponding trusted code section using one or more allowed APIs. Additionally or alternatively still, in some embodiments, identifying one or more untrusted code sections may be based at least in part on the corresponding untrusted code section using one or more APIs that are not allowed. In still another example, a trusted code identification model applies declarative code recognition such that it identifies declarative code as trusted code section(s), as described herein.

In some embodiments, the trusted code identification model is optionally iteratively trained to identify one or more detectable code patterns of trusted code sections (or untrusted code sections) in a supervised training process. For example, the trusted code identification model may be trained based on one or more of system provider-defined trusted code, vendor-defined trusted code, or third party-defined trusted code. Additionally or alternatively, in some embodiments, the trusted code identification model is optionally iteratively trained to identify one or more detectable code patterns of trusted code sections in an unsupervised training process.

A non-limiting contextual example of a code splitting operation in accordance with block 1102 is provided below. This example demonstrates applying a trusted code identification model to a sample untrusted candidate code corpus in order to automatically identify one or more trusted code section. In this contextual example, the untrusted candidate code corpus includes:

```
function title_change(event) {
  let value = (event.target as HTMLInputElement).value;
  setEditText(value);
}
function title_keydown(event, todo) {
  let which = event.which;
  if (which === ESCAPE_KEY) {
    todo.editText = todo.title;
    todo.isEditing = false;
} else if (which === ENTER_KEY) {
  handleSubmit( );
}
```

In this contextual example, the security policy is to not allow code running in a sandbox execution environment to interact with the DOM and/or DOM events and to extract or hoist such DOM event interactions selectively for compiling into trusted code that may be executed in a primary execution environment. Accordingly, in this contextual example, the relevant rules applied by the trusted code identification model include:
(1) event is a parameter of the event handler, of Type Event (native browser event type)
(2) Allow access to event.target.value
(3) Allow access to event.which
(4) Do not allow access to any other event attribute

Using these identified rules, the trusted code identification model processes the code sections in the untrusted candidate code corpus and identifies any sections of code that comply with the given rules as trusted code sections. With continued reference to the non-limiting contextual example, the trusted code identification model identifies (event.target as HTMLInputElement).value, setEditText(value), and event.which as trusted code sections. The remaining code not identified as trusted code is, by default, identified as untrusted code sections.

Returning to FIG. 11, block 1104 of method 1100 further includes extracting the one or more trusted code sections from the untrusted candidate code corpus. In this manner, the untrusted candidate code corpus is split at one or more points of extracted trusted code sections. Such trusted code sections may be split or extracted so as to eventually be compiled to run in a primary execution environment. Any remaining code in the untrusted candidate code corpus will eventually be compiled to run in one or more sandbox execution environments.

Turning to block 1106 of FIG. 11, method 1100 further includes generating one or more trusted computer executable functions based on the one or more trusted code sections. In other words, the code sections identified as trusted code sections in block 1102 and extracted from the untrusted candidate code corpus in block 1104 may be compiled as one or more trusted computer executable functions. A trusted computer executable function is a computer executable function that may be executed in a primary execution environment. With continued reference to the non-limiting contextual example, the trusted code sections may be generated as the following trusted computer executable functions:

```
function pre_title_change(event) {
  return (event.target as HTMLInputElement).value;
}
function title_change_tag(value) {
  setEditText(value)
}
function pre_title_keydown(event) {
  return event.which;
}
```

In some embodiments, trusted computer executable functions may be generated in compliance with one or more predetermined rules.

Turning to block 1108 of FIG. 11, method 1100 further includes generating one or more untrusted computer executable functions based on one or more untrusted code sections remaining in the untrusted candidate code corpus. For example, one or more untrusted computer executable functions may be generated wherein each untrusted computer executable function is based on one or more sections of untrusted code. An untrusted computer executable function is a computer executable function that may be executed in a sandbox execution environment. With continued reference to the non-limiting contextual example described above, the remaining untrusted code sections may be generated as the following untrusted computer executable function:

```
function title_keydown_tag(which, todo) {
  if (which === ESCAPE_KEY) {
    todo.editText = todo.title;
    todo.isEditing = false;
  } else if (which === ENTER_KEY) {
    handleSubmit( );
  }
}
```

Similar to trusted computer executable functions, untrusted computer executable functions may be generated in compliance with one or more predetermined rules.

In some embodiments, generating the one or more trusted computer executable functions and generating the one or more untrusted computer executable functions may comprise generating a reciprocal communication pathway between the one or more trusted computer executable functions and the one or more untrusted computer executable functions. The reciprocal communication pathway may be configured to transmit one or more execution input parameters, one or more execution return values, or a combination thereof between the functions during execution of the one or more trusted computer executable functions and the one or more untrusted computer executable functions. By generating such a reciprocal communication pathway, the present disclosure provides the ability to capture, for example, the result of the execution of a trusted computer executable function in the primary execution environment and return or place such captured result (i.e., instead of the extracted trusted code section) in the untrusted computer executable function to continue running in the sandbox execution environment. That is, in some embodiments, a placeholder with a corresponding identifier is put in the place of the extracted trusted code in the untrusted computer executable function running in the sandbox execution environment and the captured result from the primary execution environment is returned to the placeholder. In other words, the trusted code section is extracted from the untrusted code, replaced with an identifier, and compiled to a safe, trusted computer executable function which can be run in the primary execution environment. The event is handled in the primary execution environment, the result of the execution of the trusted computer executable function is tracked and sent back to the sandbox execution environment with the identifier. Then, the event handler of the untrusted computer executable function is triggered (e.g., .then( ), receiving as an input the value returned from the trusted computer executable function. Thus, even though the code is now split into trusted computer executable functions and untrusted computer executable functions in accordance with the given rules, information, such as input parameters and/or return values are allowed to flow between the several generated functions, as necessary. In this manner, the code may function normally if executed at runtime even after being separated into several generated functions executing in different execution environments. For example, in some embodiments, the one or more trusted computer executable functions and one or more untrusted computer executable functions are executed in a primary execution environment and sandbox execution environment respectively to safely and efficiently obtain the intended result of the untrusted candidate code corpus (e.g., render a hybrid website interface).

In another non-limiting contextual example, an example untrusted candidate code corpus for rendering a To Do list is provided:

```
refs.newTodo
  .oninput(({event}) =>
      setNewTodo(event.target as HTMLInputElement).value)
  })
refs.newTodo
  .onkeydown(({event}) => {
      (event.keyCode === ENTER_KEY)?event.preventDefault( ):‘’
      if (event.keyCode === ENTER_KEY)
        return;
      let newValue = newTodo( );
      let val = newValue.trim( );
      if (val) {
        todos( ).push({
          id: uuid( ), title: val, isEditing: false,
          editText: ‘’, isCompleted: false
        })
      }
      setNewTodo(‘’);
    })
```

In accordance with block 1102 of method 1100, a trusted code identification model may be applied to such untrusted candidate code corpus. In this non-limiting contextual example, the trusted code identification model applies the following relevant rules in order to identify safe patterns of code:
(1) Read event.target.value

(2) Read event.keyCode
(3) Read const variables
(4) Use literal strings
(5) Call event.preventDefault( )event is a parameter of the event handler, of Type Event (native browser event type)

Using these identified rules, the trusted code identification model may process the code sections in the untrusted candidate code corpus for rendering a To Do list and identify sections of code that comply with the given rules as trusted code sections. With continued reference to the non-limiting contextual example, the trusted code identification model identifies event.target as HTMLInputElement).value, event.keyCode===ENTER_KEY) ?event.preventDefault( )”, and event.keyCode as trusted code sections. The remaining code not identified as trusted code is, by default, identified as untrusted code sections.

With continued reference to the To Do list example, embodiments of the present disclosure may further include extracting the identified trusted code sections from the untrusted candidate code corpus in accordance with block 1104. That is, event.target as HTMLInputElement).value, event.keyCode===ENTER_KEY)?event.preventDefault( )”, and event.keyCode are extracted, hoisted, or otherwise split from the untrusted candidate code corpus.

With continued reference to the To Do list example, embodiments of the present disclosure may further include generating one or more trusted computer executable functions based on the one or more trusted code sections and generating one or more untrusted computer executable functions based on one or more untrusted code sections remaining in the untrusted candidate code corpus in accordance with blocks 1106 and 1108, respectively. For example, the extracted trusted code sections may be replaced with a placeholder and a unique ID, as noted by the handler$:

```
refs.newTodo
  .oninput$(handler$<Event, TodoViewState, any>(‘4’))
  .then(({event: value}) => {
    setNewTodo(value)
  })
refs.newTodo
  .onkeydown$(handler$<KeyboardEvent, TodoViewState, any>(‘3’))
  .then(({event: keyCode}) => {
    if (keyCode === ENTER_KEY)
      return;
  let newValue = newTodo( );
  let val = newValue.trim( );
  if (val) {
    todos( ).push({
      id: uuid( ), title: val, isEditing: false,
      editText: ‘’, isCompleted: false
    })
  }
  setNewTodo(‘’);
})
```

In turn, the extracted trusted code sections may be compiled into trusted computer executable code functions for execution in a primary execution environment:

```
export const funcRepository: FunctionsRepository = {
  “3”: ({event}: JayEvent<KeyboardEvent, any>) => {
    (event.keyCode === ENTER_KEY)?event.preventDefault( ):‘’
    return event.keyCode;
  },
  “4”: ({event}: JayEvent<Event, any>) =>
    (event.target as HTMLInputElement).value,
}
```

In some embodiments, a plurality of code structures may be generated from a respective source code structure. That is, the present disclosure contemplates that the compiler, for example, may be configured for the simultaneous generation of multiple code variants. For example, given a source code section, at least one trusted code section and at least one untrusted code section may be identified in accordance with various embodiments described herein. Accordingly, at least one trusted computer executable code function or trusted website code definition element may be generated and at least one untrusted computer executable code function or untrusted website code component may be generated. In the case that a trusted website code definition element and untrusted website code component are generated, a corresponding element bridge and component bridge may also be generated. Additionally or alternatively, a plurality of types of code structures may be generated. For example, for each generated code structure, there may be a respective type generated corresponding to Static Site Generation (SSG), Server-Side Rendering (SSR), Client-Side Rendering (CSR), etc.

In some embodiments, a plurality of code structures may be generated from a respective source code structure for optimization, efficiency, simplicity, and/or the like. For example, in a case where a code structure includes an “if” statement, one code structure may be generated corresponding to a true evaluation of the “if” statement while another code structure may be generated corresponding to a false evaluation of the “if” statement. In some embodiments, a plurality of code structures may be generated from a source code structure based on whether the code structure is static, dynamic, hybrid, and/or based on the processing and/or properties associated with the code structure.

In various embodiments, decision making with respect to generated code structures (e.g., trusted computer executable functions, untrusted computer executable functions, website code definition elements, untrusted website code component, SSG-based code structures, SSR-code based structures, CSR-based code structures, etc.) may be performed by a compiler rather than at runtime. In other words, which code structures will be generated and how they are composed may be determined by a compiler outside of runtime.

Turning to block 1110 of FIG. 11, method 1100 optionally further includes executing the one or more trusted computer executable functions in a primary execution environment and the one or more untrusted computer executable functions in a sandbox execution environment. In a non-limiting example, executing the one or more trusted computer executable functions in a primary execution environment and the one or more untrusted computer executable functions in a sandbox execution environment may result in the rendering of a hybrid website interface.

Although it is a focus of the present disclosure to provide a secure system for running code, it is contemplated by this disclosure that code that fails to run is, at times, acceptable or even desirable. For example, a particular section of code in the untrusted candidate code corpus may not have a detectable or recognized code pattern or otherwise qualify as a trusted code section and as such, fails to satisfy the requirements to be identified as a trusted code section. For example, an attacker may use malicious code in an attempt to exploit the systems running or connected to the malicious code. In other examples, erroneous code may unintentionally pose security and/or stability threats to the systems running or connected to the erroneous code. In either scenario, the malicious/erroneous code will result in a code pattern that is not recognized and, as a result, the particular code will not be identified and/or extracted as trusted code sections and such code will run in a sandbox execution environment, even though such code section may require an API that is not available in the sandbox execution environment. It is not extracted or hoisted from the untrusted candidate code corpus and is instead generated (e.g., compiled) as an untrusted computer executable function. At runtime, such untrusted computer executable function will fail to run in a sandbox execution environment due to the necessary API not being available to it. Such code run in the sandbox execution environment will fail to access sensitive APIs as they are not available in the sandbox execution environment and vulnerable systems will not be exposed to the threat of the malicious/erroneous code. Said differently, this code may be considered to be an attempt to break the sandbox and/or circumvent the security system, and therefore, it is acceptable that this code fails to run in a sandbox execution environment.

Additionally or alternatively, method 1100 optionally further includes generating a structure of functions at block 1112 of FIG. 11. For example, in some embodiments, a first trusted computer executable function of the one or more trusted computer executable functions is communicably coupled to a second untrusted computer executable function via a reciprocal communication pathway, such that, during execution, an output of the first trusted computer executable function serves as an input of the second untrusted computer executable function or an output of the second untrusted computer executable function serves as an input of the first trusted computer executable function. Still further, the second untrusted computer executable function may be communicably coupled to a third trusted computer executable function, such that, during execution, an output of the second untrusted computer executable function serves as an input of the third trusted computer executable function or an output of the third trusted computer executable function serves as an input of the second untrusted computer executable function.

In a non-limiting example, a structure of functions f₁( ), f₂( ), and f₃( ), may be generated from a function f( ) based on the identification of one trusted code section and two untrusted code sections in f( ). For example, an untrusted candidate code corpus may contain one section of identifiable trusted code. After a code splitting operation, the one section of trusted code is extracted which splits the remaining untrusted code into two sections. f₁( ) and f₃( ) are untrusted computer executable functions based on the first and second sections of untrusted code, respectively. f₂( ) is a trusted computer executable function based on the section of trusted code. At runtime, untrusted computer executable functions f₁( ) and f₃( ) are executed in a sandbox execution environment while trusted computer executable function f₂( ) is executed in a primary execution environment. The output of f₁( ) serves as the input to f₂( ) and the output of f₂( ) serves as the input to f₃( ). Accordingly, the runtime execution is formally running as f( )≈f₃(f₂(f₁( ))).

In another non-limiting example, a more complex structure of functions f₁( ), f₂( ), f₃( ), f₄( ) and f₅( ) may be similarly generated based on two trusted code sections and three untrusted code sections. f₁( ), f₃( ) and f₅( ) are untrusted computer executable functions based on the first, second and third sections of untrusted code respectively. f₂( ) and f₄( ) are trusted computer executable functions based on the first and second sections of trusted code respectively. At runtime, untrusted computer executable functions f₁( ), f₃( ) and f₅( ) are executed in a sandbox execution environment while trusted computer executable functions f₂( ) and f₄( ) are executed in a primary execution environment. The output of f₁( ) serves as the input to f₂( ), the output of f₂( ) serves as the input to f₃( ), the output of f₃( ) serves as the input to f₄( ), and the output of f₄( ) serves as the input to f₅( ). Accordingly, the runtime execution is formally running as f( )≈f₅(f₄(f₃(f₂(f₁( ))))).

### Example Secure Code-Based Content Implementation Overview and Embodiments

Example embodiments of the present disclosure may proceed to implement secure code-based content in a supply chain in a number of ways. Accordingly, various processes in accordance with the present disclosure are described herein.

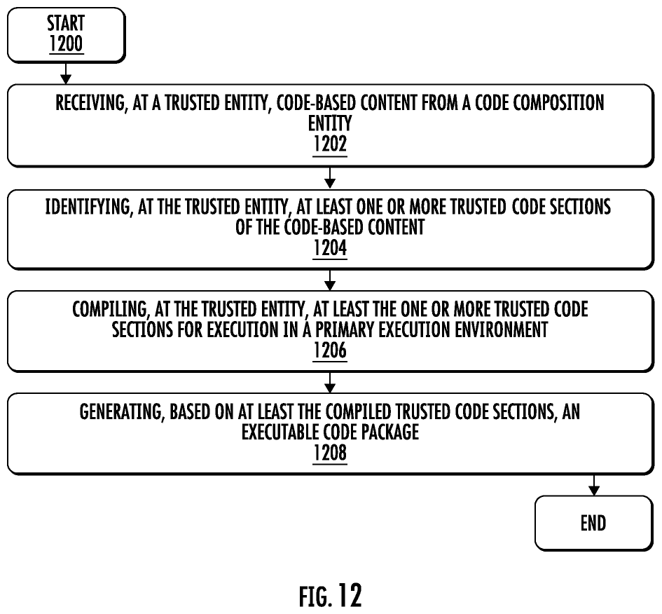

Turning now to FIG. 12, example operations are shown for implementing secure code-based content in a supply chain. In the embodiment illustrated in FIG. 12, the flowchart illustrates method 1200, which includes receiving, at a trusted entity, code-based content from a code composition entity at block 1202. In some embodiments, a code composition entity may generate, produce, sell, and/or the like, code-based content. The code composition entity may send such code-based content to the trusted entity for processing the code-based content. For example, a code-supply chain may include a code composition entity, a trusted entity, and a code consumption entity. In such a code-supply chain, the trusted entity may receive the code-based content from the code composition entity to help facilitate a safe and secure supply chain for the code-based content to be consumed.

In some embodiments, the code composition entity may generate the code-based content using a library or framework that supports code splitting operations in accordance with various embodiments described herein. For example, the code composition entity may optionally perform a code-splitting operation on the code-based content prior to sending the code-based content to the trusted entity in order to perform testing, development, etc. In some embodiments, the code composition entity may optionally generate a candidate secure distribution of the code-based content following such a code splitting operation. In some embodiments, the code composition entity may send the original code-based content (which has not been through such a code splitting operation), the candidate secure distribution of the code-based content, and/or portions thereof (e.g., just the trusted code sections of the code-based content after performing the candidate secure distribution) to the trusted entity.

Turning to block 1204 of FIG. 12, method 1200 further includes identifying, at the trusted entity, at least one or more trusted code sections of the code-based content. For example, depending on what portions and/or format of the code-based content the code composition entity has transmitted to the trusted entity, the trusted entity may or may not be required to perform a code splitting operation in order to identify the trusted code sections. For example, in an instance wherein the code composition entity transmits only the trusted code sections of the code-based content (after performing the candidate secure distribution), the trusted entity may identify the received content as the at least one or more trusted code sections. In another instance, wherein the trusted entity receives the original code-based content (which has not been through such a code splitting operation) and/or the candidate secure distribution of the code-based content, the trusted entity may perform a code splitting operation that includes identifying one or more trusted code sections of the code-based content received from the code composition entity. For example, the trusted entity may apply a trusted code identification model to automatically identify one or more trusted code sections of the code-based content. The trusted code identification model may apply one or more analyses to identify such trusted code sections as described herein with respect to FIG. 11. For example, in some embodiments, the trusted code identification model may apply one or more algorithms, pattern matching, and/or rules to identify the trusted code sections, or the trusted code identification model may be an AI-based model in accordance with various embodiments described herein. That is, the trusted code identification model may use one or more code analysis factors to make suggestions or predictions as to trusted code sections (and/or untrusted code sections). Still further, the trusted entity may revise the result of the code-splitting operation against the candidate secure distribution of the code-based content.

In some embodiments, the trusted entity may optionally verify the code-based content. For example, in some instances, method 1200 optionally includes the trusted entity verifying the code-based content sometime after block 1202. In some embodiments, after receiving code-based content from a code composition entity, the trusted entity may verify (e.g., approve) the code-based content is compliant with one or more agreements, regulations, and/or the like. The trusted entity may perform verification at any point after receiving the code-based content, such as before or after performing any code splitting operations. The trusted entity may block, reject, and/or approve the code-based content pending verifications.

Turning to block 1206 of FIG. 12, method 1200 further includes compiling, at the trusted entity, at least the one or more trusted code sections for execution in a primary execution environment. For example, the trusted entity may generate (e.g., compile) the one or more trusted code sections as one or more trusted computer executable functions for execution in a primary execution environment. That is, at runtime, such trusted computer executable functions are executed in the primary execution environment. In some embodiments, the trusted entity may further optionally compile one or more untrusted code sections for execution in a sandbox execution environment. For example, in an instance wherein the trusted entity, the code consumption entity, and/or a fourth party will be executing the untrusted code sections as part of the executable code package, the trusted entity may generate (e.g., compile) one or more untrusted code sections as one or more untrusted computer executable functions in a sandbox execution environment. At runtime, such untrusted computer executable functions are executed in the sandbox execution environment.

In some embodiments, the trusted entity need not compile untrusted code sections as the code composition entity may execute such untrusted code sections in sandbox execution environment operating on the code composition entity's systems and provide the result of such execution to the code consumption entity. In this way, the code consumption entity can know that the extracted trusted code has not been tampered with as it has been compiled and/or verified by the trusted entity, while the code composition entity need not disclose all of its code to the code consumption entity. In still a further embodiment, the code consumption entity may receive (e.g., consume) the compiled untrusted code sections directly from the code composition entity and safely execute such compiled code as such compiled untrusted code sections are executed in a sandbox execution environment.

Returning to block 1208 of FIG. 12, method 1200 further includes generating, based on at least the compiled trusted code sections, an executable code package. For example, the trusted entity may generate the executable code package (e.g., bundles in the case of browsers and the JavaScript® ecosystem) including the trusted code sections compiled (e.g., trusted computer executable functions) for later execution in a primary execution environment. In some embodiments, the trusted entity may optionally further generate the executable code-package based on one or more compiled untrusted code sections. For example, the trusted entity may generate the executable code package including the trusted code sections compiled (e.g., trusted computer executable functions) for later execution in a primary execution environment and including untrusted code sections compiled (e.g., untrusted computer executable functions) for later execution in a sandbox execution environment. In some embodiments, the trusted entity may optionally further verify (e.g., approve) the executable code package is compliant with one or more agreements, regulations, and/or the like. In some embodiments, the trusted entity may optionally further transmit the executable code package to a code consumption entity.

In some embodiments, the executable code package enables a code consumption entity to consume trusted code sections. For example, the code consumption entity may receive the executable code package including the trusted code sections compiled (e.g., trusted computer executable functions) for execution in a primary execution environment. The code consumption entity may then execute the executable code package. In some embodiments, the code consumption entity may consume the trusted code sections from the trusted entity. For example, the trusted entity may execute the executable code package including the trusted code sections compiled (e.g., trusted computer executable functions) for execution in a primary execution environment and send data indicative of the result of the execution to a code consumption entity.

In some embodiments, the executable code package enables a code consumption entity to consume untrusted code sections. For example, the code consumption entity may receive the executable code package including the untrusted code sections compiled for execution in a sandbox execution environment. The code consumption entity may then execute the executable code package. In some embodiments, the code consumption entity may consume the untrusted code sections from the trusted entity. For example, the trusted entity may execute the executable code package including the untrusted code sections compiled for execution in a sandbox execution environment and send data indicative of the result of the execution to the code consumption entity. In some embodiments, the code consumption entity may consume untrusted code sections from the code composition entity. For example, the code composition entity may execute the candidate secure distribution of the code-based content including the untrusted code sections compiled for execution in a sandbox execution environment and send data indicative of the result of the execution to a code consumption entity.

In a non-limiting contextual example, a code composition entity may use method 1200 or similar in order to selectively expose its code to a code consumption entity. For example, in Server-Side Rendering (SSR), embodiments of the present disclosure may be used to identify certain code as untrusted code (e.g., such as with a $ suffix) such that it remains with code composition entity and can be executed by the code composition entity, thereby enabling a code composition entity to make decisions as to what kind of code will even be shipped to the code consumption entity. For example, in the following code example for a guestbook application, the code with a $ suffix may run on the server-side such that it is eliminated from the client:

```
  import {createState, Props} from ″jay-component″;
  import {DBConnection$} from ′==.′
  export interface GuestbookProps {
      guestbookId: string
      dbConnection$: DBConnection$
  }
  function GuestbookConstructor({guestbookId, dbConnection$}:
Props<GuestbookProps>) {
      let [guestNumber, setGuestNumber] = createState(0)
      let [name, setName] = createState(′′)
      ssrTask$(async ( ) => {
        let dbCount = await dbConnection$.query(′select guest_number
      from guestbooks where id = ?′, [guestbookId( )]);
        if (dbCount)
          setGuestNumber(dbCount);
      })
    const buttonClick = ( ) => {
      setGuestNumber(callServerAPI$(async ( ) => {
        await dbConnection$.exec(‘update guestbooks set guest_number
      = guest_number + 1 where id = ?’, [guestbookId( )])
        return await dbConnection$.query(′select guest_number from
      guestbooks where id = ?′, [guestbookId( )]);
      }))
    }
    return (
      <div>
```

In another non-limiting contextual example, a code composition entity may use method 1200 or similar in order to selectively expose its code to a code consumption entity. For example, in Static Site Generation (SSG), embodiments of the present disclosure may be used to identify certain code as untrusted code (e.g., such as with a $$ suffix) such that it remains with code composition entity and even resolves certain items at build time and thereby improve rate at which a website is rendered. For example, in the following code example for a guestbook application, the code with a $$ suffix may be resolved in the build time (e.g., the title, number of assigns to the guestbook name, etc.) and the code that loads the guestbook number of votes would be resolved on the server-side and not even be shipped to the client:

```
  import {createState, Props} from “jay-component”;
  import {DBConnection$} from ‘==.’
  export interface GuestbookProps {
      guestbookId: string
      dbConnection$: DBConnection$
  }
  function GuestbookConstructor({guestbookId, dbConnection$}:
Props<GuestbookProps>) {
    let [guestNumber, setGuestNumber] = createState(0)
    let [name, setName] = createState(‘’)
    let [guestbookName$$, setGuestbookName$$] = createState(‘’);
    ssgTask$$(async ( ) => {
      setGuestbookName$$(dbConnection$.query(‘select title from
  guestbooks where id = ?’, [guestbookId( )]))
    })
  ...
  return (
      <div>
        <div>Number of guests who signed to the {guestbookName$$}:
    {guestNumber}=/div>
        <div>To sign to the guest book, write your name
          <input type=“text” oninput={({event}) =>
      setName((event.target as HTMLInputElement).value)}=>
          <button onclick={buttonClick}>sign=/button>
          </div>
      </div>
    )
  }
```

FIGS. 1-3C, 10, 11, and 12 illustrate flowcharts and signal diagrams describing the operation of apparatuses, methods, systems, and computer program products according to example embodiments contemplated herein. Each method or process described herein may include any number of operational blocks defining the process and/or a portion thereof. It should be appreciated that in some embodiments the various processes and/or sub-processes described herein may be combined in any manner, such that the embodiment is configured to perform each aspect of the various processes in combination, in parallel and/or serially. In some embodiments, at least one additional and/or at least one alternative operation is performed in one or more of the described processes, and/or at least one operation is removed from one or more of the described processes.

Similarly, while operations are depicted in the drawings in a particular order, this should not be understood as requiring that such operations be performed in the particular order shown or in sequential order, or that all illustrated operations be performed to achieve desirable result(s), unless described otherwise. In certain circumstances, multitasking and parallel processing may be advantageous. Similarly, in some cases, the actions recited in the claims can be performed in a different order and still achieve desirable results.

Additionally, optional operations may be depicted in one or more processes or flow diagrams illustrated herein utilizing dashed (or “broken”) lines. In this regard, it should be appreciated that the processes described herein are examples only and the scope of the disclosure is not limited to the exact operations depicted and described, and the depicted and described operations should not limit the scope and spirit of the embodiments described herein and covered in the appended claims.

In some embodiments, one or more of the devices, apparatuses, modules, and/or systems disclosed herein is configured to perform any number and/or combination of the processes described herein, whether alone or in combination. Each of the described processes may be altered or implemented in any of a myriad of ways without departing from the spirit of the present disclosure. In some embodiments, the processes are embodied in computer-implemented methods executable by any of a myriad of computing device implementations, or combinations thereof, described herein, including by a client device 508, a hybrid website interface rendering system 510, a hybrid website interface rendering server 512, and/or the like as described herein.

Moreover, it will be understood that each flowchart block, and combinations of flowchart blocks, may be implemented by various means, such as hardware, firmware, processor, module, circuitry, and/or other devices associated with execution of software including one or more computer program instructions. As will be appreciated, any disclosed computer program instructions may be loaded onto a computer or other programmable apparatus (e.g., hardware) to produce a machine, such that the resulting computer or other programmable apparatus implements the functions specified in the flowchart blocks. For example, one or more of the operations described above may be implemented by an apparatus executing computer program instructions. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks. In this regard, for example, the computer program instructions may be stored by a memory 802 of the server (e.g., hybrid website interface rendering server 512) and executed by a processor 804 of the server (e.g., hybrid website interface rendering server 512).

The flowchart blocks support combinations of means for performing the specified functions and combinations of operations for performing the specified functions. It will be understood that one or more blocks of the flowcharts, and combinations of blocks in the flowcharts, can be implemented by special-purpose hardware-based computer systems which perform the specified functions, or combinations of special-purpose hardware with computer instructions.

### Exemplary System Architecture

Methods, apparatuses, systems, and computer program products of the present disclosure may be embodied by any of a variety of computing devices. For example, the method, apparatus, system, and computer program product of an example embodiment may be embodied by a networked device (e.g., an enterprise platform), such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

FIG. 5 illustrates a block diagram of an example computing system that may be specially configured within which embodiments of the present disclosure may operate. In this regard, FIG. 5 illustrates an overview of a computing system 500 which may include one or more devices and sub-systems that are configured for performing some or all of the various operations and processes described herein. In some examples, such a system 500 implements rendering of a hybrid website interface via a hybrid website interface rendering system 510 in accordance with some embodiments described herein. Said differently, the various depicted devices of the computing system 500 communicate to, in some embodiments, enable the rendering of a hybrid website interface. In other examples, such a system 500 implements trusted code splitting in accordance with some embodiments described herein. Said differently, the various depicted devices of the computing system 500 communicate to, in some embodiments, enable trusted code splitting.

The computing system 500 is illustrated with a hybrid website interface rendering system 510 communicably connected via a network 502 to one or more client devices 508A-508B (referred to as “client devices 508”; the depictions in FIG. 5 of “B” client devices are merely for illustration purposes). Said differently, users may access the hybrid website interface rendering system 510 over at least one communications network 502 using one or more of client devices 508A-B. In some embodiments, each of the client devices 508A-B is embodied by one or more user-facing computing devices embodied in hardware, software, firmware, and/or a combination thereof, configured for performing some or all of the hybrid website interface rendering functionality described herein. That is, the client devices 508A-B may include circuitry, modules, networked processors, a suitable network server, and/or other type of processing device (e.g., a controller or computing device of the client device 508). For example, in some embodiments, a client device 508 is embodied by a personal computer, a desktop computer, a laptop computer, a computing terminal, a smartphone, a netbook, a tablet computer, a personal digital assistant, a wearable device, a smart home device, and/or other networked device that may be used for any suitable purpose in addition to performing some or all of the hybrid website interface rendering functionality described herein. In some example contexts, the client device 508A-B is configured to execute one or more computing programs to perform the various functionality described herein. For example, the client device 508A-B may execute a web-based application or applet (e.g., accessible via a website), a software application installed to the client device 508A-B (e.g., an “app”), or other computer-coded instructions accessible to the client device 508.

In some embodiments, the client devices 508A-B may include various hardware, software, firmware, and/or the like for interfacing with the hybrid website interface rendering system 510. Said differently, a client device 508A-B may be configured to access the hybrid website interface rendering system 510 and/or to render information provided by the hybrid website interface rendering system 510 (e.g., via a software application executed on the client device 508). According to some embodiments, the client device 508A-B comprises a display for rendering various interfaces, including one or more hybrid website interface(s). For example, in some embodiments, the client device 508A-B is configured to display such interface(s) on the display of the client device 508A-B for viewing, editing, and/or otherwise interacting with at least a selected document, which may be provided by the hybrid website interface rendering system 510.

Returning to FIG. 5, in some embodiments, the hybrid website interface rendering system 510 includes one or more servers, such as the hybrid website interface rendering server 512. For example, hybrid website interface rendering system 510 may implement some of its functionality on a server or a server set (e.g., hybrid website interface rendering server 512), and some of its functionality on client elements (e.g., client devices 508A-B). In some embodiments, the hybrid website interface rendering system 510 dynamically determines whether to perform some functionality on the server or the client platform. In some embodiments, the hybrid website interface rendering system 510 comprises other servers and components, as described below with respect to the exemplary depicted embodiment of a website building system 610 in FIG. 6.

Hybrid website interface rendering server 512 may be any suitable network server and/or other type of processing device. In this regard, the hybrid website interface rendering server 512 may be embodied by any of a variety of devices, for example, the hybrid website interface rendering server 512 may be embodied as a computer or a plurality of computers. For example, hybrid website interface rendering server 512 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least a portion of the components illustrated with respect to server apparatus 800 in FIG. 8 and described in connection therewith. The hybrid website interface rendering server 512 may, in some embodiments, comprise several servers or computing devices performing interconnected and/or distributed functions. Despite the many arrangements contemplated herein, hybrid website interface rendering server 512 is shown and described herein as a single computing device to avoid unnecessarily overcomplicating the disclosure.

In some embodiments, the hybrid website interface rendering server 512 is configured, via one or more software modules, hardware modules, or a combination thereof, to access communications network 502 for communicating with one or more of the client devices 508. Additionally, or alternatively, the hybrid website interface rendering server 512 is configured, via software, hardware, or a combination thereof, to is configured to execute any of a myriad of processes associated with implementing hybrid website interface rendering. Said differently, hybrid website interface rendering server 512 may include circuitry, modules, networked processors, or the like, configured to perform some or all of the hybrid website interface rendering functionality, as described herein. In this regard, for example, in some embodiments, the hybrid website interface rendering server 512 receives and processes data (e.g., such as data communicated between trusted website code definition elements, untrusted website code components, proxy transformation components, untrusted candidate code corpus, trusted code identification model, etc.)

In some embodiments, the hybrid website interface rendering system 510 includes at least one repository, such as hybrid website interface rendering repository 514. Such repository(ies) may be hosted by the hybrid website interface rendering server 512 or otherwise hosted by devices in communication with the hybrid website interface rendering server 512. As depicted, in some embodiments, the hybrid website interface rendering server 512 is communicable with the hybrid website interface rendering repository 514. In some embodiments, the hybrid website interface rendering server 512 may be located remotely from the hybrid website interface rendering repository 514. In this regard, in some embodiments, the hybrid website interface rendering server 512 is directly coupled to the hybrid website interface rendering repository 514 within the hybrid website interface rendering system 510.

Additionally, or alternatively, in some embodiments, the hybrid website interface rendering server 512 is wirelessly coupled to the hybrid website interface rendering repository 514. In yet other embodiments, the hybrid website interface rendering repository 514 is embodied as a sub-system(s) of the hybrid website interface rendering server 512. That is, hybrid website interface rendering server 512 may comprise the hybrid website interface rendering repository 514. Additionally, or alternatively, in some embodiments, the hybrid website interface rendering repository 514 is embodied as a virtual repository executing on the hybrid website interface rendering server 512.

The hybrid website interface rendering repository 514 may be embodied by hardware, software, or a combination thereof, for storing, generating, and/or retrieving data and information utilized by the hybrid website interface rendering system 510 for performing the operations described herein. For example, hybrid website interface rendering repository 514 may be stored by any suitable storage device configured to store some or all of the information described herein (e.g., memory 802 of the hybrid website interface rendering server 512 or a separate memory system separate from the hybrid website interface rendering server 512, such as one or more database systems, backend data servers, network databases, cloud storage devices, or the like provided by another device (e.g., online application or 3rd party provider), such as a Network Attached Storage (NAS) device or devices, or as a separate database server or servers (e.g., such as in a cloud computing environment and thereby completed by multiple servers). Hybrid website interface rendering repository 514 may comprise data received from the hybrid website interface rendering server 512 (e.g., via a memory 802 and/or processor(s) 804), a third-party and/or a client device 508, and the corresponding storage device may thus store this data. The hybrid website interface rendering repository 514 may store various data in any of a myriad of manners, formats, tables, computing devices, and/or the like. For example, in some embodiments, the hybrid website interface rendering repository 514 includes one or more sub-repositories that are configured to store specific data processed by the hybrid website interface rendering system 510. Hybrid website interface rendering repository 514 includes information accessed and stored by the hybrid website interface rendering server 512 to facilitate the operations of the hybrid website interface rendering system 510.

Hybrid website interface rendering system 510 (e.g., hybrid website interface rendering server 512) can communicate with one or more client devices 508A-B via communications network 502. Communications network 502 may include any one or more wired and/or wireless communication networks including, for example, a wired or wireless local area network (LAN), personal area network (PAN), metropolitan area network (MAN), wide area network (WAN), or the like, or combinations thereof, as well as any hardware, software and/or firmware required for implementing the one or more networks (e.g., network routers, switches, hubs, etc.). For example, communications network 502 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network.

Furthermore, the communications network 502 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the hybrid website interface rendering system 510, such as JavaScript Object Notation (JSON) objects sent via a WebSocket channel. In some embodiments, the protocol is JSON over RPC, JSON over REST/HTTP, the like, or combinations thereof.

In some embodiments, the hybrid website interface rendering system 510 is a standalone system. In other embodiments, the hybrid website interface rendering system 510 is embedded inside of a larger editing system. In certain embodiments, the hybrid website interface rendering system 510 is associated with a visual design system and further still, in some embodiments, the visual design system is one or more of a document building system, a website building system, or an application building system. It is also contemplated by the present disclosure that the hybrid website interface rendering system 510 may be used to define, create, and/or render compositions or documents of various sizes and scopes, such as a page section, single web page, a plurality of web pages, a complete website, third-party applications, complex or composite page components, etc. Additionally, or alternatively, it is further contemplated by the present disclosure that the hybrid website interface rendering system 510 may be used in non-web environments or embodiments, such as applications providing execution or automation environments (e.g., Excel® supporting Excel® macros), IoT, build pipelines, and/or the like.

An example embodiment of a hybrid website interface rendering system (e.g., a hybrid website interface rendering system 510 as depicted in FIG. 5) is depicted in FIG. 6. In particular, FIG. 6 depicts a computing system 600 including a website building system (“WBS”) 610 as an example hybrid website interface rendering system for the creation and/or update of, for example, hierarchical websites and/or trusted code splitting.

A WBS 610 may be online (i.e., applications are edited and stored on a server or server set), offline, or partially online (with websites being edited locally but uploaded to a central server for publishing). A WBS 610 may be accessed by a variety of users via a network 602, including designers, subscribers, subscribing users or site editors, and code editors, which are the users designing the websites, as well as end users which are the “users of users” accessing the created web sites. Although end users may typically access the WBS 610 in a read-only mode, a WBS (and web sites) may allow end users to perform changes to a website, such as adding or editing data records, adding talkbacks to news articles, adding blog entries to blogs, and/or the like.

In some embodiments, a WBS 610 may allow multiple levels of users and different permissions and capabilities may be associated with and/or assigned to each level. For example, users may register with the WBS 610 (e.g., via the WBS server which manages the users, web sites, and access parameters of the end users).

With reference to FIG. 6, in addition to a hybrid website interface rendering service 612 and a hybrid website interface rendering repository 614, a WBS 610 may comprise a WBS site manager 605, an object marketplace 615, a RT (runtime) server 620, a WBS editor 630, a site generation system 640 and a WBS content management system 700. WBS 610 is depicted in communication with embodiments of the client devices 508A-B which are depicted as being operated by WBS vendor staff 608A, WBS site designer 608B (i.e., a user), a site viewer 608N (i.e., a user of a user), as well as external systems 670. For example, WBS vendor staff 608A may be an employee of the pertinent website building system vendor and may create and maintain various WBS elements such as templates, content/layout elements, and/or the like. In some embodiments, a site designer 608B may use WBS 610 to build his site for use by site viewers 608N.

Additionally, or alternatively, a site designer 608B may be an external site designer or consultant, though the website building system vendor may employ site designers 608B, for example, for the creation of template sites for inclusion in the WBS 610. In some embodiments, site viewers 608N may only view the system. Additionally, or alternatively, in some embodiments, site viewers 608N may be allowed some form of site input or editing (e.g., talkback sending or blog article posting). In still further embodiments, WBS 610 comprises a limited site generation system 640 configured to allow a viewer 608N to build (e.g., a user page) within a social networking site. It is contemplated by this disclosure that a site viewer 608N may also include a site designer 608B.

In some embodiments, WBS site manager 605 is used by site designer 608B to manage his created sites (e.g., to handle payment for the site hosting or set permissions for site access). In some embodiments, WBS RT (runtime) server 620 handles run-time access by one or more (e.g., possibly numerous) site viewers 63. In some embodiments, such access is read-only, but in certain embodiments, such access involves interactions that may affect back-end data or front-end display (e.g., purchasing a product or posting a comment in a blog). In some embodiments, WBS RT server 620 serves pages to site designers 608B (e.g., when previewing the site, or as a front-end to WBS editor 630).

In some embodiments, object marketplace 615 allows trading of objects (e.g., as add-on application, templates, and element types) between object vendors and site designers 608B through WBS 610. In some embodiments, WBS editor 630 allows site designer 608B to edit site pages (e.g., manually or automatically generated), such as editing of content, logic, layout, attributes, and/or the like. For example, in some embodiments, WBS editor 630 allows site designer 608B to adapt a particular template and its elements according to his business or industry.

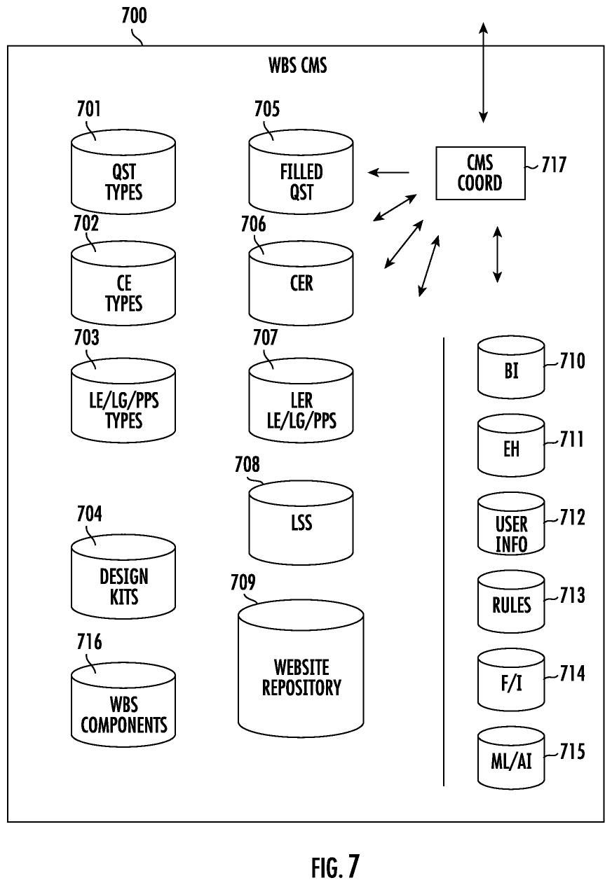

In some embodiments, site generation system 640 creates the actual site based on the integration and analysis of information entered by site designer 608B (e.g., via questionnaires), pre-specified and stored in CMS (content management system) 700 together with information from external systems 670 and internal information held within CMS 700 that may be gleaned from use of the WBS 610 by other designers. Additionally, or alternatively, CMS 700 is held in centralized storage or locally by site designer 608B. Example repositories of a CMS 700 are described below with respect to FIG. 7.

With reference to FIG. 7, an example CMS 700 is illustrated. The WBS 610 may utilize CMS 700, comprising a series of repositories, stored over one or more servers or server farms, to support creation of various web sites. For example, CMS 700 may include one or more of user information/profile repository 712, WBS component repository 716, WBS site repository 709, business intelligence (BI) repository 710, and editing history repository 711. Additionally, or alternatively, CMS 700 may include one or more of questionnaire type repository 701, content element type repository 702, LE (layout element) type repository 703, design kit repository 704, filled questionnaires repository 705, CER (content element repository) 706, LER (layout element repository) 707, layout selection store 708, rules repository 713, family/industry repository 714, and ML/AI (machine learning/artificial intelligence) repository 715. A CMS 700 may also include a CMS coordinator 717 to coordinate and control access to such one or more repositories.

It is contemplated by this disclosure that the WBS 610 can be used to create and/or update hierarchical websites based on visual editing or automatic generation based on collected business knowledge, wherein collected business knowledge refers to the collection of relevant content to the web site being created which may be gleaned from, for example, external systems 670 or other sources. Further details regarding collected business knowledge are described in commonly-owned U.S. Pat. No. 10,073,923 which was filed May 29, 2017 as U.S. patent application Ser. No. 15/607,586, and is entitled “SYSTEM AND METHOD FOR THE CREATION AND UPDATE OF HIERARCHICAL WEBSITES BASED ON COLLECTED BUSINESS KNOWLEDGE,” which application is incorporated by reference herein in its entirety.

In some embodiments, WBS 610 uses internal data architecture to store WBS-based sites. For example, this architecture may organize the handled sites' internal data and elements inside the WBS 610. This architecture may be different from the external view of the site (as seen, for example, by the end-users) and may also be different from the way the corresponding HTML pages sent to the browser are organized. In some embodiments, the internal data architecture contains additional properties for each element in the page (e.g., creator, creation time, access permissions, link to templates, SEO related information, and/or the like) which are relevant for the editing and maintenance of the site in the WBS 610, but are not externally visible to end-users (or even to some editing users). The internal version of the sites may be stored in a site repository as further detailed below.

In some embodiments, a WBS 610 is used with applications. A visual application is a website including pages, containers, and components. Each page is separately displayed and includes one or more components. In some embodiments, components include containers as well as atomic components. In some embodiments, the WBS 610 supports hierarchical arrangements of components using atomic components (e.g., text, image, shape, video, and/or the like) as well as various types of container components which contain other components (e.g., regular containers, single-page containers, multi-page containers, gallery containers, and/or the like). The sub-pages contained inside a container component are referred to as mini-pages, each of which may contain multiple components. Some container components may display just one of the mini-pages at a time, while others may display multiple mini-pages simultaneously.

In some examples, pages may use templates—general page templates or component templates. In an exemplary embodiment, an application master page containing components replicated in all other regular pages is a template. In another exemplary embodiment, an application header/footer, which repeats on all pages, is a template. In some embodiments, templates may be used for the complete page or page sections. A WBS 610 may provide inheritance between templates, pages, or components, possibly including multi-level inheritance, multiple inheritance and diamond inheritance (i.e., A inherits from B and C, and both B and C inherit from D). In some embodiments, a WBS 610 supports site templates.

In some embodiments, the visual arrangement of components inside a page is a layout. In some embodiments, a WBS 610 supports dynamic layout processing whereby the editing of a given component (or other changes affecting it such as externally-driven content change) may affect other components. Further details regarding dynamic layout processing are described in commonly-owned U.S. Pat. No. 10,185,703, which was filed Feb. 20, 2013 as U.S. patent application Ser. No. 13/771,119, and is entitled “WEB SITE DESIGN SYSTEM INTEGRATING DYNAMIC LAYOUT AND DYNAMIC CONTENT,” which patent is incorporated by reference herein in its entirety.

In some embodiments, a WBS 610 is extended using add-on applications, such as third-party applications and components, list applications, and WBS configurable applications. In certain embodiments, such add-on applications may be added and integrated into designed web sites. Such add-on applications may be purchased (or otherwise acquired) through a number of distribution mechanisms, such as being pre-included in the WBS design environment, from an application store (e.g., integrated into the WBS object marketplace 615 or external) or directly from the third-party vendor. Such third-party applications may be hosted on the servers of the WBS vendor, the servers of the third-party application's vendor, and/or a 4th party server infrastructure.

In some embodiments, a WBS 610 allows procedural code to be added to some or all of the entities (e.g., applications, pages, elements, components, and the like). Such code could be written in a standard language (such as JS), an extended version of a standard language or a language proprietary to the specific WBS 610. The executed code may reference APIs provided by the WBS 610 itself or external providers. The code may also reference internal constructs and objects of the WBS 610, such as pages, components and their attributes.

In some embodiments, the procedural code elements may be activated via event triggers which may be associated with user activities (e.g., mouse move or click, page transition and/or the like), activities associated with other users (e.g., an underlying database or a specific database record being updated by another user and/or the like), system events or other types of conditions. The activated code may be executed inside the WBS's client element (e.g., client devices 508), the server platform, a combination of the two or a dynamically determined execution platform. Further details regarding activation of customized back-end functionality are described in commonly-owned U.S. Pat. No. 10,209,966, which was filed on Jul. 24, 2018, as U.S. patent application Ser. No. 16/044,461, and is entitled “CUSTOM BACK-END FUNCTIONALITY IN AN ONLINE WEBSITE BUILDING ENVIRONMENT,” which patent is incorporated by reference herein in its entirety.

FIG. 8 illustrates a block diagram of an example apparatus that may be specially configured in accordance with an example embodiment of the present disclosure. In some embodiments, hybrid website interface rendering system 510 and/or hybrid website interface rendering server 512 is embodied by one or more computing systems, such as the server apparatus 800 as depicted and described in FIG. 8.

FIG. 8 shows a schematic block diagram of example modules or circuitry, some or all of which may be included in server apparatus 800. As illustrated in FIG. 8, in accordance with some example embodiments, the server apparatus 800 may include various means, such as memory 802, processor 804, input/output module 806, communications module 808, hybrid website interface rendering module 810, and/or code splitting module 812. The server apparatus 800 may be configured, using one or more of the modules 802-812, to execute the operations regarding implementing hybrid website interface rendering and/or trusted code splitting as described herein. Said differently, systems, methods, apparatuses, and/or computer program products as described herein are configured to transform or otherwise manipulate a general-purpose computer(s) so that it functions as a special purpose computer to provide hybrid website interface rendering and/or trusted code splitting as described herein.

Although the use of the terms “module” and “circuitry” as used herein with respect to components 802-812 are described in some cases using functional language, it should be understood that the particular implementations necessarily include the use of particular hardware configured to perform the functions associated with the respective module or circuitry as described herein. It should also be understood that certain of these components 802-812 may include similar or common hardware. For example, two or more modules may both leverage use of the same processor, network interface, storage medium, or the like to perform their associated functions, such that duplicate hardware is not required for each module. It will be understood in this regard that some of the components or modules described in connection with the hybrid website interface rendering server 512, for example, may be housed within this device, while other components or modules are housed within another of these devices, or by yet another device not expressly illustrated in FIG. 5. Said differently, in some embodiments, one or more external systems (such as a remote cloud computing and/or data storage system) may also be leveraged to provide at least some of the functionality discussed herein.

While the terms “module” and “circuitry” should be understood broadly to include hardware, in some embodiments, the terms “module” and “circuitry” also include software for configuring the hardware. That is, in some embodiments, each of the modules 802-812 may be embodied by hardware, software, or a combination thereof, for performing the operations described herein. In some embodiments, some of the modules 802-812 may be embodied entirely in hardware or entirely in software, while other modules are embodied by a combination of hardware and software. For example, in some embodiments, the terms “module” and “circuitry” may include processing circuitry, storage media, network interfaces, input/output devices, and the like.

Additionally, or alternatively, in some embodiments, one or more of the modules 802-812 may be combined, such that a single module includes means configured to perform the operations of two or more of the modules 802-812. Said differently, other elements of the server apparatus 800 may provide or supplement the functionality of a particular module or circuitry. For example, the processor 804 may provide processing functionality, the memory 802 may provide storage functionality, the communications module 808 may provide network interface functionality, and the like, to another module or circuitry. Additionally, or alternatively, one or more of the modules 802-812 may be embodied by two or more submodules.

In some embodiments, the processor 804 (and/or co-processor or any other processing circuitry assisting or otherwise associated with the processor) may be in communication with the memory 802 via a bus for passing information among components of, for example, hybrid website interface rendering server 512. The memory 802 is non-transitory and may include one or more volatile and/or non-volatile memories, or some combination thereof. In other words, the memory 802 may be an electronic storage device (e.g., a non-transitory computer readable storage medium). The memory 802 may be configured to store information, data, content, applications, instructions, or the like, for enabling server apparatus 800 (e.g., hybrid website interface rendering server 512) to carry out various functions in accordance with example embodiments of the present disclosure.

Although illustrated in FIG. 8 as a single memory, memory 802 may comprise a plurality of memory components. The plurality of memory components may be embodied on a single computing device or distributed across a plurality of computing devices. In various embodiments, memory 802 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 802 may be configured to store information, data, applications, instructions, or the like for enabling server apparatus 800 to carry out various functions in accordance with example embodiments discussed herein. For example, in at least some embodiments, memory 802 is configured to buffer data for processing by processor 804. Additionally, or alternatively, in at least some embodiments, memory 802 is configured to store program instructions for execution by processor 804. Memory 802 may store information in the form of static and/or dynamic information. This stored information may be stored and/or used by the server apparatus 800 (e.g., hybrid website interface rendering server 512) during the course of performing its functionalities.

Processor 804 may be embodied in a number of different ways and may, for example, include one or more processing devices configured to perform independently. Additionally, or alternatively, processor 804 may include one or more processors configured in tandem via a bus to enable independent execution of instructions, pipelining, and/or multithreading. Processor 804 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 8 as a single processor, in some embodiments, processor 804 comprises a plurality of processors. The plurality of processors may be embodied on a single computing device or may be distributed across a plurality of such devices collectively configured to function as hybrid website interface rendering server 512. The plurality of processors may be in operative communication with each other and may be collectively configured to perform one or more functionalities of hybrid website interface rendering server 512 as described herein.

In an example embodiment, processor 804 is configured to execute instructions stored in the memory 802 or otherwise accessible to processor 804. Alternatively, or additionally, the processor 804 may be configured to execute hard-coded functionality. As such, whether configured by hardware or software methods, or by a combination thereof, the processor 804 may represent an entity (e.g., physically embodied in circuitry) capable of performing operations according to an embodiment of the present disclosure while configured accordingly. Alternatively, as another example, when the processor 804 is embodied as an executor of software instructions, the instructions may specifically configure processor 804 to perform one or more algorithms and/or operations described herein when the instructions are executed. For example, these instructions, when executed by processor 804, may cause the server apparatus 800 (e.g., hybrid website interface rendering server 512) to perform one or more of the functionalities of system 500 as described herein.

In some embodiments, the server apparatus 800 further includes input/output module 806 that may, in turn, be in communication with processor 804 to provide an audible, visual, mechanical, or other output and/or, in some embodiments, to receive an indication of an input from a user, a client device 508, or another source. In that sense, input/output module 806 may include means for performing analog-to-digital and/or digital-to-analog data conversions. Input/output module 806 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output module 806 may comprise a user interface and may comprise a web user interface, a mobile application, a client device, a kiosk, or the like. The processor 804 and/or user interface circuitry comprising the processor 804 may be configured to control one or more functions of a display or one or more user interface elements through computer program instructions (e.g., software and/or firmware) stored on a memory accessible to the processor 804 (e.g., memory 802, and/or the like). In some embodiments, aspects of input/output module 806 may be reduced as compared to embodiments where server apparatus 800 may be implemented as an end-user machine or other type of device designed for complex user interactions. In some embodiments (like other components discussed herein), input/output module 806 may even be eliminated from server apparatus 800. Input/output module 806 may be in communication with memory 802, communications module 808, and/or any other component(s), such as via a bus. Although more than one input/output module 806 and/or other component can be included in server apparatus 800, only one is shown in FIG. 8 to avoid overcomplicating the disclosure (e.g., like the other components discussed herein).

Communications module 808, in some embodiments, includes any means, such as a device or circuitry embodied in either hardware, software, firmware or a combination of hardware, software, and/or firmware, that is configured to receive and/or transmit data from/to a network and/or any other device, circuitry, or module in communication with server apparatus 800. In this regard, communications module 808 may include, for example, a network interface for enabling communications with a wired or wireless communication network. In some embodiments, communications module 808 is configured to receive and/or transmit any data that may be stored by memory 802 using any protocol that may be used for communications between computing devices. For example, communications module 808 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, communications module 808 includes circuitry for interacting with the antenna(s) to cause transmission of signals via the antenna or to handle receipt of signals received via the antenna(e). These signals may be transmitted by hybrid website interface rendering server 512 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications module 808 may additionally, or alternatively be in communication with the memory 802, input/output module 806 and/or any other component of server apparatus 800, such as via a bus.

In some embodiments, hybrid website interface rendering module 810 is included in the server apparatus 800 and configured to perform the functionality discussed herein related to, inter alia, enabling rendering of a hybrid website interface. In some embodiments, hybrid website interface rendering module 810 includes hardware, software, firmware, and/or a combination of such components, configured to support various aspects of such hybrid website interface rendering-related functionality, features, and/or services of the hybrid website interface rendering module 810 as described herein (e.g., providing a primary execution environment, providing one or more sandbox execution environments, providing one or more proxy transformation components, causing rendering of the hybrid website interface, and/or the like).

In some embodiments, hybrid website interface rendering module 810 provides a compiling functionality (e.g., a Jcompiler 400) as set forth in data flow diagram illustrated in FIG. 4A. In some embodiments, the Jcompiler 400 is configured to extract declarative programming language expressions from the presentation code subcomponent of untrusted website code component(s), compile the extracted declarative programming language expressions to form secure code component(s) or secure functions executing in the primary execution environment, and/or form proxy transformation component(s) (e.g., from the presentation code subcomponent of an untrusted website code component).

In various embodiments, a Jcompiler 400 reads the definitions of the trusted website code definition elements (JEs) and untrusted website code components (JCs), such as reading and/or running a JSX file [1], reading an HTML/CSS file [2], and/or reading another definition format. The Jcompiler 400 then creates a semantic representation of the untrusted website code definition element definition (Jay JE definition [4]), which is the first input for safe code generation. In some embodiments, the Jcompiler 400 extracts the declarative programming language (JLang) expressions from the untrusted website code component (JC [5]) and replaces such declarative programming language (JLang) expressions with one or more identifier(s). The extracted declarative programming language (JLang) expressions form the second input for safe code generation. In still further embodiments, the Jcompiler 400 compiles the trusted website code definition element (JE)- and untrusted website code component (JC)-extracted declarative programming language (JLang) expressions to secure code that can run anywhere (e.g., in insecure threads, secure threads, or other isolation contexts [6]). The trusted website code definition element (JE) transforms into a JS function that, given the data defined, renders the HTML specified and, in an instance, providing an update of the data, updates the HTML as per the definitions. The input for the JS rendering function is denoted as the “ViewState”, which the untrusted website code component (JC) calculates. The declarative programming language (JLang) expressions are transformed into event handlers and other functions with native DOM access.

With continued reference to the embodiment of FIG. 4A, the Jcompiler 400 creates or forms proxy transformation components (e.g., JE bridges, JE stubs, JC bridges, and JC stubs) for the trusted website code definition element (JE [7]) and untrusted website code component (JC [8]), the proxy transformation components used as proxies for each in different contexts. Additionally, or alternatively, the Jcompiler 400 bundles the generated trusted website code definition element (JE) and untrusted website code component (JC) code into two bundles (i) secure bundle [7] including the safe-generated trusted website code definition element (JE) code and the proxy transformation component (JC bridge) for the untrusted website code component (JC) code to be run in the primary execution environment [9]; and (ii) unsecure bundle [8] to run in a sandbox execution environment [10], including the untrusted website code component (JC) code and the proxy transformation component (JE bridge) for the trusted website code definition element (JE).

With continued reference to the embodiment of FIG. 4A, the Jcompiler 400 generates one or more files needed (and decides the communication protocol(s)) for development environments to recognize the signature of the functions that the trusted website code definition element (JE) is compiled into (e.g., .d.ts files, which are type definition files that allow for the use of existing JS code in Typescript, for typescript support [11]). For example, with such signature files, the development experience of coding the untrusted website code component, JC [3], code is given standard support. The generation of the signature files (e.g., such as d.ts files) can be decoupled from generating the secure bundle [7] and unsecure bundle [8].

Additionally, or alternatively, in some embodiments, the trusted website code definition element enables the creation of a transformation pipeline managed by the Jcompiler, as depicted in FIG. 4B, allowing one to change the trusted website code definition element before generating the code of the trusted website code definition element. In some embodiments, such a transformation may insert values into the trusted website code definition element from a database, translate texts in the trusted website code definition element using a translation system, and/or transform common design patterns (e.g., transform a stack of boxes into a “forEach” dynamic structure). As depicted in FIG. 4B, incorporating the transformation pipeline into the Jcompiler adds a step after reading the untrusted website code definition element (JE) definitions [4] and before generating the safe code [6] and the d.ts files [11]. Step [12], which runs during the compilation process, can run unsafe code and execute any type of logic which transforms the JE definition.

It should be appreciated that, in some embodiments, hybrid website interface rendering module 810 performs one or more of such exemplary actions in combination with another module of the server apparatus 800, such as one or more of memory 802, processor 804, input/output module 806, and communications module 808. For example, in some embodiments, hybrid website interface rendering module 810 utilizes processing circuitry, such as the processor 804 and/or the like, to perform one or more of its corresponding operations. In a further example, some or all of the functionality of hybrid website interface rendering module 810 may be performed by processor 804 in some embodiments. In this regard, some or all of the example hybrid website interface rendering processes and algorithms discussed herein can be performed by at least one processor 804 and/or hybrid website interface rendering module 810. It should also be appreciated that, in some embodiments, hybrid website interface rendering module 810 may include a separate processor, specially configured field programmable gate array (FPGA), or application specific integrated circuit (ASIC) to perform its corresponding functions.

Additionally, or alternatively, in some embodiments, hybrid website interface rendering module 810 utilizes memory 802 to store collected information. For example, in some implementations, hybrid website interface rendering module 810 includes hardware, software, firmware, and/or a combination thereof, that interacts with hybrid website interface rendering repository 514 (as illustrated in FIG. 5) and/or memory 802 to send, retrieve, update, and/or store data values embodied by, associated with, configured for association with, and/or otherwise support the operations of the hybrid website interface rendering module 810 and the remaining circuitry. Additionally, or alternatively, in some embodiments, hybrid website interface rendering module 810 utilizes input/output module 806 to facilitate user output and/or to receive user input (e.g., user clicks, user taps, keyboard interactions, user gesture, and/or the like). Additionally, or alternatively still, in some embodiments, the hybrid website interface rendering module 810 utilizes communications module 808 to initiate transmissions to another computing device, receive transmissions from another computing device, communicate signals between the various modules as depicted, and/or the like.

In some embodiments, code splitting module 812 is included in the server apparatus 800 and configured to perform the functionality discussed herein related to, inter alia, trusted code splitting. In some embodiments, code splitting module 812 includes hardware, software, firmware, and/or a combination of such components, configured to support various aspects of such code splitting-related functionality, features, and/or services of the code splitting module 812 as described herein (e.g., applying a trusted code identification model, identifying trusted code sections, identifying untrusted code sections, extracting trusted code sections, generating reciprocal communication pathways, etc.). Although code splitting module 812 can be included in server apparatus 800 as shown in FIG. 8, it is contemplated by the present disclosure that code splitting module 812 may be included in the server apparatus 800, in one or more separate server apparatuses 800, and/or collections of servers (e.g., a cloud networking environment, microservices, and/or the like).

FIG. 9 illustrates a block diagram of an example client apparatus that may be specially configured in accordance with an example embodiment of the present disclosure. In some embodiments, the client device 508A-B is embodied by one or more computing systems, such as the client apparatus 900 as depicted and described in FIG. 9. The client apparatus 900 includes a memory 902, processor 904, input/output module 906, communications module 908, hybrid website interface rendering module 910, and/or code splitting module 912. That is, in some embodiments, hybrid website interface rendering module 910 and/or code splitting module 912 is optionally included in the client apparatus 900 (e.g., client device 508) and configured to perform some or all of the functionality discussed herein related to, inter alia, hybrid website interface rendering module 910 and/or code splitting module 912. The client apparatus 900 may be configured using one or more of the sets of circuitries to execute the operations described herein. The modules 902-912 may function similarly or identically to the similarly named modules depicted and described with respect to the server apparatus 800. For purposes of brevity and length of disclosure, repeated disclosure with regard to the functionality of such similarly named sets of circuitry is omitted herein.

### Definitions

The term “hybrid website interface rendering system” refers to a software platform(s) and associated hardware that is configured to support, maintain and manage rendering of hybrid website interfaces (e.g., a webpage, graphical user interface, online document, etc.) and all associated functionalities, including, for example, providing a primary execution environment, providing one or more sandbox execution environment(s), providing one or more proxy transformation components, and compiling trusted website code definition elements, untrusted website code components, and such proxy transformation components. Example hybrid website interface rendering systems comprise supporting server(s), repositor(ies), and client device(s), and in some embodiments, are further configured to engage with external resources and external applications. In some embodiments, the hybrid website interface rendering system is a standalone system. In other embodiments, the hybrid website interface rendering system is embedded inside of a larger editing system. In certain embodiments, the hybrid website interface rendering system is associated with a visual design system, and further still, in some embodiments, the visual design system is one or more of a document building system, a website building system, or a software application building system.

The term “hybrid website interface rendering server” refers to a software platform and associated hardware that is configured to manage the various code structures and components and some or all of the associated hybrid website interface rendering functionality of the hybrid website interface rendering system. The hybrid website interface rendering server is accessible via one or more computing devices, is configured to receive various data, and access one or more data repositories such as a hybrid website interface rendering repository. The functionality of the hybrid website interface rendering server may be provided via a single server or collection of servers having a common functionality, or the functionality of the hybrid website interface rendering server may be segmented among a plurality of servers, collections of servers (e.g., a cloud networking environment, microservices, and/or the like) and/or a plurality of clients performing subsets of the described functionality of the hybrid website interface rendering.

The term “hybrid website interface” refers to a graphical user interface that is rendered as a result of execution of source code in one or more primary execution environments and one or more sandbox execution environments. A hybrid user interface is rendered to a client device based on data and instructions provided by the hybrid website interface rendering system. In some embodiments, such data and instructions are facilitated by a dedicated software application running on the client device. In other embodiments, such data and instructions are provided through a web browser running on the client device.

The term “primary execution environment” refers to an unsecured (i.e., not isolated from other environments or system) or trusted environment, such as a web window or windows, which can run code, such as JavaScript (JS). A primary execution environment is configured to execute one or more trusted website code definition elements, trusted code sections, and/or trusted computer executable functions (e.g., based on trusted code sections).

The term “sandbox execution environment” refers to a secured environment (i.e., structurally isolated from other environments or systems) which can run code, such as JS. A sandbox execution environment is an isolation mechanism or environment for securely executing potentially untrusted code. A sandbox execution environment is configured to execute one or more untrusted website code components, untrusted code sections, and/or untrusted computer executable functions (e.g., based on untrusted code sections).

The term “trusted website code definition element” refers to an element or code structure that is deemed essentially safe or trusted. In some embodiments, a trusted website code definition element utilizes declarative programming language, which is inherently secure and/or can be transformed/compiled into a code that can be verified as secure via static analysis. A trusted website code definition element does not include any logic code or logic code subcomponent, but may comprise a section including instructions, which will subsequently be compiled into logic instructions. A trusted website code definition element defines a structure of the state as well as a function that accepts data and, when called, can create and/or update (e.g., returns an update function) one or more structures in the DOM of the hybrid website interface. JE is one example of a trusted website code definition element depicted in FIG. 3B. In some embodiments, a trusted website code definition element is a trusted code section.

The term “trusted code section” refers to code or code structure that is deemed essentially safe or secure, such that it may be trusted to be executed in a primary execution environment. In some embodiments, a trusted code section utilizes declarative programming language, which is inherently secure and/or can be transformed/compiled into code that can be verified as secure via static analysis. In some embodiments, a trusted code section may comply with one or more rules and/or patterns used to identify trusted code sections. Trusted code sections, for example, may be identified based on known variable names, variable types, syntactic structures, APIs names, API types, security policies, access parameters, and/or the like. Trusted code sections may be identified and/or extracted from within an untrusted candidate code corpus. Trusted code sections may be compiled to run in a primary execution environment. For example, a trusted code section may be identified by applying a trusted code identification model to an untrusted candidate code corpus. The identified trusted code sections may be extracted from the untrusted candidate code corpus and or one or more trusted computer executable functions may be generated based on the extracted trusted code sections.

The term “trusted computer executable function” refers to a computer executable function that is generated and/or compiled based on one or more trusted code sections. Trusted computer executable functions may be generated in compliance with one or more predetermined rules. For example, trusted computer executable functions may be generated such that they are not modifiable by a user, are signed (including via hashing, cryptographic techniques, and/or via block chain), are not seen by a user, are readable, are generated using Typescript, are less than a given number of characters or lines, are condition free, and/or the like. A trusted computer executable function may be executed in a primary execution environment. A trusted computer executable function may be communicably connected to one or more other computer executable functions, such as an untrusted computer executable function. For example, the output of a trusted computer executable function may serve as the input to another computer executable function, such as an untrusted computer executable function. In another example, a trusted computer executable function may receive as an input the output from another computer executable function, such as an untrusted computer executable function. In some embodiments, a reciprocal communication pathway is established between the trusted computer executable function and an untrusted computer executable function based on the underlying untrusted code sections from which it was extracted.

The term “untrusted website code component” refers to a component or code structure that is deemed potentially or inherently unsafe, such that it may not be trusted to execute in the primary execution environment. An untrusted website code component may be a third-party application or third-party code (e.g., code structure generated externally of the system), or it may be generated internally of the system but insufficiently tested. An untrusted website code component utilizes script programming language or otherwise non-secure code to create that its associated trusted website code definition element renders. The untrusted website code component may be a structure that, given some trigger, communicates or sends new data to the associated trusted website definition element using an API. An untrusted website code component can define event handler(s) for the associated trusted website definition element. The untrusted website code component can use Refs as a way to access the DOM. That is, the untrusted website code component can set event listeners with a corresponding trusted website code definition element in order to get back events, provide updates, and then return a ViewState to the trusted website code definition element which will update the DOM. It can get Props from its parent untrusted website code components as well as expose APIs and events. JC is one example of an untrusted website code component depicted in FIG. 3B.

The term “untrusted code section” refers to code or code structure that is not deemed essentially safe or secure, such that it may not be trusted to execute in a primary execution environment. In some embodiments, untrusted code sections utilize script programming language or otherwise non-secure code. In some embodiments, untrusted code sections may not comply with any one of one or more rules and/or patterns used to identify trusted code sections. Untrusted code sections, for example, may include unusual or unknown variable names, variable types, syntactic structures, API names, API types, or require access to restricted entities, and/or the like. Untrusted code sections may be code sections that have not been identified as trusted code sections from within an untrusted candidate code corpus. Untrusted code sections may be compiled to run in a sandbox execution environment. For example, trusted code sections may be identified and extracted from an untrusted candidate code corpus, and the remaining code sections not identified as trusted code sections may, by default, be deemed untrusted code sections. One or more untrusted computer executable functions may be generated and/or compiled based on untrusted code sections.

In some embodiments, untrusted code may fail to compile or execute properly. For example, untrusted code may use an API that is not available in a sandbox execution environment. However, because the untrusted code is not identified as trusted code, untrusted computer executable functions based on the untrusted code remain in the sandbox environment where the required API is not available and, as a result, the untrusted code may fail to compile, function properly, execute at runtime and/or the like.

The term “untrusted computer executable function” refers to a computer executable function based on one or more untrusted code sections. One or more untrusted computer executable functions may be generated where each untrusted computer executable function may be based on one or more untrusted code sections. Untrusted computer executable functions may be generated in compliance with one or more predetermined rules. For example, in some embodiments, untrusted computer executable functions may be generated such that they are not modifiable by a user, are signed (including via hashing, cryptographic techniques, and/or via block chain), are not seen by a user, are readable, are generated using Typescript, are less than a given number of characters or lines, are condition free, and/or the like. An untrusted computer executable function may be executed in a sandbox execution environment. An untrusted computer executable function may be communicably connected to one or more other computer executable functions, such as a trusted computer executable function. For example, the output of an untrusted computer executable function may serve as the input to another computer executable function, such as a trusted computer executable function. In another example, an untrusted computer executable function may receive as an input the output from another computer executable function, such as a trusted computer executable function. In some embodiments, a reciprocal communication pathway is established between a trusted computer executable function and the untrusted computer executable function based on the underlying untrusted code sections from which it was extracted.

The term “untrusted candidate code corpus” refers to a corpus of code which may comprise untrusted code sections, trusted code sections, or a combination thereof. In some embodiments, code received by a hybrid website interface server may, by default, be included or defined within an untrusted candidate code corpus. That is, in some embodiments, code may, by default, be initially treated as untrusted code in an untrusted candidate code corpus, to which static analysis may be applied to potentially identify one or more trusted code sections. Once a compiler analyzes the untrusted candidate code corpus, one or more sections of code within the untrusted candidate code corpus may be identified as trusted code section(s). In other words, some code sections within the untrusted candidate code corpus may be identified by application of the trusted code identification model as trusted code sections while code sections which are not affirmatively identified as trusted code sections are untrusted code sections. Additionally or alternatively, in some embodiments, one or more sections of code within the untrusted candidate code corpus may be affirmatively identified as untrusted code section(s). For example, a compiler applying a trusted code identification model may identify code within an untrusted candidate code corpus as untrusted code section(s).

The term “proxy transformation component” refers to a component configured to communicatively link untrusted website code components executing in the sandbox execution environment to a trusted website code definition element executing in the primary execution environment, such that the proxy transformation component represents or emulates the trusted website code definition element or untrusted website code component in the opposing execution environment. Proxy transformation components are generated by a Jcompiler. Exemplary embodiments of the present disclosure depict proxy transformation components as one of two types: a bridge-type or a stub-type. A bridge-type proxy transformation component serves as a proxy to a trusted website code definition element or untrusted website code component which has both parent and child nodes. A stub-type proxy transformation component serves as a proxy to a trusted website code definition element or untrusted website code component which has parent nodes but no child nodes. It is contemplated by this disclosure that proxy transformation components may be of other types and the disclosure is not limited to the specifically identified bridge-type and stub-type of proxy transformation components.

A “primary execution environment proxy transformation component” refers to a proxy transformation component that operates in the primary execution environment and holds the rendering order place of the corresponding untrusted website code component that is operating in a sandbox execution environment. JC Bridge is one example of a primary execution environment proxy transformation component depicted in FIG. 3B.

A “sandbox execution environment proxy transformation component” refers to a proxy transformation component that operates in the sandbox execution environment and holds the rendering order place of the corresponding trusted website code definition element that is operating in the primary execution environment. JE Bridge and JE Stub 15 are two examples of a sandbox execution environment proxy transformation component depicted in FIG. 3B.

The term “trusted entity” refers to an entity in a code supply chain between a code composition entity and a code consumption entity that processes code-based content. The trusted entity receives code-based content from a code composition entity. In some embodiments, the code composition entity, prior to providing the code-based content to the trusted entity, may or may not perform trusted code splitting on the code-based content such that trusted code is compiled to execute in a primary execution environment and/or untrusted code is compiled to execute in a sandbox execution environment. Additionally or alternatively, the trusted entity may perform trusted code splitting on the code-based content such that one or more trusted code sections are compiled to execute in a primary execution environment and/or one or more untrusted code sections are compiled to execute in a sandbox execution environment. Additionally or alternatively, the trusted entity may generate an executable code package based on the trusted code sections and/or the untrusted code sections. In some embodiments, the trusted entity may send the executable code package to a code consumption entity. In some embodiments, the trusted entity may execute the executable code package and send data indicative of the results of the execution to a code consumption entity.

A trusted entity may verify received code-based content. Verifying code-based content may include any procedure used by the trusted entity to validate the code-based content. For example, the trusted entity may block, reject, or approve, completely or on a per-subsection basis, the code-based content pending any verifications based upon any agreements, regulations, and/or the like. The trusted entity may perform verification before and/or after applying a trusted code splitting operation to the code-based content.

The term “code composition entity” refers to an entity that produces code-based content. For example, a code composition entity may be an individual or group that writes, generates, produces, sells, and/or the like, code-based content. A code composition entity may provide code for consumption directly or indirectly. For example, a code composition entity may provide code-based content directly to a code consumption entity and/or indirectly by way of a trusted entity.

The term “code consumption entity” refers to an entity that receives code-based content. For example, a code consumption entity may be an individual or group that downloads, purchases, receives, views, and/or the like, code-based content. A code consumption entity may consume code from a code composition entity directly or indirectly. For example, a code consumption entity may consume code-based content directly from a code composition entity and/or indirectly by way of a trusted entity. In some embodiments, a code consumption entity may receive code-based content from a composition entity and/or a trusted entity enabling local execution of the code-based content by the code consumption entity. In some embodiments, a code consumption entity may receive data indicative of executed code-based content from a code composition entity and/or a trusted entity. For example, a code consumption entity may consume trusted code from a trusted entity and untrusted code from a code composition entity and/or a fourth party. In another example, a code consumption entity may consume trusted code and untrusted code from a trusted entity. In any case, the code consumption entity may receive code-based content for local execution or data indicative of an execution of the code-based content by another entity.

The term “provider-defined trusted code” refers to sections of trusted code that are defined, at least in part, by a provider. In some embodiments, one or more entities are associated with a hybrid website interface rendering system. Providers may have different APIs, use cases, functionalities, security policies and/or the like that give cause to at least partially different definitions for what may be identified as trusted code. Such differences may be reflected by provider-defined trusted code. For example, a provider of a hybrid website interface rendering system may provide one or more rules, patterns of code, and/or the like, which are applied, at least in part, by a compiler or trusted code identification model to identify trusted code.

The term “vendor-defined trusted code” refers to sections of trusted code that are defined, at least in part, by a vendor. In some embodiments, one or more entities are associated with a hybrid website interface rendering system. Vendors may have different APIs, use cases, functionalities, security policies and/or the like that give cause to at least partially different definitions for what may be identified as trusted code. Such differences may be reflected by vendor-defined trusted code. For example, a vendor of a hybrid website interface rendering system may provide one or more rules, patterns of code, and/or the like, which are applied, at least in part, by a compiler or trusted code identification model to identify trusted code.

The term “third party-defined trusted code” refers to sections of trusted code that are defined, at least in part, by a third party. In some embodiments, one or more entities are associated with a hybrid website interface rendering system. Third parties may have different APIs, use cases, functionalities, security policies and/or the like that give cause to at least partially different definitions for what may be identified as trusted code. Such differences may be reflected by third party-defined trusted code. For example, a third party of a hybrid website interface rendering system may provide one or more rules, patterns of code, and/or the like, which are applied, at least in part, by a compiler or trusted code identification model to identify trusted code.

The term “rendering order” refers to an object-calling structure in which the trusted website code definition elements and/or untrusted website code definition elements are to be called or rendered in order to implement the rendering of a hybrid website interface.

The term “trained machine learning model” refers to a machine learning task. Machine learning is a method used to devise complex models and algorithms that lend themselves to prediction. A machine learning model is a computer-implemented algorithm that can learn from data with or without relying on rules-based programming. These models enable reliable, repeatable decisions and results and uncovering of hidden insights through machine-based learning from historical relationships and trends in the data.

A machine learning model is initially fit or trained on a training dataset (e.g., a set of examples used to fit the parameters of the model). The model can be trained on the training dataset using supervised or unsupervised learning. The model is run with the training dataset and produces a result, which is then compared with a target, for each input vector in the training dataset. In certain embodiments, a machine learning model is trained in real-time (e.g., on-the-fly training). Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network).

The term “trusted code identification model” refers to a data entity configured to analyze an untrusted candidate code corpus and automatically and selectively identify trusted code section(s). The trusted code identification model may use, for example, one or more code analysis factors to make suggestions or predictions as to trusted code. The trusted code identification model may apply one or more defined rules and/or match one or more defined patterns of code to identify sections of the code within the untrusted candidate code corpus as trusted code section(s). Additionally, or alternatively, the trusted code identification model can be a machine learning model that is trained using tracked data, historical data, and/or the like. For example, in some embodiments, an unsupervised learning structure, a supervised learning structure, a reinforcement learning structure, a deep learning structure, a clustering algorithm, and/or the like is implemented for determining correlations of varied data and data formats to make suggestions or predictions as to trusted code. In still some further embodiments, the trusted code identification model may be an AI-based model or a non-AI based model.

The term “compilation performance metric” refers to a data entity that describes the compilation and/or execution of code. A compilation performance metric, for example, may include a static and/or dynamic value, range of values, proportion, rate, and/or the like. In some embodiments, a compilation performance metric may be used to report code that has failed to compile, function properly, execute at runtime and/or the like. For example, untrusted code requiring an API that is unavailable in a respective sandbox execution environment may not compile, function properly, execute at runtime, and/or the like. One or more such instances may be recorded as a compilation performance metric. The compilation performance metric, for example, may be provided to a user such that the user may become aware of the one or more instances. In another example, the compilation performance metric may be provided to a co-pilot like entity configured to assist in code-based activities. The compilation performance metric may include or be associated with one or more indices, variable names, variable types, functions, and/or the like, such that a user may be directed to the respective code.

The term “code-based content” refers to any code that may be configured to make available some information. For example, code-based content may be web pages, web page sections, templates, third-party applications, plug-ins, add-ons, packages, components, portion(s) thereof, and/or the like used for rendering websites, applications or portion(s) thereof, performing data manipulations, automating tasks, developing software and/or the like. Code-based content may or may not be split into trusted and untrusted code sections.

The term “executable code package” refers to consumable code-based content. In some embodiments, an executable code package is generated by a trusted entity and/or a code composition entity. An executable code package may be based on code-based content generated by and/or received from a code composition entity. An executable code package may include identified and compiled trusted code sections and/or untrusted code sections based on received code-based content. Trusted code sections in an executable code package may be configured to execute in a primary execution environment while untrusted code sections may be configured to execute in a sandbox execution environment. In some embodiments, an executable code package may be transmitted to a code consumption entity, thereby enabling the code consumption entity to execute the executable code package. Additionally or alternatively, in some embodiments, one or more portions of an executable code package is executed by a trusted entity and/or the code composition entity and data indicative of the results of the execution are sent to the code consumption entity.

The term “candidate secure distribution” refers to code-based content from a code composition entity. For example, a code composition entity may apply a trusted code identification model to code-based content to identify one or more trusted code sections and/or one or more untrusted code sections in order to generate a candidate secure distribution of the code-based content. The candidate secure distribution may include trusted code sections compiled to execute in a primary execution environment and/or untrusted code sections compiled to execute in a sandbox execution environment. In some embodiments, a code composition entity may provide the candidate secure distribution of the code-based content to a trusted entity. The code composition entity may provide the candidate secure distribution of the code-based content to a trusted entity for the purpose of a code consumption entity receiving the code-based content following processing by the trusted entity. The term “website building blocks” refers to structural objects used to assemble a website in accordance with a website building system as described herein. By way of example, website building blocks may include pages, sub-pages, containers, components, atomic components, content elements, layout elements, templates, layouts, layout rules, add-on applications, third-party applications, procedural code, and the like.

The term “compiler” refers to a computer program configured to create an executable computer program. In various embodiments, a compiler may be configured to translate computer code from one programming language to another, identify one or more sections of trusted code, make one or more code-based determinations, generate and/or manipulate one or more code sections, and/or the like. In some embodiments, a compiler, as used herein, may also be a preprocessor, Jcompiler, a JIT compiler, a static or dynamic code analyzer, an interpreter, a virtual machine (e.g., applying a trusted code identification model), or any other compiling, code processing, transformation, modification, or generation technology (including generative AI-based techniques).

The term “code analysis factors” refers to one or more cues or information sources used by a compiler (e.g., trusted code identification model) to make determinations. For example, code analysis factors may comprise code context, variable names, variable types, function usage, syntactic structures, API names, API types, security policies, code pattern matching, code abstract syntax tree (AST) analysis, declarative code recognition, historical code identification data, domain specific language (DSL), rules, libraries, library types, library names, and/or the like. A compiler may use one or more code analysis factors to, for example, identify sections of trusted code, sections of untrusted code, and/or the like.

The terms “identifier” or “identifiers” refers to a unique identifier, non-unique identifier, and/or the like.

The terms “website editing historical interactions,” “editing historical interactions,” and “historical editing interactions” refer to electronic interactions performed by client devices associated with editing user identifiers while assembling a website in accordance with a website building system as described herein. For example, such interactions may include editing of content, logic, layout, attributes, and/or the like.

The term “electronic interaction data” refers to electronic interactions performed by client devices with electronic interfaces (e.g., hybrid website interfaces). Electronic interaction data can include interaction(s) with a touch screen, mouse click(s), cursor position(s), cursor hovering(s), and the like.

The terms “client device”, “computing device”, “user device”, and the like may be used interchangeably to refer to computer hardware that is configured (either physically or by the execution of software) to access one or more of an application, service, or repository made available by a server and, among various other functions, is configured to directly, or indirectly, transmit and receive data. A client and server are generally remote from each other as the server is often (but not always) on another computer system, in which case the client device accesses the service by way of a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with a client device or an admin user interacting with an admin device). Information/data generated at the client device can be received from the client device at the server.

Example client devices include, without limitation, smart phones, tablet computers, laptop computers, wearable devices (e.g., integrated within watches or smartwatches, eyewear, helmets, hats, clothing, earpieces with wireless connectivity, and the like), personal computers, desktop computers, enterprise computers, the like, and any other computing devices known to one skilled in the art in light of the present disclosure. In some embodiments, a client device is associated with a user. In some embodiments, an association is created by a client device transmitting authentication information associated with the user to the hybrid website interface rendering system (e.g., hybrid website interface rendering server).

The terms “data,” “content,” “digital content,” “digital content object,” “signal”, “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media.

Examples of non-transitory computer-readable media include a magnetic computer-readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., physical or virtual servers in a cloud-based computing environment). In certain embodiments, an application is designed for use by and interaction with one or more local, networked or remote computing devices, such as, but not limited to, client devices. Non-limiting examples of an application comprise website editing services, document editing services, word processors, spreadsheet applications, accounting applications, web browsers, email clients, media players, file viewers, collaborative document management services, videogames, audio-video conferencing, and photo/video editors.

In some embodiments, an application is a cloud product. When associated with a client device, such as a mobile device, communication with hardware and software modules executing outside of the application is typically provided via application programming interfaces (APIs) provided by the mobile device operating system.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of qualitative assessment or quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present disclosure and may be included in more than one embodiment of the present disclosure (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

### Additional Implementation Details

Thus, particular embodiments of the subject matter have been described. While this specification contains many specific implementation details, these should not be construed as limitations on the scope of any inventions or of what may be claimed, but rather as description of features specific to particular embodiments of particular inventions. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination. Similarly, the separation of various system components in the embodiments described above should not be understood as requiring such separation in all embodiments, and it should be understood that the described program components and systems can generally be integrated together in a single software product or packaged into multiple software products.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices. Accordingly, non-transitory computer-readable storage media can be configured to store firmware, one or more application programs, and/or other software, which include instructions and/or other computer-readable program code portions that can be executed to control processors of the components of server apparatus 800 and/or client apparatus 900 to implement various operations, including the examples shown herein. As will be appreciated, any such computer program instructions and/or other type(s) of code may be loaded onto a computer, processor, or other programmable apparatus's circuitry to produce a machine, such that the computer, processor, or other programmable circuitry that execute the code on the machine creates the means for implementing various functions, including those described herein in connection with the components of hybrid website interface rendering server 512 and/or client device 508. It is also noted that all or some of the information discussed herein can be based on data that is received, generated, and/or maintained by one or more components of the hybrid website interface rendering server 512 and/or client device 508. In some embodiments, one or more external systems (such as a remote cloud computing and/or data storage system) may also be leveraged to provide at least some of the functionality discussed herein.

The following exemplary embodiments are provided, the numbering of which is not to be construed as designating levels of importance or relevance.

Embodiment 1 provides a website building system configured to enable rendering of a hybrid website interface based on at least one trusted website code definition element and at least one untrusted website code component, the website building system comprising at least one processor and at least one non-transitory memory comprising program code, the at least one non-transitory memory and the program code configured to, with the at least one processor, cause the website building system to at least provide a primary execution environment configured to execute one or more trusted website code definition elements, provide one or more sandbox execution environments configured to execute one or more untrusted website code components, provide one or more proxy transformation components that are configured to communicatively link the one or more untrusted website code components to at least one of the one or more trusted website code definition elements, and cause rendering of the hybrid website interface following execution of the at least one trusted website code definition element and the one or more untrusted website code components via the one or more proxy transformation components.

Embodiment 2 provides the website building system of Embodiment 1, wherein the one or more proxy transformation components comprise at least one primary execution environment proxy transformation component and at least one sandbox execution environment proxy transformation component.

Embodiment 3 provides the website building system of any one of Embodiments 1-2, wherein providing the primary execution environment and providing the one or more sandbox execution environments comprises mapping a rendering order of the one or more trusted website code definition elements and the one or more untrusted website code components across the execution environments.

Embodiment 4 provides the website building system of any one of Embodiments 1-3, wherein one or more primary execution environment proxy transformation components operate in the primary execution environment and are configured as placeholders of the one or more corresponding untrusted website code definition elements in the rendering order.

Embodiment 5 provides the website building system of any one of Embodiments 1-4, wherein a first trusted website code definition element executing in the primary execution environment is configured to receive a triggering event, and transmit the triggering event downstream to a subsequent primary execution environment proxy transformation component executing in the primary execution environment, the subsequent primary execution environment proxy transformation component communicating a message to its corresponding untrusted website code component executing in a first sandbox execution environment.

Embodiment 6 provides the website building system of any one of Embodiments 1-5, wherein the triggering event is a client event originating from a user interaction with a browser operating on a client device.

Embodiment 7 provides the website building system of any one of Embodiments 1-6, wherein a first untrusted website code component executes in a first sandbox execution environment, wherein an output of the execution of the first untrusted website code component comprises tracked data, and wherein the tracked data is communicated to a corresponding primary execution environment proxy transformation component executing in the primary execution environment.

Embodiment 8 provides the website building system of any one of Embodiments 1-7, wherein, during execution, the first untrusted website code component performs a simulated rendering of itself.

Embodiment 9 provides the website building system of any one of Embodiments 1-8, wherein, during execution, the corresponding primary execution environment proxy transformation component provides the tracked data as input data to a subsequent trusted website code definition element in the rendering order.

Embodiment 10 provides the website building system of any one of Embodiments 1-9, wherein one or more sandbox execution environment proxy transformation components operate in a first sandbox execution environment and are configured as placeholders of the one or more corresponding trusted website code components in the rendering order.

Embodiment 11 provides the website building system of any one of Embodiments 1-10, wherein a second untrusted website code component executes in a second, separate sandbox execution environment.

Embodiment 12 provides the website building system of any one of Embodiments 1-11, wherein the rendering order comprises at least a trusted root website code definition element of the primary execution environment and an untrusted root website code component of a first sandbox execution environment.

Embodiment 13 provides the website building system of any one of Embodiments 1-12, wherein the program code is further configured to, with the at least one processor, cause the website building system to at least receive a code execution request, the code execution request triggering an execution instruction to the trusted root website code definition element of the primary execution environment and the trusted root website code definition element transmitting another execution instruction to the untrusted root website code component of the first sandbox execution environment.

Embodiment 14 provides the website building system of any one of Embodiments 1-13, wherein at least one of the one or more untrusted website code components comprises a third-party application or third-party code.

Embodiment 15 provides the website building system of any one of Embodiments 1-14, wherein at least one of the one or more untrusted website code components comprises untested or insufficiently tested code.

Embodiment 16 provides the website building system of any one of Embodiments 1-15, wherein a first untrusted website code component comprises a presentation code subcomponent and a logic code subcomponent.

Embodiment 17 provides the website building system of any one of Embodiments 1-16, wherein the website building system further comprises a Jcompiler, the Jcompiler configured to extract declarative programming language expressions from the presentation code subcomponent of the first untrusted website code component, compile the extracted declarative programming language expressions to form a secure code component executing in the primary execution environment, and form the one or more proxy transformation components from the presentation code subcomponent of the first untrusted website code component, the one or more proxy transformation components executing in the primary execution environment.

Embodiment 18 provides the website building system of any one of Embodiments 1-17, wherein a first trusted website code definition element of the one or more trusted website code definition elements comprises declarative programming language expressions.

Embodiment 19 provides the website building system of any one of Embodiments 1-18, wherein the first trusted website code definition element is configured to define a function that accepts tracked data.

Embodiment 20 provides the website building system of any one of Embodiments 1-19, wherein the first trusted website code definition element comprises instructions configured to be compiled into logic instructions.

Embodiment 21 provides the website building system of any one of Embodiments 1-20, wherein the declarative programming language expressions are verifiable via static analysis.

Embodiment 22 provides the website building system of any one of Embodiments 1-21, wherein the program code is further configured to, with at least one processor, cause the website building system to at least analyze a plurality of website code structures configured to render the hybrid website interface, parse the plurality of website code structures, and programmatically determine and categorize at least one website code structure as a trusted website code definition element and at least one other website code structure as an untrusted website code component.

Embodiment 23 provides the website building system of any one of Embodiments 1-22, wherein the website building system comprises one or more trained machine learning models to programmatically determine and categorize the at least one website code structure as a trusted website code definition element and the at least one other website code structure as an untrusted website code component.

Embodiment 24 provides the website building system of any one of Embodiments 1-23, wherein an execution output of the primary execution environment creates or updates a structure in a Document Object Model (DOM) of the hybrid website interface.

Embodiment 25 provides the website building system of any one of Embodiments 1-24, wherein the DOM of the hybrid website interface is associated with at least one document data structure, the at least one document data structure comprises one or more of a tree-structured data structure, a forest-structured data structure, a federated architecture data structure, a graph data structure, a referential table, an object database, a flat data structure, a hash table, or a combination thereof.

Embodiment 26 provides the website building system of any one of Embodiments 1-25, wherein rendering of the hybrid website interface is a client-side rendering.

Embodiment 27 provides the website building system of any one of Embodiments 1-26, wherein rendering of the hybrid website interface is a server-side rendering.

Embodiment 28 provides a computer-implemented method for enabling rendering of a hybrid website interface based on at least one trusted website code definition element and at least one untrusted website code component, the computer-implemented method comprising providing a primary execution environment configured to execute one or more trusted website code definition elements, providing one or more sandbox execution environments configured to execute one or more untrusted website code components, providing one or more proxy transformation components that are configured to communicatively link the one or more untrusted website code components to at least one of the one or more trusted website code definition elements, and rendering the hybrid website interface following execution of the at least one trusted website code definition element and the one or more untrusted website code components via the one or more proxy transformation components.

Embodiment 29 provides the computer-implemented method of Embodiment 28, wherein the one or more proxy transformation components comprise at least one primary execution environment proxy transformation component and at least one sandbox execution environment proxy transformation component.

Embodiment 30 provides the computer-implemented method of any one of Embodiments 28-29, wherein providing the primary execution environment and providing the one or more sandbox execution environments comprises mapping a rendering order of the one or more trusted website code definition elements and the one or more untrusted website code components across the execution environments.

Embodiment 31 provides the computer-implemented method of any one of Embodiments 28-30, wherein one or more primary execution environment proxy transformation components operate in the primary execution environment and are configured as placeholders of the one or more corresponding untrusted website code definition elements in the rendering order.

Embodiment 32 provides the computer-implemented method of any one of Embodiments 28-31, wherein a first trusted website code definition element executing in the primary execution environment is configured to receive a triggering event, and transmit the triggering event downstream to a subsequent primary execution environment proxy transformation component executing in the primary execution environment, the subsequent primary execution environment proxy transformation component communicating a message to its corresponding untrusted website code component executing in a first sandbox execution environment.

Embodiment 33 provides the computer-implemented method of any one of Embodiments 28-32, wherein the triggering event is a client event originating from a user interaction with a browser operating on a client device.

Embodiment 34 provides the computer-implemented method of any one of Embodiments 28-33, wherein a first untrusted website code component executes in a first sandbox execution environment, wherein an output of the execution of the first untrusted website code component comprises tracked data, and wherein the tracked data is communicated to a corresponding primary execution environment proxy transformation component executing in the primary execution environment.

Embodiment 35 provides the computer-implemented method of any one of Embodiments 28-34, wherein, during execution, the first untrusted website code component performs a simulated rendering of itself.

Embodiment 36 provides the computer-implemented method of any one of Embodiments 28-35, wherein, during execution, the corresponding primary execution environment proxy transformation component provides the tracked data as input data to a subsequent trusted website code definition element in the rendering order.

Embodiment 37 provides the computer-implemented method of any one of Embodiments 28-36, wherein one or more sandbox execution environment proxy transformation components operate in a first sandbox execution environment and are configured as placeholders of the one or more corresponding trusted website code components in the rendering order.

Embodiment 38 provides the computer-implemented method of any one of Embodiments 28-37, wherein a second untrusted website code component executes in a second, separate sandbox execution environment.

Embodiment 39 provides the computer-implemented method of any one of Embodiments 28-38, wherein the rendering order comprises at least a trusted root website code definition element of the primary execution environment and an untrusted root website code component of a first sandbox execution environment.

Embodiment 40 provides the computer-implemented method of any one of Embodiments 28-39, the method further comprising receiving a code execution request, the code execution request triggering an execution instruction to the trusted root website code definition element of the primary execution environment and the trusted root website code definition element transmitting another execution instruction to the untrusted root website code component of the first sandbox execution environment.

Embodiment 41 provides the computer-implemented method of any one of Embodiments 28-40, wherein at least one of the one or more untrusted website code components comprises a third-party application or third-party code.

Embodiment 42 provides the computer-implemented method of any one of Embodiments 28-41, wherein at least one of the one or more untrusted website code components comprises untested or insufficiently tested code.

Embodiment 43 provides the computer-implemented method of any one of Embodiments 28-42, wherein a first untrusted website code component comprises a presentation code subcomponent and a logic code subcomponent.

Embodiment 44 provides the computer-implemented method of any one of Embodiments 28-43, the method further comprising providing a Jcompiler, extracting, via the Jcompiler, declarative programming language expressions from the presentation code subcomponent of the first untrusted website code component, compiling, via the Jcompiler, the extracted declarative programming language expressions to form a secure code component executing in the primary execution environment, and forming, via the Jcompiler, the one or more proxy transformation components from the presentation code subcomponent of the first untrusted website code component, the one or more proxy transformation components executing in the primary execution environment.

Embodiment 45 provides the computer-implemented method of any one of Embodiments 28-44, wherein a first trusted website code definition element of the one or more trusted website code definition elements comprises declarative programming language expressions.

Embodiment 46 provides the computer-implemented method of any one of Embodiments 28-45, wherein the first trusted website code definition element is configured to define a function that accepts tracked data.

Embodiment 47 provides the computer-implemented method of any one of Embodiments 28-46, wherein the first trusted website code definition element comprises instructions configured to be compiled into logic instructions.

Embodiment 48 provides the computer-implemented method of any one of Embodiments 28-47, wherein the declarative programming language expressions are verifiable via static analysis.

Embodiment 49 provides the computer-implemented method of any one of Embodiments 28-48, the method further comprising analyzing a plurality of website code structures configured to render the hybrid website interface, parsing the plurality of website code structures, and programmatically determining and categorizing at least one website code structure as a trusted website code definition element and at least one other website code structure as an untrusted website code component.

Embodiment 50 provides the computer-implemented method of any one of Embodiments 28-49, wherein one or more trained machine learning models perform the step of the step of programmatically determining and categorizing at least one website code structure as a trusted website code definition element and at least one other website code structure as an untrusted website code component.

Embodiment 51 provides the computer-implemented method of any one of Embodiments 28-50, wherein an execution output of the primary execution environment creates or updates a structure in a Document Object Model (DOM) of the hybrid website interface.

Embodiment 52 provides the computer-implemented method of any one of Embodiments 28-51, wherein the DOM of the hybrid website interface is associated with at least one document data structure, the at least one document data structure comprises one or more of a tree-structured data structure, a forest-structured data structure, a federated architecture data structure, a graph data structure, a referential table, an object database, a flat data structure, a hash table, or a combination thereof.

Embodiment 53 provides the computer-implemented method of any one of Embodiments 28-52, wherein rendering of the hybrid website interface is a client-side rendering.

Embodiment 54 provides the computer-implemented method of any one of Embodiments 28-53, wherein rendering of the hybrid website interface is a server-side rendering.

Embodiment 55 provides a computer program product comprising at least one non-transitory computer-readable storage medium having computer program code stored thereon that, in execution with at least one processor is configured to provide a primary execution environment configured to execute one or more trusted website code definition elements, provide one or more sandbox execution environments configured to execute one or more untrusted website code components, provide one or more proxy transformation components that are configured to communicatively link the one or more untrusted website code components to at least one of the one or more trusted website code definition elements, and cause rendering of the hybrid website interface following execution of the at least one trusted website code definition element and the one or more untrusted website code components via the one or more proxy transformation components.

Embodiment 56 provides the computer program product of Embodiment 55, wherein the one or more proxy transformation components comprise at least one primary execution environment proxy transformation component and at least one sandbox execution environment proxy transformation component.

Embodiment 57 provides the computer program product of any one of Embodiments 55-56, wherein providing the primary execution environment and providing the one or more sandbox execution environments comprises mapping a rendering order of the one or more trusted website code definition elements and the one or more untrusted website code components across the execution environments.

Embodiment 58 provides the computer program product of any one of Embodiments 55-57, wherein one or more primary execution environment proxy transformation components operate in the primary execution environment and are configured as placeholders of the one or more corresponding untrusted website code definition elements in the rendering order.

Embodiment 59 provides the computer program product of any one of Embodiments 55-58, wherein a first trusted website code definition element executing in the primary execution environment is configured to receive a triggering event, and transmit the triggering event downstream to a subsequent primary execution environment proxy transformation component executing in the primary execution environment, the subsequent primary execution environment proxy transformation component communicating a message to its corresponding untrusted website code component executing in a first sandbox execution environment.

Embodiment 60 provides the computer program product of any one of Embodiments 55-59, wherein the triggering event is a client event originating from a user interaction with a browser operating on a client device.

Embodiment 61 provides the computer program product of any one of Embodiments 55-60, wherein a first untrusted website code component executes in a first sandbox execution environment, wherein an output of the execution of the first untrusted website code component comprises tracked data, and wherein the tracked data is communicated to a corresponding primary execution environment proxy transformation component executing in the primary execution environment.

Embodiment 62 provides the computer program product of any one of Embodiments 55-61, wherein, during execution, the first untrusted website code component performs a simulated rendering of itself.

Embodiment 63 provides the computer program product of any one of Embodiments 55-62, wherein, during execution, the corresponding primary execution environment proxy transformation component provides the tracked data as input data to a subsequent trusted website code definition element in the rendering order.

Embodiment 64 provides the computer program product of any one of Embodiments 55-63, wherein one or more sandbox execution environment proxy transformation components operate in a first sandbox execution environment and are configured as placeholders of the one or more corresponding trusted website code components in the rendering order.

Embodiment 65 provides the computer program product of any one of Embodiments 55-64, wherein a second untrusted website code component executes in a second, separate sandbox execution environment.

Embodiment 66 provides the computer program product of any one of Embodiments 55-65, wherein the rendering order comprises at least a trusted root website code definition element of the primary execution environment and an untrusted root website code component of a first sandbox execution environment.

Embodiment 67 provides the computer program product of any one of Embodiments 55-66, further configured to receive a code execution request, the code execution request triggering an execution instruction to the trusted root website code definition element of the primary execution environment and the trusted root website code definition element transmitting another execution instruction to the untrusted root website code component of the first sandbox execution environment.

Embodiment 68 provides the computer program product of any one of Embodiments 55-67, wherein at least one of the one or more untrusted website code components comprises a third-party application or third-party code.

Embodiment 69 provides the computer program product of any one of Embodiments 55-68, wherein at least one of the one or more untrusted website code components comprises untested or insufficiently tested code.

Embodiment 70 provides the computer program product of any one of Embodiments 55-69, wherein a first untrusted website code component comprises a presentation code subcomponent and a logic code subcomponent.

Embodiment 71 provides the computer program product of any one of Embodiments 55-70, further configured to extract declarative programming language expressions from the presentation code subcomponent of the first untrusted website code component, compile the extracted declarative programming language expressions to form a secure code component executing in the primary execution environment, and form the one or more proxy transformation components from the presentation code subcomponent of the first untrusted website code component, the one or more proxy transformation components executing in the primary execution environment.

Embodiment 72 provides the computer program product of any one of Embodiments 55-71, wherein a first trusted website code definition element of the one or more trusted website code definition elements comprises declarative programming language expressions.

Embodiment 73 provides the computer program product of any one of Embodiments 55-72, wherein the first trusted website code definition element is configured to define a function that accepts tracked data.

Embodiment 74 provides the computer program product of any one of Embodiments 55-73, wherein the first trusted website code definition element comprises instructions configured to be compiled into logic instructions.

Embodiment 75 provides the computer program product of any one of Embodiments 55-74, wherein the declarative programming language expressions are verifiable via static analysis.

Embodiment 76 provides the computer program product of any one of Embodiments 55-75, further configured to analyze a plurality of website code structures configured to render the hybrid website interface, parse the plurality of website code structures, and programmatically determine and categorize at least one website code structure as a trusted website code definition element and at least one other website code structure as an untrusted website code component.

Embodiment 77 provides the computer program product of any one of Embodiments 55-76, wherein the computer program product executes one or more trained machine learning models to programmatically determine and categorize the at least one website code structure as a trusted website code definition element and the at least one other website code structure as an untrusted website code component.

Embodiment 78 provides the computer program product of any one of Embodiments 55-77, wherein an execution output of the primary execution environment creates or updates a structure in a Document Object Model (DOM) of the hybrid website interface.

Embodiment 79 provides the computer program product of any one of Embodiments 55-78, wherein the DOM of the hybrid website interface is associated with at least one document data structure, the at least one document data structure comprises one or more of a tree-structured data structure, a forest-structured data structure, a federated architecture data structure, a graph data structure, a referential table, an object database, a flat data structure, a hash table, or a combination thereof.

Embodiment 80 provides the computer program product of any one of Embodiments 55-79, wherein rendering of the hybrid website interface is a client-side rendering.

Embodiment 81 provides the computer program product of any one of Embodiments 55-80, wherein rendering of the hybrid website interface is a server-side rendering.

Embodiment 82 provides a website building system configured to enable rendering of a hybrid website interface based on at least one trusted code structure and at least one untrusted code structure, the website building system comprising at least one processor and at least one non-transitory memory comprising program code, the at least one non-transitory memory and the program code configured to, with the at least one processor, cause the website building system to at least access a code repository to identify at least one untrusted website code structure and at least one trusted website code structure, transform the at least one untrusted website code structure into a primary execution environment proxy transformation component, the at least one untrusted website code structure continuing to operate within a sandbox execution environment, generate a primary execution environment configured for executing the at least one trusted website code structure and the primary execution environment proxy transformation component, and cause rendering of the hybrid website interface following execution of the at least one trusted website code structure and the at least one untrusted website code structure via the primary execution environment proxy transformation component.

Embodiment 83 provides a computer-implemented method for enabling rendering of a hybrid website interface based on at least one trusted website code definition element and at least one untrusted website code component, the computer-implemented method comprising accessing a code repository, identifying at least one untrusted website code structure and at least one trusted website code structure, transforming the at least one untrusted website code structure into a primary execution environment proxy transformation component, the at least one untrusted website code structure continuing to operate within a sandbox execution environment, generating a primary execution environment configured for executing the at least one trusted website code structure and the primary execution environment proxy transformation component, executing the at least one trusted website code structure and the at least one untrusted website code structure via the primary execution environment proxy transformation component, and rendering the hybrid website interface following execution of the at least one trusted website code structure and the at least one untrusted website code structure via the primary execution environment proxy transformation component.

Embodiment 84 provides a computer program product comprising at least one non-transitory computer-readable storage medium having computer program code stored thereon that, in execution with at least one processor is configured to access a code repository to identify at least one untrusted website code structure and at least one trusted website code structure, transform the at least one untrusted website code structure into a primary execution environment proxy transformation component, the at least one untrusted website code structure continuing to operate within a sandbox execution environment, generate a primary execution environment configured for executing the at least one trusted website code structure and the primary execution environment proxy transformation component, and cause rendering of the hybrid website interface following execution of the at least one trusted website code structure and the at least one untrusted website code structure via the primary execution environment proxy transformation component.

Embodiment 85 provides a computer-implemented method for automatically performing trusted code splitting to an untrusted candidate code corpus, the computer-implemented method comprising applying a trusted code identification model to the untrusted candidate code corpus to automatically identify one or more trusted code sections; extracting the one or more trusted code sections from the untrusted candidate code corpus; generating one or more trusted computer executable functions based on the one or more trusted code sections; and generating one or more untrusted computer executable functions based on one or more untrusted code sections remaining in the untrusted candidate code corpus.

Embodiment 86 provides the computer-implemented method of Embodiment 85, wherein generating the one or more trusted computer executable functions and generating the one or more untrusted computer executable functions comprises generating a reciprocal communication pathway between the one or more trusted computer executable functions and the one or more untrusted computer executable functions, the reciprocal communication pathway configured to transmit one or more execution input parameters, one or more execution return values, or a combination thereof during execution of the one or more trusted computer executable functions and the one or more untrusted computer executable functions.

Embodiment 87 provides the computer-implemented method of any one of Embodiments 85-86, wherein the trusted code identification model is iteratively trained to identify one or more detectable code patterns of trusted code sections in a supervised training process.

Embodiment 88 provides the computer-implemented method of any one of Embodiments 85-87, wherein the trusted code identification model is iteratively trained to identify one or more detectable code patterns of trusted code sections in an unsupervised training process.

Embodiment 89 provides the computer-implemented method of any one of Embodiments 85-88, wherein the trusted code identification model is trained based on one or more of system provider-defined trusted code, vendor-defined trusted code, or third party-defined trusted code.

Embodiment 90 provides the computer-implemented method of any one of Embodiments 85-89, wherein the trusted code identification model applies one or more trusted code identification rules to automatically identify the one or more trusted code sections, the one or more trusted code identification rules are based on one or more of a code context, a code syntax structure, variable names, variable types, implicated APIs, code pattern matching, code abstract syntax tree (AST) analysis, declarative code recognition, historical code identification data, or domain specific language (DSL).

Embodiment 91 provides the computer-implemented method of any one of Embodiments 85-90, further comprising generating a structure of functions, wherein generating the structure of functions comprises communicably connecting a first trusted computer executable function to a second untrusted computer executable function via a reciprocal communication pathway, such that, during execution, an output of the first trusted computer executable function serves as an input parameter of the second untrusted computer executable function or an output of the second untrusted computer executable function serves as an input parameter of the first trusted computer executable function.

Embodiment 92 provides the computer-implemented method of any one of Embodiments 85-91, wherein the trusted code identification model is applied using a compiler.

Embodiment 93 provides the computer-implemented method of any one of Embodiments 85-92, further comprising executing the one or more trusted computer executable functions in a primary execution environment and the one or more untrusted computer executable functions in a sandbox execution environment.

Embodiment 94 provides the computer-implemented method of any one of Embodiments 85-93, wherein at runtime, an untrusted code section requiring access to an API that is not connected to the sandbox execution environment fails to execute in the sandbox execution environment.

Embodiment 95 provides a website building system configured for automatically performing trusted code splitting to an untrusted candidate code corpus, the website building system comprising at least one processor and at least one non-transitory memory comprising program code, the at least one non-transitory memory and the program code configured to, with the at least one processor, cause the website building system to at least: apply a trusted code identification model to the untrusted candidate code corpus to automatically identify one or more trusted code sections; extract the one or more trusted code sections from the untrusted candidate code corpus; generate one or more trusted computer executable functions based on the one or more trusted code sections; and generate one or more untrusted computer executable functions based on one or more untrusted code sections remaining in the untrusted candidate code corpus.

Embodiment 96 provides the website building system of Embodiment 95, wherein generating the one or more trusted computer executable functions and generating the one or more untrusted computer executable functions comprises generating a reciprocal communication pathway between the one or more trusted computer executable functions and the one or more untrusted computer executable functions, the reciprocal communication pathway configured to transmit one or more execution input parameters, one or more execution return values, or a combination thereof during execution of the one or more trusted computer executable functions and the one or more untrusted computer executable functions.

Embodiment 97 provides the website building system of any of Embodiments 95-96, wherein the trusted code identification model is iteratively trained to identify one or more detectable code patterns of trusted code sections in a supervised training process.

Embodiment 98 provides the website building system of any of Embodiments 95-97, wherein the trusted code identification model is iteratively trained to identify one or more detectable code patterns of trusted code sections in an unsupervised training process.

Embodiment 99 provides the website building system of any of Embodiments 95-98, wherein the trusted code identification model is trained based on one or more of system provider-defined trusted code, vendor-defined trusted code, or third party-defined trusted code.

Embodiment 100 provides the website building system of any of Embodiments 95-99, wherein the trusted code identification model applies one or more trusted code identification rules to automatically identify the one or more trusted code sections, the one or more trusted code identification rules are based on one or more of a code context, a code syntax structure, variable names, variable types, implicated APIs, code pattern matching, code abstract syntax tree (AST) analysis, declarative code recognition, historical code identification data, or domain specific language (DSL).

Embodiment 101 provides the website building system of any of Embodiments 95-100, wherein the program code is further configured to, with the at least one processor, cause the website building system to at least: generate a structure of functions, wherein generating the structure of functions comprises communicably connecting a first trusted computer executable function to a second untrusted computer executable function via a reciprocal communication pathway, such that, during execution, an output of the first trusted computer executable function serves as an input parameter of the second untrusted computer executable function or an output of the second untrusted computer executable function serves as an input parameter of the first trusted computer executable function.

Embodiment 102 provides the website building system of any of Embodiments 95-101, wherein the trusted code identification model is applied using a compiler.

Embodiment 103 provides the website building system of any of Embodiments 95-102, wherein the program code is further configured to, with the at least one processor, cause the website building system to at least execute the one or more trusted computer executable functions in a primary execution environment and the one or more untrusted computer executable functions in a sandbox execution environment.

Embodiment 104 provides the website building system of any of Embodiments 95-103, wherein at runtime, an untrusted code section requiring access to an API that is not connected to the sandbox execution environment fails to execute in the sandbox execution environment.

Embodiment 105 provides a computer program product comprising at least one non-transitory computer-readable storage medium having computer program code stored thereon that, in execution with at least one processor is configured to: apply a trusted code identification model to the untrusted candidate code corpus to automatically identify one or more trusted code sections; extract the one or more trusted code sections from the untrusted candidate code corpus; generate one or more trusted computer executable functions based on the one or more trusted code sections; and generate one or more untrusted computer executable functions based on one or more untrusted code sections remaining in the untrusted candidate code corpus.

Embodiment 106 provides the computer program product of Embodiment 105, wherein generating the one or more trusted computer executable functions and generating the one or more untrusted computer executable functions comprises generating a reciprocal communication pathway between the one or more trusted computer executable functions and the one or more untrusted computer executable functions, the reciprocal communication pathway configured to transmit one or more execution input parameters, one or more execution return values, or a combination thereof during execution of the one or more trusted computer executable functions and the one or more untrusted computer executable functions.

Embodiment 107 provides the computer program product of any one of Embodiments 105-106, wherein the trusted code identification model is iteratively trained to identify one or more detectable code patterns of trusted code sections in a supervised training process.

Embodiment 108 provides the computer program product of any one of Embodiments 105-107, wherein the trusted code identification model is iteratively trained to identify one or more detectable code patterns of trusted code sections in an unsupervised training process.

Embodiment 109 provides the computer program product of any one of Embodiments 105-108, wherein the trusted code identification model is trained based on one or more of system provider-defined trusted code, vendor-defined trusted code, or third party-defined trusted code.

Embodiment 110 provides the computer program product of any one of Embodiments 105-109, wherein the trusted code identification model applies one or more trusted code identification rules to automatically identify the one or more trusted code sections, the one or more trusted code identification rules are based on one or more of a code context, a code syntax structure, variable names, variable types, implicated APIs, code pattern matching, code abstract syntax tree (AST) analysis, declarative code recognition, historical code identification data, or domain specific language (DSL).

Embodiment 111 provides the computer program product of any one of Embodiments 105-110, further configured to generate a structure of functions, wherein generating the structure of functions comprises communicably connecting a first trusted computer executable function to a second untrusted computer executable function via a reciprocal communication pathway, such that, during execution, an output of the first trusted computer executable function serves as an input parameter of the second untrusted computer executable function or an output of the second untrusted computer executable function serves as an input parameter of the first trusted computer executable function.

Embodiment 112 provides the computer program product of any one of Embodiments 105-111, wherein the trusted code identification model is applied using a compiler.

Embodiment 113 provides the computer program product of any one of Embodiments 105-112, further configured to execute the one or more trusted computer executable functions in a primary execution environment and the one or more untrusted computer executable functions in a sandbox execution environment.

Embodiment 114 provides the computer program product of any one of Embodiments 105-113, wherein at runtime, an untrusted code section requiring access to an API that is not connected to the sandbox execution environment fails to execute in the sandbox execution environment.

Embodiment 115 provides a computer-implemented method for enabling rendering of a hybrid website interface, the computer-implemented method comprising identifying one or more trusted code sections in an untrusted candidate code corpus; extracting the one or more trusted code sections from the untrusted candidate code corpus; generating one or more trusted computer executable functions based on the one or more trusted code sections; generating one or more untrusted computer executable functions based on one or more untrusted code sections remaining in the untrusted candidate code corpus; and rendering the hybrid website interface following execution of one or more trusted computer executable functions in a primary execution environment and the one or more untrusted computer executable functions in a sandbox execution environment.

Embodiment 116 provides the computer-implemented method of Embodiment 115, wherein a compiler identifies the one or more trusted code sections in the untrusted candidate code.

Embodiment 117 provides the computer-implemented method of any one of Embodiments 115-116, wherein identifying one or more trusted code sections comprises identifying one or more detectable code patterns.

Embodiment 118 provides the computer-implemented method of any one of Embodiments 115-117, wherein identifying one or more detectable code patterns is based at least in part on matching sections of the untrusted candidate code to predetermined patterns of code.

Embodiment 119 provides the computer-implemented method of any one of Embodiments 115-118, wherein identifying one or more trusted code sections is based at least in part one or more allowed APIs.

Embodiment 120 provides the computer-implemented method of any one of Embodiments 115-119, further comprising generating a statistical report based on one or more compilation performance metrics; and providing the statistical report to a user.

Embodiment 121 provides a website building system configured for enabling rendering of a hybrid website interface, the website building system comprising at least one processor and at least one non-transitory memory comprising program code, the at least one non-transitory memory and the program code configured to, with the at least one processor, cause the website building system to at least identify one or more trusted code sections in an untrusted candidate code corpus; extract the one or more trusted code sections from the untrusted candidate code corpus; generate one or more trusted computer executable functions based on the one or more trusted code sections; generate one or more untrusted computer executable functions based on one or more untrusted code sections remaining in the untrusted candidate code corpus; and render the hybrid website interface following execution of one or more trusted computer executable functions in a primary execution environment and the one or more untrusted computer executable functions in a sandbox execution environment.

Embodiment 122 provides the website building system of Embodiment 121, wherein a compiler identifies the one or more trusted code sections in the untrusted candidate code.

Embodiment 123 provides the website building system of any one of Embodiments 121-122, wherein identifying one or more trusted code sections comprises identifying one or more detectable code patterns.

Embodiment 124 provides the website building system of any one of Embodiments 121-123, wherein identifying one or more detectable code patterns is based at least in part on matching sections of the untrusted candidate code to predetermined patterns of code.

Embodiment 125 provides the website building system of any one of Embodiments 121-124, wherein identifying one or more trusted code sections is based at least in part one or more allowed APIs.

Embodiment 126 provides the website building system of any one of Embodiments 121-125, wherein the program code is further configured to, with the at least one processor, cause the website building system to at least generate a statistical report based on one or more compilation performance metrics; and provide the statistical report to a user.

Embodiment 127 provides a computer program product comprising at least one non-transitory computer-readable storage medium having computer program code stored thereon that, in execution with at least one processor is configured to identify one or more trusted code sections in an untrusted candidate code corpus; extract the one or more trusted code sections from the untrusted candidate code corpus; generate one or more trusted computer executable functions based on the one or more trusted code sections; generate one or more untrusted computer executable functions based on one or more untrusted code sections remaining in the untrusted candidate code corpus; and render the hybrid website interface following execution of one or more trusted computer executable functions in a primary execution environment and the one or more untrusted computer executable functions in a sandbox execution environment.

Embodiment 128 provides the computer program product of Embodiment 127, wherein a compiler identifies the one or more trusted code sections in the untrusted candidate code.

Embodiment 129 provides the computer program product of any one of Embodiments 127-128, wherein identifying one or more trusted code sections comprises identifying one or more detectable code patterns.

Embodiment 130 provides the computer program product of any one of Embodiments 127-129, wherein identifying one or more detectable code patterns is based at least in part on matching sections of the untrusted candidate code to predetermined patterns of code.

Embodiment 131 provides the computer program product of any one of Embodiments 127-130, wherein identifying one or more trusted code sections is based at least in part one or more allowed APIs.

Embodiment 132 provides the computer program product of any one of Embodiments 127-131, further configured to generate a statistical report based on one or more compilation performance metrics and provide the statistical report to a user.

Embodiment 133 provides a computer-implemented method for implementing secure code-based content in a supply chain, the computer-implemented method comprising receiving, at a trusted entity, code-based content from a code composition entity; identifying, at the trusted entity, at least one or more trusted code sections of the code-based content; compiling, at the trusted entity, at least the one or more trusted code sections for execution in a primary execution environment; and generating, based on at least the compiled trusted code sections, an executable code package.

Embodiment 134 provides the computer-implemented method of Embodiment 133, further comprising verifying, at the trusted entity, the received code-based content.

Embodiment 135 provides the computer-implemented method of any one of Embodiments 133-134, further comprising transmitting the executable code package to a code consumption entity.

Embodiment 136 provides the computer-implemented method of any one of Embodiments 133-135, further comprising identifying, at the trusted entity, at least one or more untrusted code sections of the code-based content; and compiling, at the trusted entity, at least the one or more untrusted code sections for execution in a sandbox execution environment, and wherein generating the executable code package is based on at least the compiled trusted code sections and the compiled untrusted code sections.

Embodiment 137 provides the computer-implemented method of any one of Embodiments 133-136, further comprising executing, by the trusted entity, the executable code package, wherein executing the executable code package comprises running the one or more trusted code sections of the executable code package in a primary execution environment and transmitting a result of the execution of the executable code package to a code consumption entity.

Embodiment 138 provides the computer-implemented method of any one of Embodiments 133-137, further comprising identifying, at the trusted entity, at least one or more untrusted code sections of the code-based content and compiling, at the trusted entity, at least the one or more untrusted code sections for execution in a sandbox execution environment, and wherein generating the executable code package is based on at least the compiled trusted code sections and the compiled untrusted code sections, and wherein executing the executable code package further comprises running the one or more untrusted code sections of the executable code package in a sandbox execution environment.

Embodiment 139 provides the computer-implemented method of any one of Embodiments 133-138, wherein a code consumption entity receives a result of an execution of the one or more untrusted code sections from the code composition entity and receives a result of an execution of the trusted code sections from the trusted entity.

Embodiment 140 provides the computer-implemented method of any one of Embodiments 133-139, wherein the code composition entity generates a candidate secure distribution of the code-based content.

Embodiment 141 provides the computer-implemented method of any one of Embodiments 133-140, wherein identifying the one or more trusted code sections of the code-based content is based on application of a trusted code identification model.

Embodiment 142 provides the computer-implemented method of any one of Embodiments 133-141, wherein the code-based content corresponds to rendering a portion or an add-on of a website.

Embodiment 143 provides a website building system configured for implementing secure code-based content in a supply chain, the website building system comprising at least one processor and at least one non-transitory memory comprising program code, the at least one non-transitory memory and the program code configured to, with the at least one processor, cause the website building system to at least receive, at a trusted entity, code-based content from a code composition entity; identify, at the trusted entity, at least one or more trusted code sections of the code-based content; compile, at the trusted entity, at least the one or more trusted code sections for execution in a primary execution environment; and generate, based on at least the compiled trusted code sections, an executable code package.

Embodiment 144 provides the website building system of Embodiment 143, wherein the program code is further configured to, with the at least one processor, cause the website building system to at least verify, at the trusted entity, the received code-based content.

Embodiment 145 provides the website building system of any one of Embodiments 143-144, wherein the program code is further configured to, with the at least one processor, cause the website building system to at least transmit the executable code package to a code consumption entity.

Embodiment 146 provides the website building system of any one of Embodiments 143-145, wherein the program code is further configured to, with the at least one processor, cause the website building system to at least identify, at the trusted entity, at least one or more untrusted code sections of the code-based content; and compile, at the trusted entity, at least the one or more untrusted code sections for execution in a sandbox execution environment, and wherein generating the executable code package is based on at least the compiled trusted code sections and the compiled untrusted code sections.

Embodiment 147 provides the website building system of any one of Embodiments 143-146, wherein the program code is further configured to, with the at least one processor, cause the website building system to at least: execute, by the trusted entity, the executable code package, wherein executing the executable code package comprises running the one or more trusted code sections of the executable code package in a primary execution environment; and transmit a result of the execution of the executable code package to a code consumption entity.

Embodiment 148 provides the website building system of any one of Embodiments 143-147, wherein the program code is further configured to, with the at least one processor, cause the website building system to at least: identify, at the trusted entity, at least one or more untrusted code sections of the code-based content; and compile, at the trusted entity, at least the one or more untrusted code sections for execution in a sandbox execution environment, and wherein generating the executable code package is based on at least the compiled trusted code sections and the compiled untrusted code sections, and wherein executing the executable code package further comprises running the one or more untrusted code sections of the executable code package in a sandbox execution environment.

Embodiment 149 provides the website building system of any one of Embodiments 143-148, wherein a code consumption entity receives a result of an execution of the one or more untrusted code sections from the code composition entity and receives a result of an execution of the trusted code sections from the trusted entity.

Embodiment 150 provides the website building system of any one of Embodiments 143-149, wherein the code composition entity generates a candidate secure distribution of the code-based content.

Embodiment 151 provides the website building system of any one of Embodiments 143-150, wherein identifying the one or more trusted code sections of the code-based content is based on application of a trusted code identification model.

Embodiment 152 provides the website building system of any one of Embodiments 143-151, wherein the code-based content corresponds to rendering a portion or an add-on of a website.

Embodiment 153 provides a computer program product comprising at least one non-transitory computer-readable storage medium having computer program code stored thereon that, in execution with at least one processor is configured to receive, at a trusted entity, code-based content from a code composition entity; identify, at the trusted entity, at least one or more trusted code sections of the code-based content; compile, at the trusted entity, at least the one or more trusted code sections for execution in a primary execution environment; and generate, based on at least the compiled trusted code sections, an executable code package.

Embodiment 154 provides the computer program product of Embodiment 153, further configured to verify, at the trusted entity, the received code-based content.

Embodiment 155 provides the computer program product of any one of Embodiments 153-154, further configured to transmit the executable code package to a code consumption entity.

Embodiment 156 provides the computer program product of any one of Embodiments 153-155, further configured to identify, at the trusted entity, at least one or more untrusted code sections of the code-based content; and compile, at the trusted entity, at least the one or more untrusted code sections for execution in a sandbox execution environment, and wherein generating the executable code package is based on at least the compiled trusted code sections and the compiled untrusted code sections.

Embodiment 157 provides the computer program product of any one of Embodiments 153-156, further configured to execute, by the trusted entity, the executable code package, wherein executing the executable code package comprises running the one or more trusted code sections of the executable code package in a primary execution environment; and transmit a result of the execution of the executable code package to a code consumption entity.

Embodiment 158 provides the computer program product of any one of Embodiments 153-157, further configured to: identify, at the trusted entity, at least one or more untrusted code sections of the code-based content; and compile, at the trusted entity, at least the one or more untrusted code sections for execution in a sandbox execution environment, and wherein generating the executable code package is based on at least the compiled trusted code sections and the compiled untrusted code sections, and wherein executing the executable code package further comprises running the one or more untrusted code sections of the executable code package in a sandbox execution environment.

Embodiment 159 provides the computer program product of any one of Embodiments 153-160, wherein a code consumption entity receives a result of an execution of the one or more untrusted code sections from the code composition entity and receives a result of an execution of the trusted code sections from the trusted entity.

Embodiment 160 provides the computer program product of any one of Embodiments 153-159, wherein the code composition entity generates a candidate secure distribution of the code-based content.

Embodiment 161 provides the computer program product of any one of Embodiments 153-160, wherein identifying the one or more trusted code sections of the code-based content is based on application of a trusted code identification model.

Embodiment 162 provides the computer program product of any one of Embodiments 153-161, wherein the code-based content corresponds to rendering a portion or an add-on of a website.

Embodiment 163 provides a system configured to enable rendering of a hybrid interface based on at least one trusted code definition element and at least one untrusted code component, the system comprising at least one processor and at least one non-transitory memory comprising program code, the at least one non-transitory memory and the program code configured to, with the at least one processor, cause the system to at least provide a primary execution environment configured to execute one or more trusted code definition elements, provide one or more sandbox execution environments configured to execute one or more untrusted code components, provide one or more proxy transformation components that are configured to communicatively link the one or more untrusted code components to at least one of the one or more trusted code definition elements, and cause rendering of the hybrid interface following execution of the at least one trusted code definition element and the one or more untrusted code components via the one or more proxy transformation components.

Embodiment 164 provides the system of Embodiment 163, wherein the system comprises one or more of a visual design system, an experiment system, an end-user oriented website or application, a native application building system, a dynamic view assignment system, an application generation system, or a page analyzing visual editor.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A website building system configured to enable rendering of a hybrid website interface based on at least one trusted website code definition element and at least one untrusted website code component, the website building system comprising at least one processor and at least one non-transitory memory comprising program code, the at least one non-transitory memory and the program code configured to, with the at least one processor, cause the website building system to at least:
provide a primary execution environment configured to execute one or more trusted website code definition elements;
provide one or more sandbox execution environments configured to execute one or more untrusted website code components;
provide one or more proxy transformation components that are configured to communicatively link the one or more untrusted website code components to at least one of the one or more trusted website code definition elements; and
cause rendering of the hybrid website interface following execution of the at least one trusted website code definition element and the one or more untrusted website code components via the one or more proxy transformation components.

2. The website building system of claim 1, wherein the one or more proxy transformation components comprise at least one primary execution environment proxy transformation component and at least one sandbox execution environment proxy transformation component.

3. The website building system of claim 2, wherein providing the primary execution environment and providing the one or more sandbox execution environments comprises mapping a rendering order of the one or more trusted website code definition elements and the one or more untrusted website code components across the execution environments.

4. The website building system of claim 3, wherein one or more primary execution environment proxy transformation components operate in the primary execution environment and are configured as placeholders of the one or more corresponding untrusted website code definition elements in the rendering order.

5. The website building system of claim 4, wherein a first trusted website code definition element executing in the primary execution environment is configured to:
receive a triggering event; and
transmit the triggering event downstream to a subsequent primary execution environment proxy transformation component executing in the primary execution environment, the subsequent primary execution environment proxy transformation component communicating a message to its corresponding untrusted website code component executing in a first sandbox execution environment.

6. The website building system of claim 5, wherein the triggering event is a client event originating from a user interaction with a browser operating on a client device.

7. The website building system of claim 3, wherein a first untrusted website code component executes in a first sandbox execution environment, wherein an output of the execution of the first untrusted website code component comprises tracked data, and wherein the tracked data is communicated to a corresponding primary execution environment proxy transformation component executing in the primary execution environment.

8. The website building system of claim 7, wherein, during execution, the first untrusted website code component performs a simulated rendering of itself.

9. The website building system of claim 7, wherein, during execution, the corresponding primary execution environment proxy transformation component provides the tracked data as input data to a subsequent trusted website code definition element in the rendering order.

10. The website building system of claim 3, wherein one or more sandbox execution environment proxy transformation components operate in a first sandbox execution environment and are configured as placeholders of the one or more corresponding trusted website code components in the rendering order.

11. The website building system of claim 10, wherein a second untrusted website code component executes in a second, separate sandbox execution environment.

12. The website building system of claim 3, wherein the rendering order comprises at least a trusted root website code definition element of the primary execution environment and an untrusted root website code component of a first sandbox execution environment.

13. The website building system of claim 3, wherein the program code is further configured to, with the at least one processor, cause the website building system to at least:
receive a code execution request, the code execution request triggering an execution instruction to the trusted root website code definition element of the primary execution environment and the trusted root website code definition element transmitting another execution instruction to the untrusted root website code component of the first sandbox execution environment.

14. The website building system of claim 1, wherein at least one of the one or more untrusted website code components comprises a third-party application or third-party code.

15. The website building system of claim 1, wherein at least one of the one or more untrusted website code components comprises untested or insufficiently tested code.

16. The website building system of claim 1, wherein a first untrusted website code component comprises a presentation code subcomponent and a logic code subcomponent.

17. The website building system of claim 16, wherein the website building system further comprises a Jcompiler, the Jcompiler configured to:
extract declarative programming language expressions from the presentation code subcomponent of the first untrusted website code component;
compile the extracted declarative programming language expressions to form a secure code component executing in the primary execution environment; and
form the one or more proxy transformation components from the presentation code subcomponent of the first untrusted website code component, the one or more proxy transformation components executing in the primary execution environment.

18. The website building system of claim 1, wherein a first trusted website code definition element of the one or more trusted website code definition elements comprises declarative programming language expressions.

19. The website building system of claim 18, wherein the first trusted website code definition element is configured to define a function that accepts tracked data.

20. The website building system of claim 18, wherein the first trusted website code definition element comprises instructions configured to be compiled into logic instructions.

21. The website building system of claim 18, wherein the declarative programming language expressions are verifiable via static analysis.

22. The website building system of claim 1, wherein the program code is further configured to, with at least one processor, cause the website building system to at least:
analyze a plurality of website code structures configured to render the hybrid website interface;
parse the plurality of website code structures; and
programmatically determine and categorize at least one website code structure as a trusted website code definition element and at least one other website code structure as an untrusted website code component.

23. The website building system of claim 22, wherein the website building system comprises one or more trained machine learning models to programmatically determine and categorize the at least one website code structure as a trusted website code definition element and the at least one other website code structure as an untrusted website code component.

24. The website building system of claim 1, wherein an execution output of the primary execution environment creates or updates a structure in a Document Object Model (DOM) of the hybrid website interface.

25. The website building system of claim 24, wherein the DOM of the hybrid website interface is associated with at least one document data structure, the at least one document data structure comprises one or more of a tree-structured data structure, a forest-structured data structure, a federated architecture data structure, a graph data structure, a referential table, an object database, a flat data structure, a hash table, or a combination thereof.

26. The website building system of claim 1, wherein rendering of the hybrid website interface is a client-side rendering.

27. The website building system of claim 1, wherein rendering of the hybrid website interface is a server-side rendering.

28. A computer-implemented method for enabling rendering of a hybrid website interface based on at least one trusted website code definition element and at least one untrusted website code component, the computer-implemented method comprising:
providing a primary execution environment configured to execute one or more trusted website code definition elements;
providing one or more sandbox execution environments configured to execute one or more untrusted website code components;
providing one or more proxy transformation components that are configured to communicatively link the one or more untrusted website code components to at least one of the one or more trusted website code definition elements; and
rendering the hybrid website interface following execution of the at least one trusted website code definition element and the one or more untrusted website code components via the one or more proxy transformation components.

29. A computer program product comprising at least one non-transitory computer-readable storage medium having computer program code stored thereon that, in execution with at least one processor is configured to:
provide a primary execution environment configured to execute one or more trusted website code definition elements;
provide one or more sandbox execution environments configured to execute one or more untrusted website code components;
provide one or more proxy transformation components that are configured to communicatively link the one or more untrusted website code components to at least one of the one or more trusted website code definition elements; and
cause rendering of the hybrid website interface following execution of the at least one trusted website code definition element and the one or more untrusted website code components via the one or more proxy transformation components.
